(19) United States
(12) Patent Application Publication
(10) Pub. No.: US 2002/0107301 A1
(43) Pub. Date: Aug. 8, 2002

(54) Coloring composition, ink for ink jet recording and ink jet recording method

(76) Inventors: Junichi Yamanouchi, Kanagawa (JP); Makoto Yamada, Kanagawa (JP); Yoshiharu Yabuki, Kanagawa (JP)

Correspondence Address: BURNS DOANE SWECKER & MATHIS L L P, POST OFFICE BOX 1404, ALEXANDRIA, VA, 22313-1404, US

(21) Appl. No.: 09/905,859

(22) Filed: Jul. 17, 2001

(30) Foreign Application Priority Data
Jul. 17, 2000 (JP) 2000-216511
Jul. 11, 2001 (JP) 2001-211417

(51) Int. Cl. C03C 17/00

(52) U.S. Cl. 523/160

(57) ABSTRACT

A coloring composition having no paper-dependency, having excellent color developability and hue when printed on optionally selected paper, having excellent ink permeability with respect to paper for photographic image quality, leaving no stains directly after printing, having excellent water resistance and image fastness, enabling high recording concentration and high image quality, and which is suitable for water-based ink for writing, water-based printing ink, information recording ink and the like; and ink for ink jet recording, the ink using the coloring composition. The coloring composition includes a polymer latex and a coloring particulate dispersion including particulate composed of at least an oil-soluble dye and a hydrophobic organic solvent having a boiling point of no less than 150° C. The polymer latex preferably includes on a main chain or side chain thereof an ethylene unsaturated group. The oil-soluble dye is preferably an oil-soluble dye represented by general formula (I), (M-I), and (C-I) below.

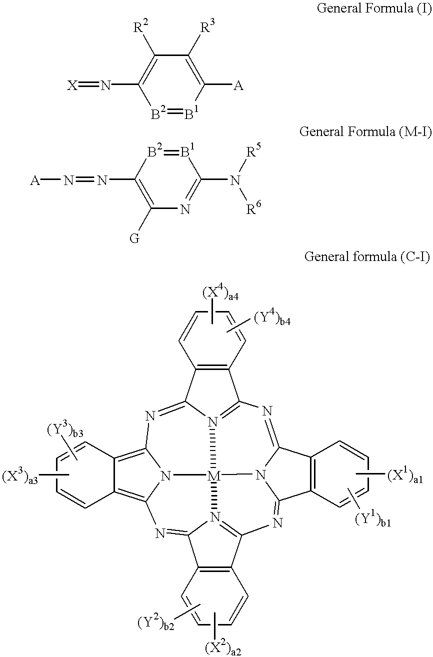

### BACKGROUND OF THE INVENTION

1. Field of the Invention

The present invention relates to a coloring composition including an oil-soluble dye appropriate for water-based copying ink, water-based printing ink, ink for information recordal and the like; ink for ink jet recording including the coloring composition; and an ink jet recording method using the ink for ink jet recording. More particularly, the present invention relates to ink for ink jet recording and an ink jet recording method in which the quality of an image recorded therewith is high, resistance to water and image fastness is excellent, and that is suitable for thermal, piezoelectric, electric field or acoustic ink jet formats.

2. Description of the Related Art

With the spread of computers in recent years, ink jet printers have become widely used for printing paper, film, cloth and the like not only in offices but also in the home. Oil-based inks, water-based inks and solid inks are known as inks for ink jet recording. In particular, water-based inks have been used more frequently than the other types of ink from the standpoints of production, handling, odor, safety and the like.

Although many such water-based inks have an advantage in that transparency and color concentration are high because water-soluble dyes that dissolve in a molecular state are used in the water-based inks, the same inks have drawbacks in that water resistance is poor because the dyes used in the inks are soluble in water, thus causing bleeding when printed on normal paper, whereby printing quality and resistance to light become remarkably poor.

Water-based inks that use pigments and dispersing dyes have been proposed, for example, in Japanese Patent Application Laid-Open (JP-A) No. 56-157468, JP-A No. 4-18468, JP-A No. 8-183920, JP-A No. 10-110126, JP-A No. 10-195355, in order to solve these problems.

However, in the case of these water-based inks, the problem remains that water resistance is still insufficient, although it is improved to a certain extent. In the case of pigment inks, there are problems in that coloring is inferior in comparison to dye inks, dispersion of pigment inks and dye inks show deficient storage stability, and clogging tends to occur at ink discharge ports.

Recently, recording paper (hereinafter sometimes referred to as “photo-quality paper”) having disposed on the surface thereof an ink receiving layer containing porous inorganic pigments have come to be used in response to an escalation in the demand for higher image quality in ink jet technology. However, there is the problem that water-based inks which use such pigments and dyes have poor retention, so that the pigment or dye is easily stripped from the surface of the recording paper when scratched or rubbed by one's hand.

Methods for containing dyes in polyurethane or polyester dispersion particulates have been proposed in JP-A No. 58-45272, JP-A No. 6-340835, JP-A No. 7-268254, JP-A No. 7-268257 and JP-A No. 7-268260.

However, the dispersion disclosed in these publications have drawbacks in that it becomes difficult to obtain coloring particulates having excellent dispersion stability when dyes are introduced at a desired concentration, and stripping of the dyes as described above occurs.

Moreover, JP-A No. 10-279873 discloses a method for making coloring polymer particulates by dissolving an acrylic polymer and an oil-soluble dye in an organic solvent, and removing the organic solvent after dispersion. However, there are problems with the quality of the recorded image, particularly the quality of the recorded image when recorded on a photo-quality paper medium, and with stability in regard to continuous recording. Further, stability of the dispersion over time is also insufficient.

Japanese Patent Application Publication (JP-B) No. 5-76977 discloses an ink composition in which an oil-soluble dye is dissolved and dispersed in an organic solvent having a low solubility in water and a specific gravity close to that of water. However, it has become clear that the organic solvent described therein has a poor recording concentration because its compatibility with oil-soluble dyes is generally insufficient and, depending on the circumstances, the dye is deposited during preservation, thus resulting in nozzles becoming clogged. There are also problems in terms of color reproducibility based on insufficiency of the hue of the oil-soluble dyes that are disclosed, and insufficient preservation stability of the image to be obtained.

### SUMMARY OF THE INVENTION

An object of the present invention is to provide a coloring composition having no paper-dependency, having excellent color developability and hue when printed on optionally selected paper, having excellent ink permeability with respect to paper for photographic image quality, leaving no stains directly after printing, having excellent water resistance and image fastness, enabling high recording concentration and high image quality, and which is suitable for water-based ink for writing, water-based printing ink, information recording ink and the like. A further object of the present invention is to provide ink for ink jet recording including the coloring composition, the ink for ink jet recording being suitable for thermal, piezoelectric or electric field or acoustic ink jet methods, having no paper dependency, having excellent color developability and hue when printed on optionally selected paper, having excellent ink permeability with respect to paper for photographic image quality, leaving no stains directly after printing, and having excellent water resistance and image fastness. A still further object of the present invention is to provide an ink jet recording method that uses the ink for ink jet recording and with which high image quality recording is possible.

The aforementioned object is achieved by the following means.

In accordance with a first aspect of the present invention, there is provided a coloring composition, the composition comprising a coloring particulate dispersion and polymer latex, the coloring particulate dispersion comprising at least an oil-soluble dye and a hydrophobic organic solvent, with the hydrophobic organic solvent having a boiling point of at least 150° C.

In accordance with a second aspect of the present invention, there is provided ink for ink jet recording, the ink comprising: a coloring particulate dispersion, the dispersion including particulate composed of at least an oil-soluble dye and a hydrophobic organic solvent, with the hydrophobic organic solvent having a boiling point of at least 150° C.; and polymer latex.

In accordance with a third aspect of the present invention, there is provided an ink jet recording method, the method comprising recording by using ink for ink jet recording, the ink comprising: coloring particulate dispersion, the dispersion including particulate composed of at least an oil-soluble dye and a hydrophobic organic solvent, with the hydrophobic organic solvent having a boiling point of at least 150° C.; and polymer latex.

### DESCRIPTION OF THE PREFERRED EMBODIMENTS

Description will be given hereinafter of a coloring composition, ink for ink jet recording, and an ink jet recording method of the present invention.

### Coloring Composition

The coloring composition of the present invention includes polymer latex and a coloring particulate dispersion comprising at least an oil-soluble dye and a hydrophobic organic solvent having a boiling point of no less than 150° C. (hereinafter, sometimes referred to as “hydrophobic high-boiling point organic solvent”).

The coloring particulate dispersion is obtained by dispersing in a water-based medium at least one of kind of each of the oil-soluble dye and the hydrophobic organic solvent having the boiling point of no less than 150° C. That is, the oil-soluble dye and the hydrophobic organic solvent having the high-boiling point are dispersed in a water-based medium as a coloring particulate dispersion having a fine particulate configuration, and exist in an emulsified dispersed state.

It should be noted that “water-based medium” in the present invention means water, or a mixture of water and a small amount of a water-miscible organic solvent to which additives such as surfactants, wetting agents, stabilizers and antiseptic agents have been added as needed.

Oil-soluble dye

The oil-soluble dye included in the coloring particulate dispersion will now be described.

Among oil-soluble dyes that are usable in the present invention, any yellow dye can be used. Examples thereof include aryl or heterylazo dyes having phenols, naphthols, anilines, pyrazolones, pyridones or opened-type active methylene compounds as a coupling component; azomethine dyes having opened-type active methylene compounds as a coupling component; methine dyes such as benzylidene dyes, monomethineoxonol dyes and the like; quinone-based dyes such as naphthoquinone dyes, anthraquinone dyes and the like; and other compound. Additionally, dyes such as quinophthalone dyes, nitro.nitroso dyes, acrydine dyes, acrydinone dyes and the like can also be used.

Among oil-soluble dyes that are usable in the present invention, any magenta dye can be used. Examples thereof include aryl or heterylazo dyes having phenols, naphthols or anilines as a coupling component; azomethine dyes having pyrazolones or pyrazolotriazoles as a coupling component; methine dyes such as arylidene dyes, styryl dyes, merocyanine dyes or oxonol dyes; carbonium dyes such as diphenylmethane dyes, triphenylmethane dyes or xanthene dyes; quinone-based dyes such as naphthoquinone, anthraquinone, anthrapyridone and the like; condensed polycyclic dyes such as dioxazine dyes and the like; and other compounds.

Among oil-soluble dyes that are usable in the present invention, any cyan dye can be used. Examples thereof include azomethine dyes such as indoaniline dyes or indophenol dyes; polymethine dyes such as cyanine dyes, oxonol dyes, merocyanine dyes and the like; carbonium dyes such as diphenylmethane dyes, triphenylmethane dyes or xanthene dyes; phthalocyanine dyes; anthraquinone dyes; aryl or heterylazo dyes having phenols, naphthols or anilines as a coupling component; indigo.thioindigo dyes; and the like.

Though each of the aforementioned dyes has a chromophore in the structure, dyes which do not develop color (yellow, magenta, cyan or the like) until decomposition of a part of the chromophore can also be used in the present invention. As a counter cation to be decomposed, inorganic cations such as cations of alkali metals, ammonium ions and the like may be used, or organic cations such as pyridinium ions, quaternary ammonium ions and the like may be used and, further, polymer cations containing these cations as a part of the structure may also be used.

The following dyes are listed as preferable, specific examples of the aforementioned oil-soluble dyes, but the present invention is by no means limited to the same.

For example, C.I. Solvent Black 3, 7, 27, 29 and 34; C.I. Solvent Yellow 14, 16, 19, 29, 30, 56, 82, 93 and 162; C.I. Solvent Red 1, 3, 8, 18, 24, 27, 43, 49, 51, 72, 73, 109, 122, 132 and 218; C.I. Solvent Violet 3; C.I. Solvent Blue 2, 11, 25, 35 and 70; C.I. Solvent Green 3 and 7; and C.I. Solvent Orange 2, and the like are preferable.

Of these, particularly preferable are Nubian Black PC-0850, Oil Black HBB, Oil Yellow 129, Oil Yellow 105, Oil Pink 312, Oil Red 5B, Oil Scarlet 308, Vali Fast Blue 2606, Oil Blue BOS (manufactured by Orient Kagaku K.K.), Neopen Yellow 075, Neopen Magenta SE 1378, Neopen Blue 808, Neopen Blue FF 4012, Neopen Cyan FF 4238 (manufactured by BASF) and the like.

In the present invention, a dispersing dye can be used in an amount such that the dispersing dye is dissolved in a non-water miscible organic solvent. The following dispersing dyes can be listed as preferable, specific examples, but the present invention is by no means limited to the same.

For example, C.I. Disperse Yellow 5, 42, 54, 64, 79, 82, 83, 93, 99, 100, 119, 122, 124, 126, 160, 184:1, 186, 198, 199, 201, 204, 224 and 237; C.I. Disperse Orange 13, 29, 31:1, 33, 49, 54, 55, 66, 73, 118, 119 and 163; C.I. Disperse Red 54, 60, 72, 73, 86, 88, 91, 92, 93, 111, 126, 127, 134, 135, 143, 145, 152, 153, 154, 159, 164, 167, 177, 181, 204, 206, 207, 221, 239, 240, 258, 277, 278, 283, 311, 323, 343, 348, 356 and 362; C.I. Disperse Violet 33; C.I. Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365 and 368; C.I. Disperse Green 6:1 and 9; and the like are preferable.

Of the preceding oil-soluble dyes, compounds represented by the following general formulae (I), (M-I) and (C-I) are preferable. Among the compounds represented by these formulae, the compounds represented by general formulae (M-I) and (C-I) are particularly preferable as magenta pigments and cyan pigments.

Hereafter, the compound represented by the general formula (I) will be described. It should be noted that compounds in which at least one of groups in the general formula (I) is a group included in a preferable range indicated below are preferable, and compounds in which more groups are in a preferable range are more preferable, with those in which all the groups are in a preferable range being most preferable.

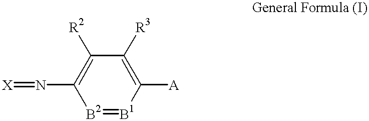

In the above-mentioned general formula (I), X represents a residual group of a color coupler, A represents —NR⁴R⁵ or a hydroxy group, R⁴ and R⁵ each independently represents a hydrogen atom, aliphatic group, aromatic group or heterocyclic group. A is preferably —NR⁴R⁵. R⁴ and R⁵ each independently represents preferably a hydrogen atom or aliphatic group, and further preferably a hydrogen atom, alkyl group or substituted alkyl group, and most preferably a hydrogen atom, an alkyl group having 1 to 18 carbon atoms or a substituted alkyl group having 1 to 18 carbon atoms.

In the above-described formula (I), B¹ represents ═C(R⁶)— or ═N—, and B² represents —C(R⁷)═ or —N═. It is preferable that B¹ and B² do not simultaneously represent —N═, and it is more preferable that B¹ represents ═C(R⁶)— and B² represents —C(R⁷)═.

In the general formula (I), R², R³, R⁶ and R⁷ each independently represents a hydrogen atom, halogen atom, aliphatic group, aromatic group, heterocyclic group, cyano group, —OR⁵¹, —SR⁵², —CO₂R⁵³, —OCOR⁵⁴, —NR⁵⁵R⁵⁶, —CONR⁵⁷R⁵⁸, —SO₂R⁵⁹, —SO₂NR⁶⁰R⁶¹, —NR⁶²CONR⁶³R⁶⁴, —NR⁶⁵CO₂R⁶⁶, —COR⁶⁷, —NR⁶⁸COR⁶⁹ or —NR⁷⁰SO₂R⁷¹, and R⁵¹, R⁵², R⁵³, R⁵⁴, R⁵⁵, R⁵⁶, R⁵⁷, R⁵⁸, R⁵⁹, R⁶⁰, R⁶¹, R⁶², R⁶³, R⁶⁴, R⁶⁵, R⁶⁶, R⁶⁷, R⁶⁸, R⁶⁹, R⁷⁰, and R⁷¹ each independently represents a hydrogen atom, aliphatic group or aromatic group.

R² and R⁷ each independently represents, among the above-mentioned moieties, preferably a hydrogen atom, halogen atom, aliphatic group, —OR⁵¹, —NR⁶²CONR⁶³R⁶⁴, —NR⁶⁵CO₂R⁶⁶, —NR⁶⁸COR⁶⁹, or —NR⁷⁰SO₂R⁷¹, further preferably a hydrogen atom, fluorine atom, chlorine atom, alkyl group, substituted alkyl group, —NR⁶²CONR⁶³R⁶⁴, or —NR⁶⁸COR⁶⁹, still further preferably a hydrogen atom, chlorine atom, alkyl group having 1 to 10 carbon atoms, or substituted alkyl group having 1 to 10 carbon atoms, and most preferably a hydrogen atom, alkyl group having 1 to 4 carbon atoms, or substituted alkyl group having 1 to 4 carbon atoms.

R³ and R⁶ each independently represents, among the above-mentioned moieties, preferably a hydrogen atom, halogen atom, or aliphatic group, further preferably a hydrogen atom, fluorine atom, chlorine atom, alkyl group, or substituted alkyl group, still further preferably a hydrogen atom, chlorine atom, alkyl group having 1 to 10 carbon atoms, or substituted alkyl group having 1 to 10 carbon atoms, and most preferably a hydrogen atom, alkyl group having 1 to 4 carbon atoms, or substituted alkyl group having 1 to 4 carbon atoms.

In the general formula (I), R² and R³, R³ and R⁴, R⁴ and R⁵, R⁵ and R⁶, or R⁶ and R⁷ may bond with each other to form rings. As a combination to form rings, combinations of R³ and R⁴, R⁴ and R⁵, and R⁵ and R⁶ are preferable.

A ring formed by mutual bonding of R² and R³, or R⁶ and R⁷ is preferably a 5-membered ring or 6-membered ring. The ring is preferably an aromatic ring (for example, a benzene ring) or an unsaturated heterocyclic ring (for example, a pyridine ring, imidazole ring, thiazole ring, pyrimidine ring, pyrrole ring, or furan ring).

A ring formed by mutual bonding of R³ and R⁴, or R⁵ and R⁶ is preferably a 5-membered ring or 6-membered ring. Examples of the ring include a tetrahydroquinoline ring and dihydroindole ring.

A ring formed by mutual bonding of R⁴ and R⁵ is preferably a 5-membered ring or 6-membered ring. Examples of the ring include a pyrrolidine ring, piperidine ring and morpholine ring.

In the present specification, aliphatic group means an alkyl group, substituted alkyl group, alkenyl group, substituted alkenyl group, alkinyl group, substituted alkinyl group, aralkyl group or substituted aralkyl group.

The alkyl group may have branching, or may form a ring. The number of carbon atoms in the alkyl group is preferably from 1 to 20, and further preferably from 1 to 18.

An alkyl moiety of the substituted alkyl group is the same as in the above-mentioned alkyl group.

The alkenyl group may have branching, or may form a ring. The number of carbon atoms in the alkenyl group is preferably from 2 to 20, and further preferably from 2 to 18.

An alkenyl moiety of the substituted alkenyl group is the same as in the above-mentioned alkenyl group.

The alkinyl group may have branching, or may form a ring. The number of carbon atoms in the alkinyl group is preferably from 2 to 20, and further preferably from 2 to 18.

An alkinyl moiety of the substituted alkinyl group is the same as in the above-mentioned alkinyl group.

An alkyl moiety of the aralkyl group and substituted aralkyl group is the same as in the above-mentioned alkyl group. An aryl moiety of the aralkyl group and substituted aralkyl group is the same as in the following aryl group.

Examples of substituents on the substituted alkyl group, substituted alkenyl group, substituted alkinyl group and substituents on an alkyl moiety of the substituted aralkyl group include a halogen atom, cyano group, nitro group, heterocyclic group, —OR¹¹¹, —SR¹¹², —CO₂R¹¹³, —NR¹¹⁴R¹¹⁵, —CONR¹¹⁶R¹¹⁷, —SO₂R¹¹⁸, and —SO₂NR¹¹⁹R¹²⁰. R¹¹¹, R¹¹², R¹¹³, R¹¹⁴, R¹¹⁵, R¹¹⁶, R¹¹⁷, R¹¹⁸, R¹¹⁹ and R¹²⁰ each independently represents a hydrogen atom, aliphatic group or aromatic group.

Examples of substituents on an aryl moiety of the substituted aralkyl group are the same as the following examples of substituents on the substituted aryl group.

In the present specification, aromatic group means an aryl group or substituted aryl group. The aryl group is preferably a phenyl group or naphthyl group, and particularly preferably a phenyl group.

An aryl moiety of the substituted aryl group is the same as in the above-mentioned aryl group.

Examples of substituents on the substituted aryl group include a halogen atom, cyano group, nitro group, aliphatic group, heterocyclic group, —OR¹²¹, —SR¹²², —CO₂R¹²³, —NR¹²⁴R¹²⁵, —CONR¹²⁶R¹²⁷, —SO₂R¹²⁸, and —SO₂NR¹²⁹R¹³⁰. R¹²¹, R¹²², R¹²³, R¹²⁴, R¹²⁵, R¹²⁶, R¹²⁷, R¹²⁸, R¹²⁹ and R¹³⁰ each independently represents a hydrogen atom, aliphatic group or aromatic group.

In the present specification, examples of the heterocyclic group include both groups having a saturated ring and groups having an unsaturated ring. The heterocyclic ring is preferably a 5-membered or 6-membered ring. Further, the heterocyclic ring may be condensed with an aliphatic ring, aromatic ring or other heterocyclic ring.

Examples of the heteroatom in the heterocyclic ring include boron atoms, nitrogen atoms, oxygen atoms, sulfur atoms, selenium atoms, and tellurium atoms. Of these, nitrogen, oxygen and sulfur are preferable.

A heterocyclic group in which a carbon atom, among atoms constituting the heterocyclic ring, has free atomic valency (monovalency) is preferable (a heterocyclic group is bonded at a carbon atom).

Examples of the saturated heterocyclic ring include a pyrrolidine ring, morpholine ring, 2-bora-1,3-dioxorane ring and 1,3-thiazolidine ring.

Examples of the unsaturated heterocyclic ring include an imidazole ring, thiazole ring, benzothiazole ring, benzooxazole ring, banzotriazole ring, benzoselenazole ring, pyridine ring, pyrimidine ring and quinoline ring.

The heterocyclic group may have a substituent. Examples of this substituent include a halogen atom, cyano group, nitro group, aliphatic group, aromatic group, heterocyclic group, —OR¹³¹, —SR¹³², —CO₂R¹³³, —NR¹³⁴R¹³⁵, —CONR¹³⁶R¹³⁷, —SO₂R¹³⁸, and —SO₂NR¹³⁹R¹⁴⁰. R¹³¹, R¹³², R¹³³, R¹³⁴, R¹³⁵, R¹³⁶, R¹³⁷, R¹³⁸, R¹³⁹, and R¹⁴⁰ each independently represents a hydrogen atom, aliphatic group or aromatic group.

The following couplers are preferable.

Examples of the yellow coupler include couplers represented by formulae (I) and (II) described in U.S. Pat. No. 3,933,501, U.S. Pat. No. 4,022,620, U.S. Pat. No. 4,326,024, U.S. Pat. No. 4,401,752 and U.S. Pat. No. 4,248,961, Japanese Patent Application Publication (JP-B) No. 58-10739, GB Patent Nos. 1,425,020 and 1,476,760, U.S. Pat. No. 3,973,968, U.S. Pat. No. 4,314,023 and U.S. Pat. No. 4,511,649, EU Patent Nos. 249,473A and 502,424A, couplers represented by formulae (1) and (2) described in EU Patent No. 513,496A (particularly Y-28 described on page 18), couplers represented by formula (1) described in claim 1 of EU Patent No. 568,037A, couplers represented by the general formula (1) described in U.S. Pat. No. 5,066,576, column 1, line 45 to 55, couplers represented by general formula (1) described in JP-A No. 4-274425, paragraph 0008, couplers represented by formula (1) described in EU Patent No. 498,381A1, p. 40, claim 1 (particularly D-35 described on page 18), couplers represented by the formula (Y) described in EU Patent No. 447,969A, p. 4 (particularly Y-1 (page 17) and Y-54 (page 41)) and couplers represented by formulae (II) to (IV) described in U.S. Pat. No. 4,476,219, column 7, lines 36 to 58 (particularly II-17, 19 (column 17) and II-24 (column 19)).

Examples of the magenta coupler include the compounds described in U.S. Pat. No. 4,310,619 and U.S. Pat. No. 4,351,897, EU Patent No. 73,636, U.S. Pat. Nos. 3,061,432, 3,725,067, Research Disclosure Nos. 24220 (June 1984) and 24230 (June 1984), JP-A Nos. 60-33552, 60-43659, 61-72238, 60-35730, 55-118034 and 60-185951, U.S. Pat. No. 4,500,630, U.S. Pat. No. 4,540,654 and U.S. Pat. No. 4,556,630, International Publication WO 88/04795, JP-A Nos. 3-39737 (L-57 (page 11, lower right column), L-68 (page 12, lower right column, L-77 (page 13, lower right column), [A-4]-63 (page 134), [A-4]-73,-75 (page 139) described in EU Patent No. 456,257, M-4,-6 (page 26), M-7 (page 27) described in EU Patent No. 486,965, M-458 (page 19) described in EU Patent No. 571,959A, (M-1) described in JP-A No. 5-204106 (page 6), and M-22 described in JP-A No. 4-362631, paragraph 0237.

Examples of the cyan coupler include the compounds described in U.S. Pat. No. 4,052,212, U.S. Pat. No. 4,146,396, U.S. Pat. No. 4,228,233 and U.S. Pat. No. 4,296,200, EU Patent No. 73,636, and CX-1, 3, 4, 5, 11, 12, 14, and 15 (pages 14 to 16) described in JP-A No. 4-204843; C-7, 10 (page 35), 34, 35 (page 37), I-1, I-17 (pages 42 to 43) described in JP-A No. 4-43345; and couplers represented by general formula (Ia) or (Ib) described in JP-A No. 6-67385, claim 1.

In addition, couplers described in JP-A Nos. 62-215272 (page 91) and 2-33144 (pages 3, 30) and EP 355,660A (pages 4, 5, 45, 47) are also useful.

Of compounds represented by the above-mentioned general formula (I), compounds represented by the following general formula (II) are particularly preferably used as the magenta dye.

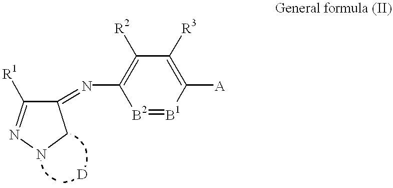

In the general formula (II), R¹ represents a hydrogen atom, aliphatic group, aromatic group, heterocyclic group, cyano group, —OR¹¹, —SR¹², —CO₂R¹³, —OCOR¹⁴, —NR¹⁵R¹⁶, —CONR¹⁷R¹⁸, —SO₂R¹⁹, —SO₂NR²⁰R²¹, —NR²²CONR²³R²⁴, —NR²⁵CO₂R²⁶, —COR²⁷, —NR²⁸COR²⁹, or —NR³⁰SO₂R³¹, and R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸, R²⁹, R³⁰, and R³¹ each independently represents a hydrogen atom, aliphatic group or aromatic group. R², R³, A, B¹ and B² are as defined in the general formula (I), and preferable ranges thereof are the same.

In the above-mentioned general formula (II), D represents a group of atoms forming a 5-membered or 6-membered nitrogen-containing heterocyclic ring which may be substituted by at least one of an aliphatic group, aromatic group, heterocyclic group, cyano group, —OR⁸¹, —SR⁸², —CO₂R⁸³, —OCOR⁸⁴, —NR⁸⁵R⁸⁶, —CONR⁸⁷R⁸⁸, —SO₂R⁸⁹, —SO₂NR⁹⁰R⁹¹, —NR⁹²CONR⁹³R⁹⁴, —NR⁹⁵CO₂R⁹⁶, —COR⁹⁷, —NR⁹⁸COR⁹⁹, or —NR¹⁰⁰SO₂R¹⁰¹, and this heterocyclic ring may further form a fused ring with other ring.

Here, R⁸¹, R⁸², R⁸³, R⁸⁴, R⁸⁵, R⁸⁶, R⁸⁷, R⁸⁸, R⁸⁹, R⁹⁰, R⁹¹, R⁹², R⁹³, R⁹⁴, R⁹⁵, R⁹⁶, R⁹⁷, R⁹⁸, R⁹⁹, R¹⁰⁰, and R¹⁰¹ each independently represents a hydrogen atom, aliphatic group or aromatic group.

In the general formula (II), R¹ is preferably a hydrogen atom, aliphatic group, aromatic group, —OR¹¹, —SR¹², —NR¹⁵R¹⁶, —SO₂R¹⁹, —NR²²CONR²³R²⁴, —NR²⁵CO₂R²⁶, —NR²⁸COR²⁹, or —NR³⁰SO₂R³¹, more preferably a hydrogen atom, aliphatic group, aromatic group, —OR¹¹, or —NR¹⁵R¹⁶, still more preferably a hydrogen atom, alkyl group, substituted alkyl group, aryl group, substituted aryl group, alkoxy group, substituted alkoxy group, phenoxy group, substituted phenoxy group, dialkylamino group, or substituted dialkylamino group, further preferably a hydrogen atom, alkyl group having 1 to 10 carbon atoms, substituted alkyl group having 1 to 10 carbon atoms, aryl group having 6 to 10 carbon atoms or substituted aryl group having 6 to 10 carbon atoms, and most preferably a hydrogen atom, alkyl group having 1 to 6 carbon atoms, or substituted alkyl group having 1 to 6 carbon atoms.

In the general formula (II), it is preferable that A is —NR⁴R⁵. D preferably forms a 5-membered nitrogen-containing heterocyclic ring, and examples of the 5-membered nitrogen-containing heterocyclic ring include an imidazole ring, triazole ring and tetrazole ring.

Of compounds represented by the above-mentioned general formula (II), pyrazolotriazoleazomethine compounds represented by the following general formula (III) are preferable.

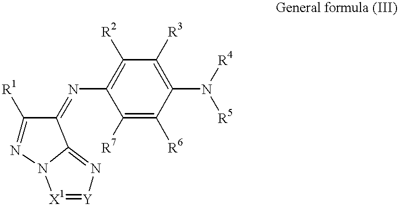

In general formula (III), R¹, R², R³, R⁴, R⁵, R⁶ and R⁷ have the same definitions as in the above-mentioned general formula (II). X¹ and Y each independently represents —C(R⁸)═ or —N═, R⁸ represents a hydrogen atom, aliphatic group or aromatic group, one of X¹ and Y is necessarily —N═, and X¹ and Y do not simultaneously represent —N═.

In general formula (III), R⁸ represents preferably a hydrogen atom, alkyl group, substituted alkyl group, aryl group, or substituted aryl group, further preferably a hydrogen atom, alkyl group having 1 to 150 carbon atoms, or substituted aryl group having 6 to 150 carbon atoms, and most preferably an alkyl group having 1 to 100 carbon atoms, or substituted aryl group having 6 to 100 carbon atoms.

Of compounds represented by the above-mentioned general formula (III), pyrazolotriazoleazomethine compounds in which X¹ is —N═, and Y is —C(R⁸)═ are preferable.

Exemplified compounds (M-1 to 16) of the pyrazolotriazoleazomethine compound represented by the general formula (II) are listed below. However, the present invention is by no means limited to the same.

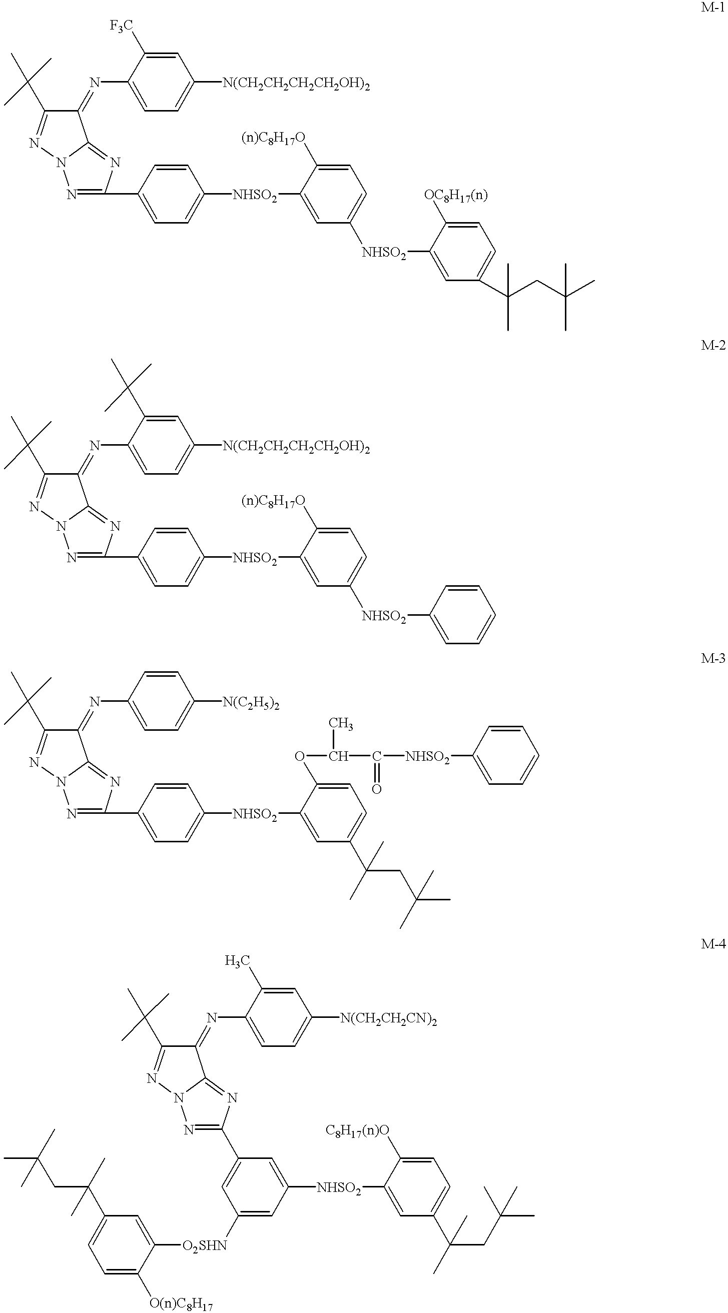

Examples of compounds usable in the present invention include, but are not limited to, exemplified compounds described in Japanese Patent Application No. 2000-78491.

The compound represented by the general formula (II) can be synthesized, for example, by referring to methods described in, Japanese Patent Application Laid-Open (JP-A) No. 4-126772, Japanese Patent Application Publication (JP-B) No.7-94180, and Japanese Patent Application No. 2000-78491.

As the cyan dye, pyrrolotriazoleazomethine compounds represented by the following general formulae (IV-1) to (IV-4) are particularly preferably used.

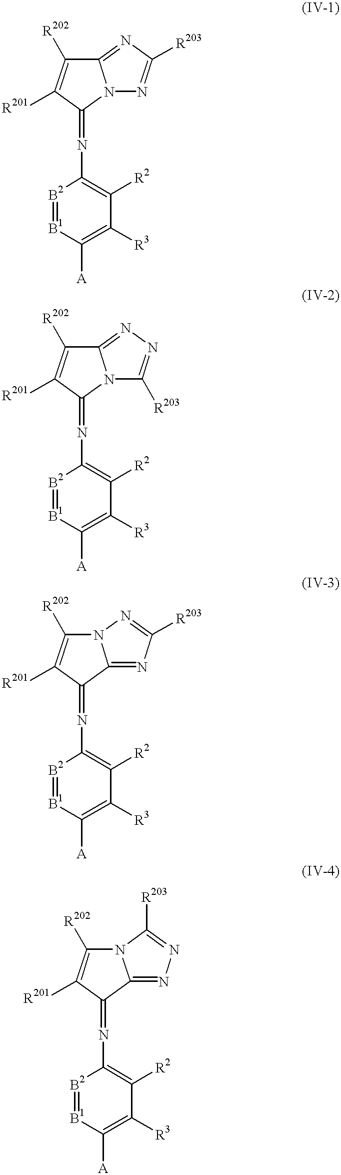

In the general formulae (IV-1) to (IV-4), A, R², R³, B¹ and B² have the same definitions as in the general formula (I), and preferable ranges thereof are the same. R²⁰¹, R²⁰² and R²⁰³ each respectively independently has the same definition as R¹ in the general formula (II). R²⁰¹ and R²⁰² may bond mutually to form a ring structure.

Further, pyrrolotriazoleazomethine compounds represented by the general formulae (IV-1) to (IV-4) in which R²⁰¹ is an electron withdrawing group having Hammett substituent constant σₚ value of 0.30 or more manifest sharp absorption and are more preferable.

Pyrrolotriazoleazomethine compounds in which the sum of Hammett substituent constant σₚ values of R²⁰¹ and R²⁰² is 0.70 or more manifest excellent hue as cyan color, and are further preferable.

Description will here be given on hue of the pyrrolotriazoleazomethine compounds represented by the general formulae (IV-1) to (IV-4).

Pyrrolotriazoleazomethine compounds represented by the general formulae (IV-1) to (IV-4) can manifest various hues depending on combination of R²⁰¹, R²⁰², R²⁰³ and R², R³, A, B¹ and B².

When the pyrrolotriazoleazomethine compounds represented by the general formulae (IV-1) to (IV-4) are one in which R²⁰¹ is a substituent having electron withdrawing property, they manifest a sharper absorption wave form and are particularly preferable as compared with compounds in which R²⁰¹ is not an electron withdrawing substituent. In consideration of this point, it is more preferable that R²⁰¹ is an electron withdrawing group having a Hammett substituent constant σₚ value of 0.30 or more than that R²⁰¹ is an alkyl group or aryl group. Further, an electron withdrawing group having a Hammett substituent constant σₚ value of 0.45 or more is more preferable, and the same having a Hammett substituent constant σₚ value of 0.60 or more is most preferable.

The above-mentioned pyrrolotriazoleazomethine compound can be used as a magenta pigment or cyan pigment. It is more preferable to use this compound as a cyan pigment. Further, pyrrolotriazoleazomethine compounds represented by the general formulae (IV-1) to (IV-4) can also be used as a magenta pigment.

In order to use of pyrrolotriazoleazomethine compounds represented by the general formulae (IV-1) to (IV-4) as a cyan pigment, it is preferable that the sum of Hammett substituent constant σₚ values of R²⁰¹ and R²⁰² is 0.70 or more. When this sum is less than 0.70, the absorption maximum wavelength is short for a cyan pigment, undesirably. Among others, those in which R²⁰² has a Hammett substituent constant σₚ value of 0.30 or more are preferable. The sum of Hammett substituent constant σₚ values of R²⁰¹ and R²⁰² is preferably 2.0 or less.

Examples of the electron withdrawing group having a Hammett substituent constant σₚ value of 0.30 or more include acyl groups, acyloxy groups, carbamoyl groups, alkoxycarbonyl groups, aryloxycarbonyl groups, cyano groups, nitro groups, alkylsulfinyl groups, arylsulfinyl groups, alkylsulfonyl groups, arylsulfonyl groups, sulfamoyl groups, halogenated alkyl groups, halogenated alkoxy groups, halogenated aryloxy groups, halogenated alkylthio groups, aryl groups substituted with two or more electron withdrawing groups having a σₚ value of 0.15 or more, and heterocyclic rings.

More specifically, examples include acyl groups (for example, acetyl, 3-phenylpropanoyl), acyloxy groups (for example, acetoxy), canbamoyl groups (for example, N-ethylcarbamoyl, N,N-dibutylcarbamoyl, N-(2-dodecyloxyethyl)carbamoyl, N-methyl-N-dodecylcarbamoyl), alkoxycarbonyl groups (for example, methoxycarbonyl, butyloxycarbonyl, dodecyloxycarbonyl, octadecyloxycarbonyl), aryloxycarbonyl groups (for example, phenoxycarbonyl), cyano groups, nitro groups, alkylsulfinyl groups (for example, 3-phenoxypropylsulfinyl), arylsulfinyl groups (for example, 3-pentadecylphenylsulfinyl), alkylsulfonyl groups (for example, methanesulfonyl, octanesulfonyl), arylsulfonyl groups (for example, benzenesulfonyl), sulfamoyl groups (for example, N-ethylsulfamoyl, N,N-dipropylsulfamoyl), halogenated alkyl groups (for example, trifluoromethyl, heptafluoropropyl), halogenated alkoxy groups (for example, trifluoromethyloxy), halogenated aryloxy groups (for example, pentafluorophenyloxy), halogenated alkylthio groups (for example, difluoromethylthio), aryl groups substituted with two or more electron withdrawing groups having a σₚ value of 0.15 or more (for example, 2,4-dinitrophenyl, 2,4,6-trichlorophenyl, pentachlorophenyl), and heterocyclic rings (for example, 2-benzooxazolyl, 2-benzothiazolyl, 1-phenyl-2-benzimidazolyl, 5-chloro-1-tetrazolyl, 1-pyrrolyl).

Examples of the electron withdrawing group having a Hammett substituent constant σₚ value of 0.45 or more acyl groups (for example, acetyl, 3-phenylpropanoyl), alkoxycarbonyl groups (for example, methoxycarbonyl), aryloxycarbonyl groups (for example, m-chlorophenoxycarbonyl), cyano group, nitro group, alkylsulfinyl groups (for example, n-propylsulfinyl), arylsulfinyl groups (for example, phenylsulfinyl), alkylsulfonyl groups (for example, methanesulfonyl and n-octanesulfonyl), arylsulfonyl groups (for example, benzenesulfonyl), sulfamoyl groups (for example, N-ethylsulfamoyl and N,N-dimethylsulfamoyl), and halogenated alkyl groups (for example, trifluoromethyl).

As the electron withdrawing group having a Hammett substituent constant σₚ value of 0.60 or more, examples include a cyano group (0.66), nitro group (0.78) and methanesulfonyl group (0.72).

As the combination in which the sum of σₚ values of R²⁰¹ and R²⁰² is 0.70 or more, combinations in which R²⁰¹ is selected from cyano groups, alkoxycarbonyl groups, alkylsulfonyl groups, arylsulfonyl groups and halogenated alkyl groups, and R²⁰² is selected from acyl groups, acyloxy groups, carbamoyl groups, alkoxycarbonyl groups, aryloxycarbonyl groups, cyano group, alkylsulfonyl groups, arylsulfonyl groups, sulfamoyl groups and halogenated alkyl groups are preferable.

The pyrrolotriazoleazomethine compound used in the present invention has a preferable structure is selected from compounds represented by the following general formula (IV-1a), in which R² is a hydrogen atom, alkyl group having 1 to 4 carbon atoms, substituted alkyl group having 1 to 4 carbon atoms, alkoxy group having 1 to 4 carbon atoms, halogen atom (fluorine, chlorine, or bromine), acylamino group having 1 to 5 carbon atoms, aminocarbonylamino group having 1 to 5 carbon atoms or alkoxycarbonylamino group having 2 to 5 carbon atoms; R⁴ and R⁵ each independently is a hydrogen atom, alkyl group having 1 to 18 carbon atoms or substituted alkyl group having 1 to 18 carbon atoms; R²⁰¹ and R²⁰² each independently represents an electron withdrawing group having a Hammett substituent constant σₚ value of 0.30 or more, and R²⁰³ is an alkyl group having 1 to 18 carbon atoms, substituted alkyl group having 1 to 18 carbon atoms, or substituted or unsubstituted aryl group having 6 to 20 carbon atoms.

When the aforementioned pyrrolotriazoleazomethine compounds are used as a cyan pigment, those of the above-mentioned groups in which the sum of Hammett substituent constant σₚ values of R²⁰¹ and R²⁰² is 0.70 or more are preferable, and those in which the sum of a p values is 1.00 or more are further preferable.

The pyrrolotriazoleazomethine compound used in the present invention has a most preferable structure selected from compounds represented by the general formula (IV-1a) in which R² is a hydrogen atom or methyl group; R⁴ and R⁵ each independently is an alkyl group having 1 to 5 carbon atoms; R²⁰¹ is a cyano group; R²⁰² is an alkoxycarbonyl group; and R²⁰³ is an aryl group.

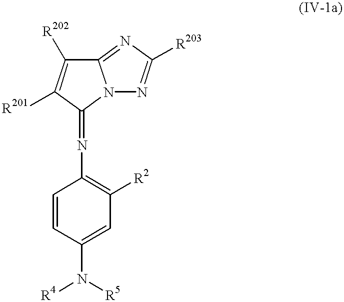

The Hammett substituent constant used in the present specification is described in Japanese Patent Application No. 11-365188, and the σₚ value in the present invention is also as defined in the same.

Exemplified compounds (C-1 to 9) of the pyrrolotriazoleazomethine compound used in the present invention will be listed only for illustrating the present invention in detail; however, these compounds do not limit the scope of the present invention.

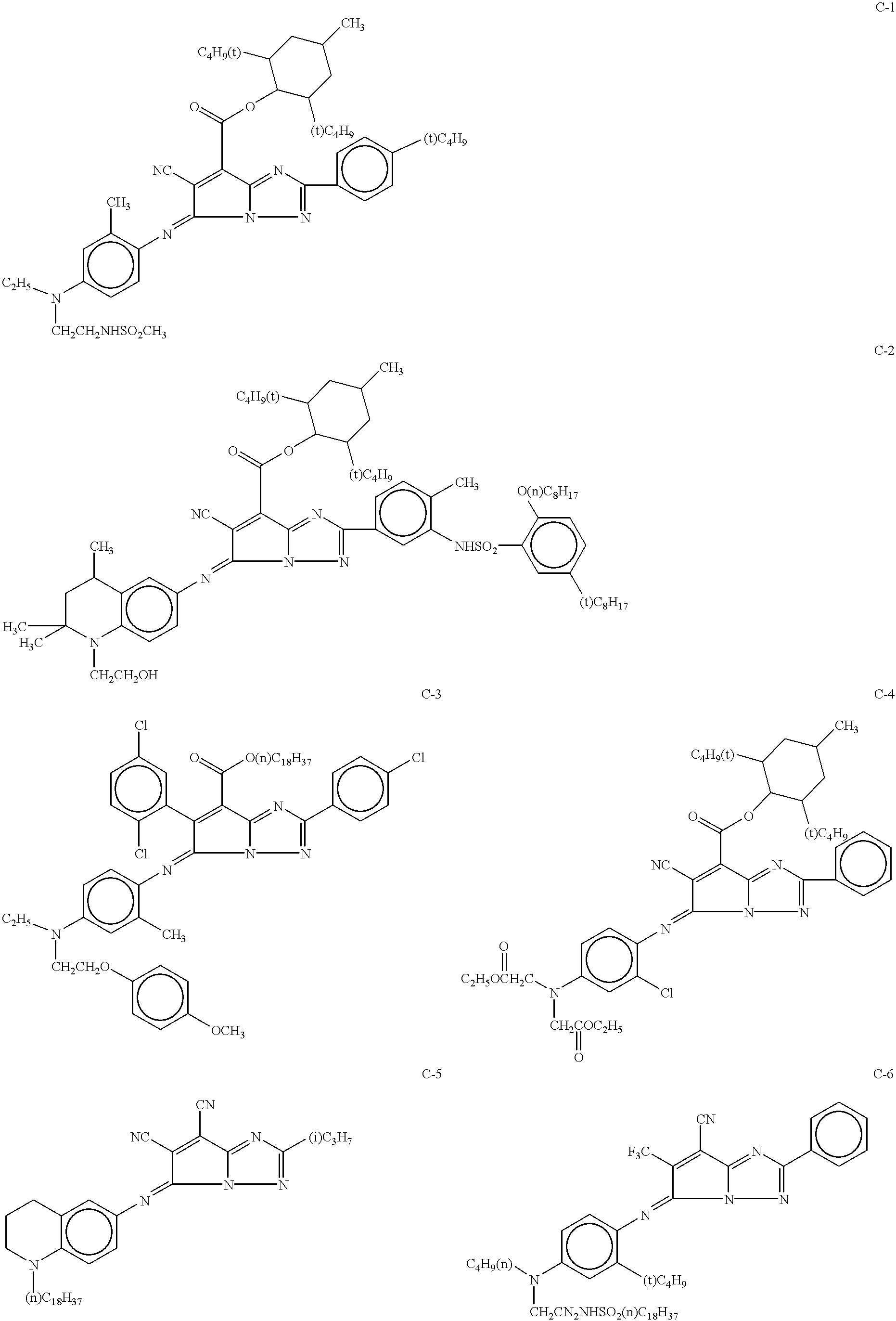

Examples of compounds usable in the present invention further include the exemplified compounds described in Japanese Patent Application No. 11-365188. However, the present invention is by no means limited to the same.

The pyrrolotriazoleazomethine pigment represented by the general formulae (IV-1) to (IV-4) can be synthesized referring to methods described in JP-A Nos. 5-177959, 9-292679, 10-62926, and Japanese Patent Application No. 11-365188.

It is preferable to use the compound (hereinafter, occasionally referred to as “azo dye”) represented by the following general formula (M-I) as the oil-soluble dye in the present invention. Explanation will now be given of the compound represented by the general formula (M-I).

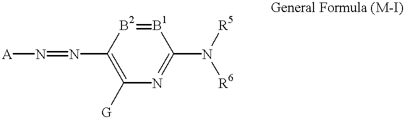

In the general formula (M-I), A represents a 5-membered heterocyclic ring diazo component A—NH₂.

As for B¹ and B², B¹ represents ═CR¹— and B² represents —CR²═, or one represents a nitrogen atom and while the other represents ═CR¹— or —CR²═.

R⁵ and R⁶ each independently represents hydrogen atoms, aliphatic groups, aromatic groups, heterocyclic groups, acyl groups, alkoxycarbonyl groups, aryloxycarbonyl groups, carbamoyl groups, alkylsulfonyl groups, arylsulfonyl groups or sulfamoyl groups. Each of these groups may also have substituent groups.

G, R¹ and R² each independently represents hydrogen atoms, halogen atoms, aliphatic groups, aromatic groups, heterocyclic groups, cyano groups, carboxyl groups, carbamoyl groups, alkoxycarbonyl groups, aryloxycarbonyl groups, acyl groups, hydroxy groups, alkoxy groups, aryloxy groups, silyloxy groups, acyloxy groups, carbomoyloxy groups, heterocyclic oxy groups, alkoxycarbonyloxy groups, aryloxycarbonyloxy groups, amino groups substituted by alkyl groups or aryl groups or heterocyclic groups, acylamino groups, ureide groups, sulfamoylamino groups, alkoxycarbonylamino groups, alkylarylsulfonylamino groups, arylsulfonylamino groups, alyloxycarbonylamino groups, nitro groups, alkylthio groups, arylthio groups, alkylsulfonyl groups, arylsulfonyl groups, alkylsulfinyl groups, arylsulfinyl groups, sulfamoyl groups, sulfo groups or heterocyclic thio groups. Each of these groups may also have substituent groups.

Further, R¹ and R⁵, or R⁵ and R⁶, may also be bonded to form a 5-6 membered ring.

The oil-soluble compound represented by general formula (M-I) of the present invention will now be described.

In general formula (M-I), A represents a 5-membered heterocyclic group diazo component A—NH₂ residual group. Examples of the 5-membered heterocyclic heteroatoms include N, O and S. Preferable is an included nitrogen 5-membered heterocyclic ring, and an aliphatic group, aromatic group or other heterocyclic ring may be bonded to the heterocyclic ring.

Preferable examples of the A heterocyclic ring include pyrazole rings, imidazole rings, thiazole rings, isothiazole rings, thiadiazole rings, benzothiazole rings, benzooxazole rings, and benzoisothiazole rings. Each of these heterocyclic rings may also have substituents. Among these, the pyrazole rings, imidazole rings, isothiazole rings, thiadiazole rings and benzothiazole rings are represented by the general formulae (M-a) through (M-f) are preferable.

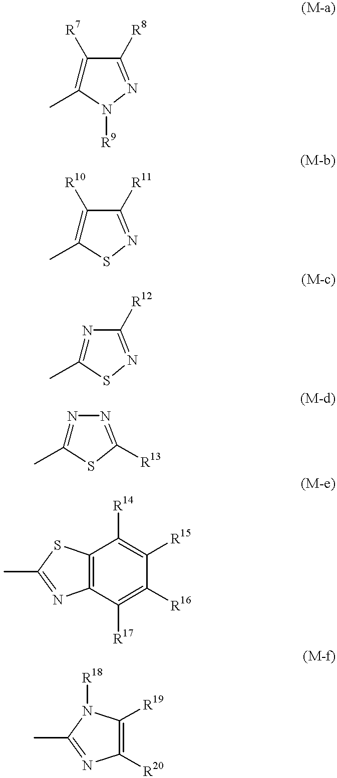

R⁷ through R²⁰ of the general formulae (M-a) through (M-f) represent the same substituents as substituents G, R¹ and R² that are described later.

Preferable among the general formulae (M-a) through (M-f) are the pyrazole groups and isothiazole groups represented by general formulae (M-a) and (M-b), with the most preferable being the pyrazole groups represented by the general formula (M-a).

As for B¹ and B², B¹ represents ═CR¹— and B² represents —CR²═, or one represents a nitrogen atom and while the other represents ═CR¹— or —CR²═. However, it is preferable that B¹ represents ═CR¹— and B² represents —CR²═.

R⁵ and R⁶ each independently represents hydrogen atoms, aliphatic groups, aromatic groups, heterocyclic groups, acyl groups, alkoxycarbonyl groups, aryloxycarbonyl groups, carbamoyl groups, alkylsulfonyl groups, arylsulfonyl groups, or sulfamoyl groups. Each of these groups may have substituents. Preferable examples of substituents represented by R⁵ and R⁶ include hydrogen atoms, aliphatic groups, aromatic groups, heterocyclic groups, acyl groups, alkylsulfonyl groups and arylsulfonyl groups. Even more preferable examples include hydrogen atoms, aromatic groups, heterocyclic groups, acyl groups, alkylsulfonyl groups or arylsulfonyl groups. Most preferably are hydrogen atoms, aryl groups, or heterocyclic groups. Each of these groups may have substituents. However, R⁵ and R⁶ are not hydrogen atoms at the same time.

G, R¹ and R² each independently represents hydrogen atoms, halogen atoms, aliphatic groups, aromatic groups, heterocyclic groups, cyano groups, carboxyl groups, carbamoyl groups, alkoxycarbonyl groups, aryloxycarbonyl groups, acyl groups, hydroxy groups, alkoxy groups, aryloxy groups, silyloxy groups, acyloxy groups, carbamoyloxy groups, heterocyclic oxy groups, alkoxycarbonyloxy groups, aryloxycarbonyloxy groups, amino groups substituted by alkyl groups or aryl groups or heterocyclic groups, acylamino groups, ureide groups, sulfamoyl amino groups, alkoxycarbonylamino groups, aryloxycarbonylamino groups, alkylsulfonylamino groups, arylsulfonylamino groups, nitro groups, alkyl and arylthio groups, heterocyclic thio groups, alkylsulfonyl groups, arylsulfonyl groups, alkylsulfinyl groups, arylsulfinyl groups, sulfamoyl groups, or sulfo groups. Each of these groups may have substituents.

Preferable substituents represented by G include hydrogen atoms, halogen atoms, aliphatic groups, aromatic groups, hydroxy groups, alkoxy groups, aryloxy groups, acyloxy groups, heterocyclic oxy groups, alkyl groups, amino groups substituted by aryl groups or heterocyclic groups, acylamino groups, ureide groups, sulfamoyl amino groups, aryloxycarbonylamino groups, alkylthio groups, arylthio groups, and heterocyclic thio groups. More preferable are hydrogen atoms, halogen atoms, alkyl groups, hydroxy groups, alkoxy groups, aryloxy groups, aryloxy groups, amino groups substituted by alkyl groups or aryl groups or heterocyclic groups, or acylamino groups. Among these, hydrogen atoms, arylamino groups and amide groups are most preferable. Each of these groups may also have substituents.

Examples of preferable substituents represented by R¹ and R² include hydrogen atoms, alkyl groups, alkoxycarbonyl groups, carboxyl groups, carbamoyl groups and cyano groups. Each of these groups may also have substituents.

R¹ and R⁵, or R⁵ and R⁶, may be bonded to form a 5-6 membered ring.

Examples of substituents when each of the substituents represented by A, R¹, R², R⁵ and R⁶ have substituents are G, R¹ and R².

Below, substituents represented by G, R¹ and R² will be described.

Examples of the halogen atoms include fluorine atoms, chlorine atoms and bromine atoms.

By aliphatic groups is meant alkyl groups, substituted alkyl groups, alkenyl groups, substituted alkenyl groups, alkinyl groups, substituted alkinyl groups, aralkyl groups and substituted aralkyl groups. The aliphatic groups may have branches or may form rings. It is preferable that the number of carbon atoms in the aliphatic group is 1-20, and more preferably 1-16. It is preferable for the aryl portions of the aralkyl groups and substituted aralkyl groups to be phenyl or naphthyl, yet phenol is particularly preferable. Examples of the aliphatic groups include methyl, ethyl, butyl, isopropyl, t-butyl, hydroxyethyl, methoxyethyl, cyanoethyl, trifluoromethyl, 3-sulfopropyl, 4-sulfobutyl, cyclohexyl, benzyl, 2-phenothyl, vinyl and allyl.

In the present specification, aromatic groups refer to aryl groups and substituted aryl groups. It is preferable for the aryl groups to be phenyl or naphthyl, with phenyl being particularly preferable. The number of carbon atoms in the aromatic group is preferable 6-20 and more preferably 1-6.

Examples of the aromatic groups include phenyl, p-tolyl, p-methoxyphenyl, o-chlorophenyl and m-(3-sulfopropylamino)phenyl.

Examples of the heterocyclic groups include heterocyclic groups having substitued and unsubstituted heterocyclic groups. Other heterocyclic rings such as aliphatic rings and aromatic rings may also be condensed on the heterocyclic ring. It is preferable that the heterocyclic group has five or six members. Examples of the substituents include aliphatic groups, halogen atoms, alkyl sulfonyl groups, arylsulfonyl groups, acyl groups, acylamino groups, sulfamoyl groups, carbamoyl groups, ionic hydrophilic groups and the like. Examples of the heterocyclic groups include 2-pyridyl groups, 2-thienyl groups, 2-thiazolyl groups, 2-benzothiazolyl groups, 2-benzooxazolyl groups, and 2-furyl groups.

Examples of the alkylsulfonyl groups and arylsulfonyl groups respectively include methansulfonyl groups and phenylsulfonyl groups.

Examples of the alkylsulfinyl groups and arylsulfinyl groups respectively include methansulfinyl groups and phenylsulfinyl groups.

Examples of the acyl groups include acyl groups having substitued and unsubstituted acyl groups. The number of carbon atoms in the acyl group is preferably 1-12. Examples of the unsubstituted acyl groups include ionic hydrophilic groups. Examples of the acyl groups include acetyl groups and benzoyl groups.

Examples of the amino groups include amino groups substituted by alkyl groups, aryl groups and heterocyclic groups. The alkyl groups, aryl groups and heterocyclic groups may also have substituents. Unsubstituted amino groups are not included. It is preferable that the alkylamino group is one having 1-6 carbon atoms. Examples of the alkylamino groups include methylamino groups and diethylamino groups.

Examples of the aryl groups include aryl groups having substituted and unsubstituted aryl groups. The number of carbon atoms in the aryl group is preferably 1-6. Examples of the substituents include ionic hydrophilic groups. Examples of the alkylamino groups include methylamino groups and diethylamino groups.

Examples of the arylamino groups include arylamino groups having substituted and unsubstituted arylamino groups. The number of carbon atoms in the arylamino group is preferably 6-12. Examples of the substituents include halogen atoms and ionic hydrophilic groups. Examples of the arylamino groups include anilino groups and 2-chloroanion groups.

Examples of the alkoxy groups include alkoxy groups having substituted and unsubstituted alkoxy groups. The number of carbon atoms in the alkoxy group is preferably 1-12. Examples of the substituents include alkoxy groups, hydroxyl groups and ionic hydrophilic groups. Examples of the alkoxy groups include methoxy groups, ethoxy groups, isopropoxy groups, methoxyethoxy groups, hydroxyethoxy groups and 3-carboxypropoxy groups.

Examples of the aryloxy groups include aryloxy groups having substituted and unsubstituted aryloxy groups. The number of carbon atoms in the aryloxy group is preferably 6-12. Examples of the substituents include alkoxy groups and ionic hydrophilic groups. Examples of the alkoxy groups include phenoxy groups, p-methoxyphenoxy groups and o-methoxyphenoxy groups.

Examples of the acylamino groups include acylamino groups having substituents. The number of carbon atoms in the acylamino group is preferably 2-12. Examples of the substituents include ionic hydrophilic groups. Examples of the acylamino groups include acetylamino groups, propionylamino groups, benzoylamino groups, N-phenylacetylamino groups, 3,5-disulfobenzoylamino groups.

Examples of the ureide groups include ureide groups having substituted and unsubstituted ureide groups. The number of carbon atoms in the ureide group is preferably 1-12. Examples of the substituents include alkyl groups and aryl groups. Examples of the ureides include 3-methylureide groups, 3,3-dimethylureide groups and 3-phenylureide groups.

Examples of the sulfamoylamino groups include sulfamoylamino groups having substituted and unsubstituted sulfamolamino groups. Examples of the substituents include alkyl groups. Examples of the sulfamoylamino groups include N,N-dipropylsulfamoylamino.

Examples of the alkoxycarbonylamino groups include those having substituents and those that do not. The number of carbon atoms in the alkoxycarbonylamino group is preferably 2-12. Examples of the substituents include ionic hydrophilic groups. Examples of the alkoxycarbonylamino groups include ethoxycarbonylamino groups.

Examples of the alkyl sulfonylamino groups and aryl sulfonylamino groups include those having substituents and those that do not. The number of carbon atoms in the alkyl and aryl sulfonylamino groups is preferably 1-12. Examples of the substituents include ionic hydrophilic groups. Examples of the alkyl and aryl sulfonylamino groups include methansulfonylamino groups, N-phenylmethansulfonylamino groups, benzensulfonylamino groups and 3-carboxybenzensulfonylamino groups.

Examples of the carbamoyl groups include those having substituents and those that do not. Examples of the substituents include alkyl groups. Examples of the carbamoyl groups include methylcarbamoyl groups and dimethylcarbamoyl groups.

Examples of the sulfamoyl groups include those having substituents and those that do not. Examples of the substituents include alkyl groups. Examples of the sulfamoyl groups include dimethylsulfamoyl groups and di-(2-hydroxyethyl)sulfamoyl groups.

Examples of the alkoxycarbonyl groups include those having substituents and those that do not. The number of carbon atoms in the alkoxycarbonyl group is preferably 2-12. Examples of the substituents include ionic hydrophilic groups. Examples of the alkoxycarbonyl groups include methoxycarbonyl groups and ethoxycarbonyl groups.

Examples of the acyloxy groups include those having substituents and those that do not. The number of carbon atoms in the acyloxy groups is preferably 1-12. Examples of the substituents include ionic hydrophilic groups. Examples of the acyloxy groups include acetoxy groups and benzoyloxy groups.

Examples of the carbamoyloxy groups include those having substituents and those that do not. Examples of the substituents include alkyl groups. Examples of the carbamoyloxy groups include N-methylcarbamoyloxy groups.

Examples of the aryloxycarbonyl groups include those having substituents and those that do not. The number of carbon atoms in the aryloxycarbonyl group is preferably 7-12. Examples of the substituents include ionic hydrophilic groups. Examples of the aryloxycarbonyl groups include phenoxycarbonyl groups.

Examples of the aryloxycarbonylamino groups include those having substituents and those that do not. The number of carbon atoms in the aryloxycarbonylamino group is preferably 7-12. Examples of the substituents include ionic hydrophilic groups. Examples of the aryloxycarbonylamino groups include phenoxycarbonylamino groups.

Examples of the alkyl, aryl and heterocyclic ring thio groups include those having substituents and those that do not. The number of carbon atoms in the alkyl, aryl and heterocyclic ring thio groups is 1-12. Examples of the substituents include ionic hydrophilic groups. Examples of the alkyl, aryl and heterocyclic ring thio groups include methyl thio groups, phenyl thio groups and 2-pyridyl thio groups.

In the present invention, the oil-soluble dye represented by general formula (M-II) below is particularly preferable.

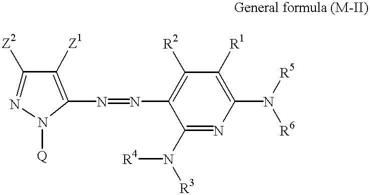

In the general formula (M-II), Z¹ represents an electron withdrawing group in which Hammett's substituent constant σₚ is no less than 0.2. It is preferable that Z¹ is an electron withdrawing group in which σₚ is 0.30 to 1.0. Examples of specifically preferable substituents include electron withdrawing substituents described later. Among these, acyl groups having 2-12 carbon atoms, alkyloxycarbonyl groups, nitro groups and cyano groups having 2-12 carbon atoms, alkylsulfonyl groups having 1-12 carbon atoms, arylsulfonyl groups having 6-18 carbon atoms, carbamoyl groups having 1-12 carbon atoms and alkyl halide groups having 1-12 carbon atoms are preferable. Particularly preferable are cyano groups, alkylsulfonyl groups having 1-12 carbon atoms and arylsulfonyl groups having 6-18 carbon atoms. Most preferable are cyano groups.

R¹, R², R⁵ and R⁶ are the same as in general formula (M-I).

R³ and R⁴ each independently represents hydrogen atoms, aliphatic groups, aromatic groups, heterocyclic groups, acyl groups, alkoxycarbonyl groups, aryloxycarbonyl groups, carbamoyl groups, alkylsulfonyl groups, arylsulfonyl groups and sulfamoyl groups. Among these, hydrogen atoms, aromatic groups, heterocyclic groups, acyl groups, alkylsulfonyl groups and arylsulfonyl groups are preferable, and hydrogen atoms, aromatic groups and heterocyclic groups are particularly preferable.

Z² represents hydrogen atoms, aliphatic groups, aromatic groups or heterocyclic groups.

Q represents hydrogen atoms, aliphatic groups, aromatic groups or heterocyclic groups. It is preferable that Q is a group comprising a non-metallic atom group necessary to form 5-8 membered rings. These 5-8 membered rings may be substituted or may also be saturated rings with unsaturated bonds. Aromatic groups and heterocyclic groups are particularly preferable. Examples of preferable non-metallic atoms include nitrogen atoms, oxygen atoms, sulfur atoms and carbon atoms. Specific examples of the 5-8 members include, for example, benzene rings, cyclopentane rings, cyclohexane rings, cycloheptane rings, cyclooctane rings, cyclohexene rings, pyridine rings, pyrimidine rings, pyrazine rings, pyridazine rings, triazine rings, imidazole rings, benzimidazole rings, oxazole rings, benzooxazole rings, thiazole rings, benzothiazole rings, oxane rings, sulforane rings and thian rings.

Each of the groups described in general formula (M-II) may have further substituents. When these groups have further substituents, examples thereof include the substituents described in general formula (M-I), the groups listed as examples in G, R¹ and R², and ionic hydrophilic groups.

Here, in relation to substituent group Z¹, description will be given of Hammett's substituent constant σₚ used in the present specification.

Hammett's rule is a rule proposed in 1935 by L. P. Hammett to quantitatively describe the influence that substituents have on equilibrium or reaction of benzene derivatives, and the rule has become widely accepted today. Among substituent constants obtained by Hammett's rule are σₚ and σₘ, which can be seen in many general textbooks such as Lange's Handbook of Chemisty 12th edition (edited by J. A. Dean, McGraw-Hill, 1979) and Kagaku no Ryôiki (Special Issue, No. 122, pp. 96-103, Nankôdô, 1979). It should be noted that, in the present invention, each of the substituents is limited by Hammett's substituent constant σₚ, but this does not mean that the substituents are limited only to substituents having known values and that can be seen in the aforementioned textbooks. Needless to say, substituents having values that are likely encompassed within the range when the value is measured on the basis of Hammett's rule, even if the values are unknown in references, are included. Further, substituents which are not benzene derivatives are also included in general formulae (M-I) and (M-II) of the present invention. σₚ is used as a measure indicating electron effects of the substituents with no relation to substitution position. σₚ is used with this kind of meaning in the present invention.

Examples of electron withdrawing groups in which Hammett's substituent constant σₚ is no less than 0.60 include cyano groups, nitro groups, alkylsulfonyl groups (e.g., methansulfonyl groups) and arylsulfonyl groups (e.g., benzenesulfonyl groups).

Examples of electron withdrawing groups in which Hammett's substituent constant σₚ is no less than 0.45 include, in addition to the preceding, acyl groups (e.g., acetyl groups), alkoxycarbonyl groups (e.g., dodecyloxycarbonyl groups), aryloxycarbonyl groups (e.g., m-chlorophenoxycarbonyl), alkylsulfinyl (e.g., n-propylsulfinyl), arylsulfinyl groups (e.g., phenylsulfinyl), sulfamoyl groups (e.g., N-ethylsulfamoyl, N,N-dimethylsulfamoyl), and alkyl halide groups (e.g., trifluoromethane).

Examples of electron withdrawing groups in which Hammett's substituent constant σₚ is no less than 0.30 include, in addition to the preceding, acyloxy groups (e.g., acetoxy), carbamoyl groups (e.g., N-ethylcarbamoyl, N,N-dibutylcarbamoyl), alkoxy halide groups (e.g., trichloromethyloxy), aryloxy halide groups (e.g., pentafluorophenyloxy), sulfonyloxy groups (e.g., methylsulfonyloxy groups), alkylthio halide groups (e.g., difluoromethylthio), aryl groups substituted by two or more electron withdrawing groups whose σₚ are 0.15 or more (e.g., 2,4-dinitrophenyl, pentachlorophenyl), and heterocyclic rings (e.g., 2-benzooxazolyl, 2-benzothiazolyl, 1-phenyl-2-benzimidazolyl).

Specific examples of electron withdrawing groups in which Hammett's substituent constant σₚ is no less than 0.20 include, in addition to the preceding, halogen atoms.

Particularly preferable combinations of substituents as the oil-soluble compound represented by general formula (M-I) are as follows.

(A) R⁵ and R⁶ are preferably hydrogen atoms, alkyl groups, aryl atoms, heterocyclic groups, sulfonyl groups or acyl groups, more preferably hydrogen atoms, aryl groups, heterocyclic groups, and most preferably hydrogen atoms, aryl groups, and heterocyclic groups. However, R⁵ and R⁶ do not simultaneously represent hydrogen atoms.

(B) G is preferably hydrogen atoms, halogen atoms, alkyl groups, hydroxyl groups, amino groups, or amide groups, more preferably hydrogen atoms, halogen atoms, amino groups, or amide groups, and most preferably hydrogen atoms, amino groups and amide groups.

(C) A is preferably pyrazole rings, imidazole rings, isothiazole rings, thiadiazole rings, benzothiazole rings, more preferably pyrazole rings and isothiazole rings, and most preferably pyrazole rings.

(D) B¹ and B² are ═CR¹— and —CR²═, respectively. R¹ and R² are each preferably hydrogen atoms, halogen atoms, cyano groups, carbamoyl group, carboxyl groups, alkyl groups, hydroxyl groups, alkoxyl groups, and more preferably hydrogen atoms, cyano groups, carbamoyl groups and alkoxy groups.

With regard to preferable combinations of substituents of compounds represented by general formula (M-I), it is preferable the compound has at least one of the various substituents described above as being a preferable group. It is more preferable that the compound has many different kinds of substituents described above as being a preferable group. It is most preferable that the compound is one in which all of the groups therein are groups listed above as being preferable.

Specific examples (a-1 to a-27, b-1 to b-6, c-1 to c-3, d-1 to d-4 and e-1 to e-4) of the oil-soluble compound represented by general formula (M-I) are indicated below, yet the oil-soluble dye used in the present invention is not limited to the same.

TABLE 1

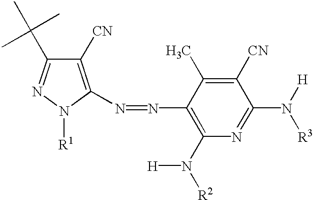

| Dye | R¹ | R² | R³ |
|---|---|---|---|
| a-1 | 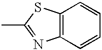 | 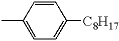 | 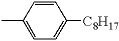 |
| a-2 | 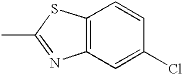 | 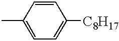 | 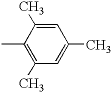 |
| a-3 | 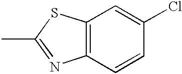 | 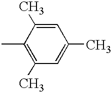 | 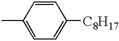 |
| a-4 | 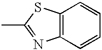 | 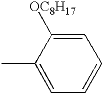 | 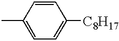 |
| a-5 | 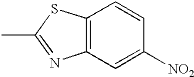 | 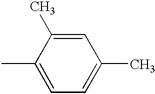 | 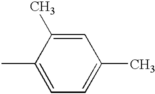 |
| a-6 | 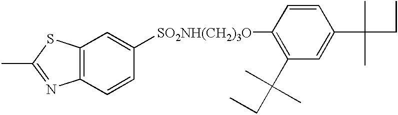 | 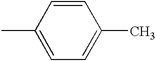 | 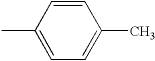 |
| a-7 | 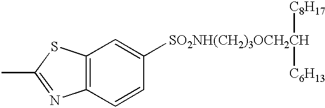 | 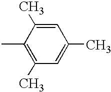 | 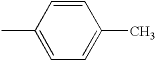 |
| a-8 | 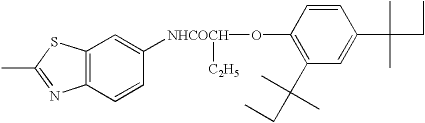 | 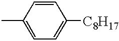 | 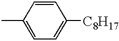 |
| a-9 | 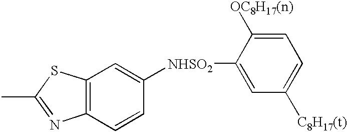 | 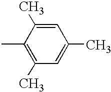 | C₈H₁₇(t) |
| a-10 | 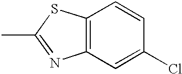 | 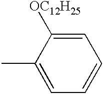 | 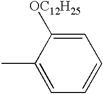 |

TABLE 2

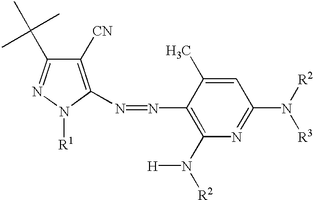

| Dye | R¹ | R² | R³ | R⁴ |
|---|---|---|---|---|
| a-11 | 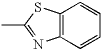 | 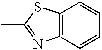 | 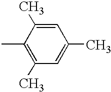 | 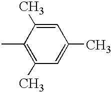 |
| a-12 | 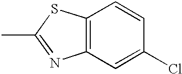 | SO₂CH₃ | 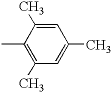 | 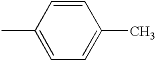 |
| a-13 | 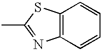 | COCH₃ | C₈H₁₇(t) | C₈H₁₇(t) |
| a-14 | 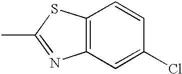 | 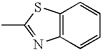 | 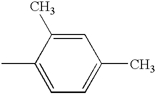 | 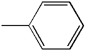 |
| a-15 | 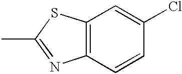 | SO₂CH₃ | 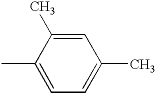 | C₈H₁₇(t) |

TABLE 3

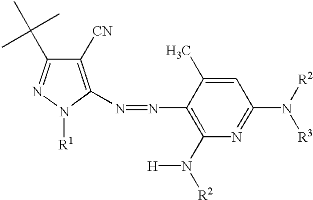

| Dye | R¹ | R² | R³ | R⁴ |
|---|---|---|---|---|
| a-16 | 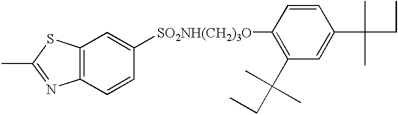 | 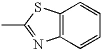 | 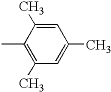 | 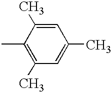 |
| a-17 | 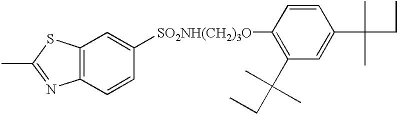 | 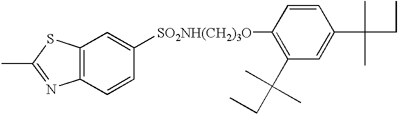 | 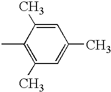 | 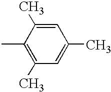 |
| a-18 | 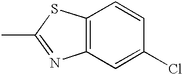 | 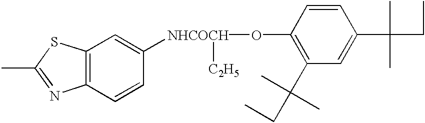 | 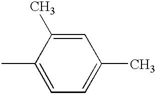 | 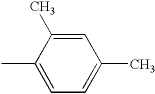 |
| a-19 | 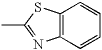 | 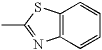 | 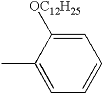 | 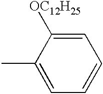 |
| a-20 | 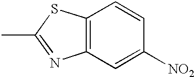 | 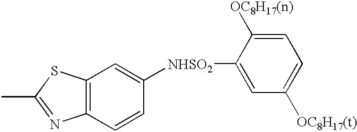 | 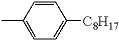 | C₈H₁₇(t) |

TABLE 4

| Dye | R¹ | R² | R³ | R⁴ | R⁵ | R⁶ | R⁷ | R⁸ |
|---|---|---|---|---|---|---|---|---|
| a-21 | 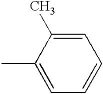 | CN | 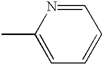 | H | CONH₂ | SO₂CH₃ | 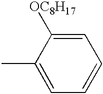 | 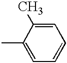 |
| a-22 | 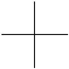 | Br | 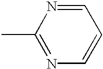 | COOC₂H₅ | H | 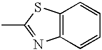 | C₈H₁₇(t) | COCH₃ |
| a-23 | 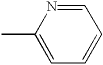 | SO₂CH₃ | 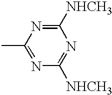 | CONH₂ | H | 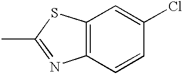 | 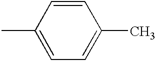 | 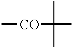 |
| a-24 | 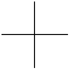 | CN | 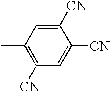 | H | H | 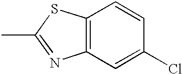 | 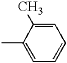 | SO₂CH₃ |

TABLE 5

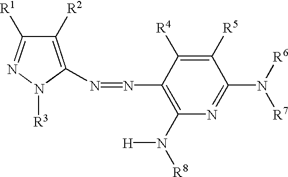

| Dye | R¹ | R² | R³ | R⁴ | R⁵ | R⁶ | R⁷ | R⁸ |
|---|---|---|---|---|---|---|---|---|
| a-25 | 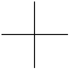 | Br | 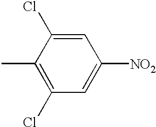 | H | CONH₂ | COCH₃ | 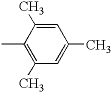 | 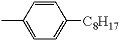 |
| a-26 | 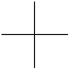 | CN | 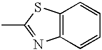 | CH₃ | H | 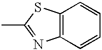 | 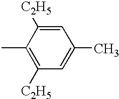 | 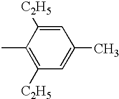 |
| a-27 | 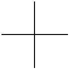 | CN | 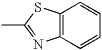 | CH₃ | CN | H | 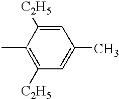 | 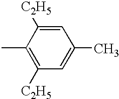 |

TABLE 6

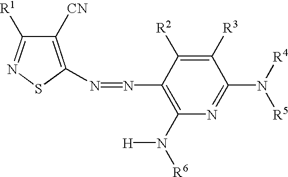

| Dye | R¹ | R² | R³ | R⁴ | R⁵ | R⁶ |
|---|---|---|---|---|---|---|
| b-1 | CH₃ | CH₃ | CN | H | 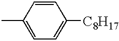 | 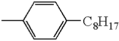 |
| b-2 | CH₃ | CH₃ | CN | H | 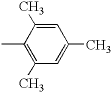 | 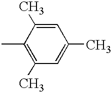 |
| b-3 | CH₃ | CH₃ | CONH₂ | H | 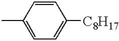 | 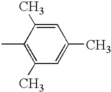 |
| b-4 | CH₃ | CH₃ | H | H | 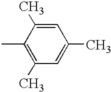 | 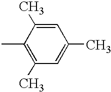 |
| b-5 | CH₃ | CH₃ | H | 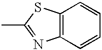 | 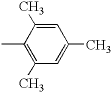 | 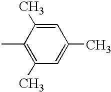 |
| b-6 | CH₃ | CH₃ | H | 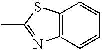 | 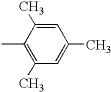 | 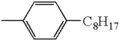 |

TABLE 7

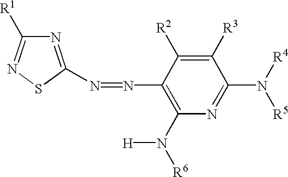

| Dye | R¹ | R² | R³ | R⁴ | R⁵ | R⁶ |
|---|---|---|---|---|---|---|
| c-1 | SCH₃ | CH₃ | CN | H | C₈H₁₇(t) | 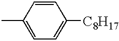 |
| c-2 | CH₃ | CH₃ | H | 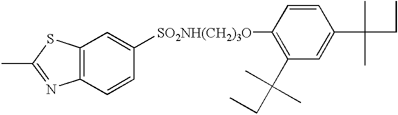 | 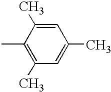 | 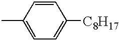 |
| c-3 | 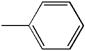 | H | H | 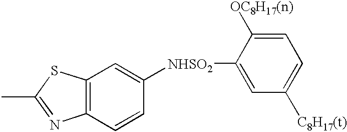 | 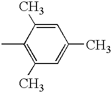 | C₈H₁₇(t) |

TABLE 8

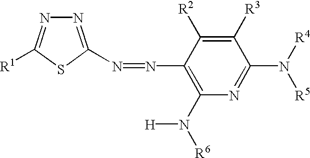

| Dye | R¹ | R² | R³ | R⁴ | R⁵ | R⁶ |
|---|---|---|---|---|---|---|
| d-1 | CH₃ | CH₃ | CN | H | 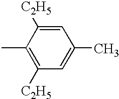 | 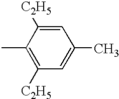 |
| d-2 | CH₃ | H | H | 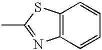 | 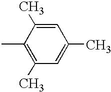 | 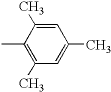 |
| d-3 | 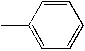 | CH₃ | CONH₂ | H | 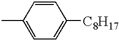 | 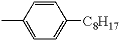 |
| d-4 | 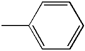 | CH₃ | H | 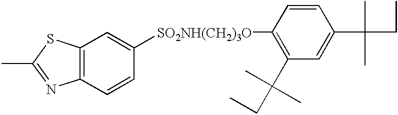 | 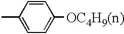 | 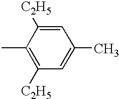 |

TABLE 9

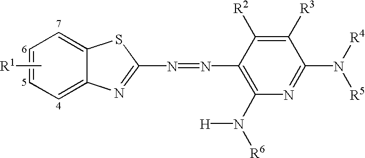

| Dye | R¹ | R² | R³ | R⁴ | R⁵ | R⁶ |
|---|---|---|---|---|---|---|
| e-1 | 5-Cl | CH₃ | CONH₂ | H | C₈H₁₇(t) | C₈H₁₇(t) |
| e-2 | 5,6-diCl | H | H | 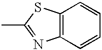 | 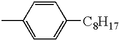 | 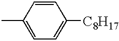 |
| e-3 | 5,6-diCl | CH₃ | H | 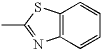 | 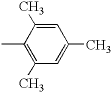 | COCH₃ |
| e-4 | 5-NO₂ | CH₃ | H | SO₂CH₃ | 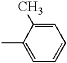 | 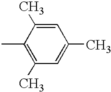 |

As the oil-soluble dye in the present invention, it particularly preferable to use a compound (hereinafter, occasionally referred to as “phthalocyanine dye”) represented by the following general formula (C-I). The compound represented by general formula (C-I) is described below.

General formula (C-I)

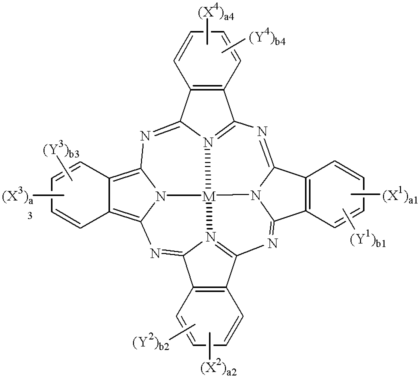

In general formula (C-I), X¹, X², X³ and X⁴ each independently represents —SO—Z¹, —SO₂—Z¹ and —SO₂NR²¹R²².

Z¹ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group. In particular, a substituted or unsubstituted alkyl group, a substituted or unsubstituted aryl group and substituted or unsubstituted heterocyclic group are preferable, with the substituted alkyl group, substituted aryl group and substituted heterocyclic group being most preferable.

R²¹ and R²² each independently represents hydrogen atoms, substituted or unsubstituted alkyl groups, substituted or unsubstituted cycloalkyl groups, substituted or unsubstituted alkenyl groups, substituted or unsubstituted aralkyl groups, substituted or unsubstituted aryl groups, or substituted or unsubstituted heterocyclic groups. In particular, hydrogen atoms, substituted or unsubstituted alkyl groups, substituted or unsubstituted aryl groups, and substituted or unsubstituted heterocyclic groups are preferable, with hydrogen atoms, substituted alkyl groups, substituted aryl groups and substituted heterocyclic groups being most preferable. However, both R²¹ and R²² are not hydrogen atoms.

It is preferable that the number of carbon atoms in the substituted or unsubstituted alkyl group represented by R²¹, R²² and Z¹ is 1-30. Examples of the substituents include the same substituents as in the case in which it is possible for Z¹, R²¹, R²², Y¹, Y², Y³ and Y⁴ to have additional substituents. In particular, hydroxyl groups, alkoxy groups, cyano groups and halogen atoms are preferable.

It is preferable that the number of carbon atoms in the substituted or unsubstituted cycloalkyl group represented by R²¹, R²² and Z¹ is 5-30. Examples of the substituents include the same substituents as in the case in which it is possible for Z¹, R²¹, R²², Y¹, Y², Y³ and Y⁴ to have additional substituents. In particular, hydroxyl groups, alkoxy groups, cyano groups and halogen atoms are preferable.

It is preferable that the number of carbon atoms in the substituted or unsubstituted alkenyl group represented by R²¹, R²² and Z¹ is 2-30. Examples of the substituents include the same substituents as in the case in which it is possible for Z¹, R²¹, R²², Y¹, Y², Y³ and Y⁴ to have additional substituents. In particular, hydroxyl groups, alkoxy groups, cyano groups and halogen atoms are preferable.

It is preferable that the number of carbon atoms in the substituted or unsubstituted aralkyl group represented by R²¹, R²² and Z¹ is 7-30. Examples of the substituents include the same substituents as in the case in which it is possible for Z¹, R²¹, R²², Y¹, Y², Y³ and Y⁴ to have additional substituents. In particular, hydroxyl groups, alkoxy groups, cyano groups and halogen atoms are preferable.

Examples of substituents of the aryl group represented by R²¹, R²² and Z¹ include the same substituents as in the case in which it is possible for Z¹, R²¹, R²², Y¹, Y², Y³ and Y⁴ to have additional substituents. Examples of preferable substituents include halogen atoms, heterocyclic groups, cyano groups, hydroxyl groups, nitro groups, carboxyl groups, acylamino groups, ureide groups, sulfamoylamino groups, arkyloxycarbonyl groups, arkyloxycarbonylamino groups, sulfonamide groups, sulfamoyl groups, carbamoyl groups, sulfonyl groups, acyloxy groups, carbamoyloxy groups, imide groups, heterocyclic ring thio groups, acyl groups, sulfo groups, 4-class ammonium groups and the like. Preferable among these are heterocyclic groups, cyano groups, carboxyl groups, acylamino groups, sulfonamide groups, sulfamoyl groups, carbamoyl groups, sulfonyl groups, imide groups, acyl groups. Particularly preferable are cyano groups, carboxyl groups, sulfamoyl groups, carbamoyl groups, sulfonyl groups, imide groups, acyl groups.

It is preferable that the heterocyclic groups represented by R²¹, R²² and Z¹ have 5 to 6 membered rings. These member rings may be condensed. Further, they may be aromatic heterocyclic rings or non-aromatic heterocyclic rings. Heterocyclic groups represented by R²¹, R²² and Z¹ are indicated below by their heterocyclic ring with substituent positions omitted. It should be noted that there are no limitations on the substituent positions. If, for example, the substituent is pyridine, substitution is possible at the second, third and fourth positions. Examples of the heterocyclic groups include pyridine, pyradine, pyrimidine, pyridazine, triazine, quinoline, isoquinoline, kinazoline, cinnoline, phthalazine, quinoxaline, pyrrole, indole, furan, benzofran, thiophene, benzothiophene, pyrazole, imidazole, benzaimidazole, triazole, oxazole, benzoxazole, thiazole, benzothiazole, isothiazole, benzoisothiazole, thiadiazole, isooxazole, benzoisooxazole, pyrrolidine, piperidine, piperadine, imidazolidine, and thiazoline. Among these, aromatic heterocyclic groups are preferable. Preferable examples thereof include, as listed above, pyridine, pyradine, pyrimidine, pyridazine, triazine, pyrazole, imidazole, benzaimidazole, triazole, thiazole, benzothiazole, isothiazole, benzoisothiazole, and thiadiazole. These may also have substituents.

Y¹, Y², Y³ and Y⁴ each independently represents hydrogen atoms, halogen atoms, alkyl groups, cycloalkyl groups, alkenyl groups, aralkyl groups, aryl groups, heterocyclic groups, cyano groups, hydroxyl groups, nitro groups, amino groups, alkylamino groups, alkoxy groups, aryloxy groups, amide groups, arylamino groups, ureide groups, sulfamoylamino groups, alkylthio groups, arylthio groups, alkoxycarbonylamino groups, sulfonamide groups, carbamoyl groups, sulfamoyl groups, sulfonyl groups, alkoxycarbonyl groups, heterocyclic oxy groups, azo groups, acyloxy groups, carbamoyloxy groups, silyloxy groups, aryloxycarbonyl groups, aryloxycarbonylamino groups, imide groups, heterocyclic thio groups, phosphoryl groups, acyl groups, carboxyl groups or sulfo groups. Each of these may have additional substituents.

Preferable among these are hydrogen atoms, halogen atoms, alkyl groups, aryl groups, cyano groups, alkoxy groups, amide groups, ureide groups, sulfonamide groups, carbamoyl groups, sulfamoyl groups and alkoxycarbonyl groups. Particularly preferable are hydrogen atoms, halogen atoms and cyano atoms, with hydrogen atoms being most preferable.

When the group is one in which it is possible for Z¹, R²¹, R²², Y¹, Y², Y³ and Y⁴ to have additional substituents, Z¹, R²¹, R²², Y¹, Y², Y³ and Y⁴ may have the following substituents.

Halogen atoms (e.g., chlorine, bromine), alkyl groups with straight or branching chains and 1-30 carbons, aralkyl groups with 7-30 carbons, alkenyl groups with 2-30 carbons, alkinyl groups with straight or branching chains and 2-30 carbons, cycloalkyl groups with straight or branching chains and 3-30 carbons, cycloalkenyl groups with straight or branching chains and 3-30 carbons, (specifically, methyl, ethyl, propyl, isopropyl, t-butyl, 2-methanesulfonylethyl, 3-phenoxypropyl, trifluoromethyl, cyclopentyl), aryl groups (e.g., phenol, 4-t-butylphenol, 2,4-di-t-amyl phenol), heterocyclic groups (e.g., imidazolyl, pyrazolyl, triazolyl, 2-furil, 2-thienyl, 2- pyrimidinyl, 2-benzothiazolyl), cyano groups, hydroxyl groups, nitro groups, carboxyl groups, amino groups, alkyloxy groups (e.g., methoxy, ethoxy, 2-methoxyethoxy, 2-methanesulfonylethoxy), aryloxy groups (e.g., phenoxy, 2-methylphenoxy, 4-t-butylphenoxy, 3-nitrophenoxy, 3-t-butyloxycarbamoylphenoxy, 3-methoxycarbamoyl), acylamino groups (e.g., acetamide, benzamide, 4-(3-t-butyl-4-hydroxyphenoxy)butanamide), alkylamino groups (e.g., methylamino, butylamino, diethylamino, methylbutylamino), anilino groups (e.g., phenolamino, 2-chloroanilino), ureide groups (e.g., phenolureide, methylureide, N,N-dibutylureide), sulfamoylamino groups (e.g., N,N-dipropylsulfamoylamino), alkylthio groups (e.g., methylthio, octylthio, 2-phenoxywethylthio), arylthio groups (e.g., phenolthio, 2-butoxy-5-t-octylphenylthio, 2-carboxyphenylthio), alkyloxycarbonylamino groups (e.g., methoxycarbonylamino), sulfonamide groups (e.g., methansulfoamide, benzenesulfonamide, p-toluenesulfonamide), carbamoyl groups (e.g., N-ethylcarboyl, N,N-dibutylcarbamoyl), sulfamoyl groups (e.g., N-ethylsulfamoyl, N,N-dipropylsulfamoyl, N-phenylsulfamoyl), sulfanyl groups (e.g., methansulfanyl, octanesulfanyl, benzenesulfanyl, toulenesulfanyl), alkyloxycarbonyl groups (e.g., methoxycarbonyl, butyloxycarbonyl), heterocyclic groups (e.g., 1-phenyltetrazole-5-oxy, 2-tetrahydropyranyloxy), azo groups (e.g., phenolazo, 4-methoxyphenylazo, 4-pivaloylaminophenolazo, 2-hydroxy-4-propanoylphenolazo), acyloxy groups (e.g., acetoxy), carbamoyloxy groups (e.g., N-methylcarbamoyloxy, N-phenylcarbamoyloxy), silyloxy (e.g., trimethylsilyloxy, dibutylmethylsilyloxy), aryloxycarbonylamino groups (e.g., phenoxycarbonylamino), imide groups (e.g., N-succinimide, N-phthalimide), heterocyclic ring thio groups (e.g., 2-benzothialylthio, 2,4-di-phenoxy-1,3,5-triazole-6-thio, 2-pyridylthio), sulfinyl groups (e.g., 3-phenoxypropylsulfinyl), phosphonyl groups (e.g., phenoxyphosphonyl, octyloxyphosphonyl, phenylphosphonyl), aryloxycarbonyl groups (e.g., phenoxycarbonyl), acyl groups (e.g., acetyl, 3-phenylpropanoyl, benzoyl), ionic hydrophilic groups (e.g., carboxyl groups, sulfo groups, and 4-class ammonium groups) and the like.

a¹-a⁴ and b¹-b⁴ each represents substituent numbers for X¹-X⁴ and Y¹-Y⁴. a¹-a⁴ each independently represents an integer of 0-4, and b¹-b⁴ each independently represents an integer of 0-4, wherein the summation of a¹-a⁴ is no less than 2. Here, when a¹-a⁴ and b¹-b⁴ represent integers of 2 or greater, plural X¹-X⁴ and Y¹-Y⁴ may be the same or different.

a¹ and b¹ each independently represents an integer of 0-4 that fulfills the relationship a¹+b¹=4. Particularly preferable is a combination in which a¹ represents 1 or 2 and b¹ represents 3 or 2. The most preferable combination is one in which a¹ represents 1 and b¹ represents 3.

a² and b² each independently represents an integer of 0-4 that fulfills the relationship a²+b²=4. Particularly preferable is a combination in which a² represents 1 or 2 and b² represents 3 or 2. The most preferable combination is one in which a² represents 1 and b² represents 3.

a³ and b³ each independently represents an integer of 0-4 that fulfills the relationship a³+b³=4. Particularly preferable is a combination in which a³ represents 1 or 2 and b³ represents 3 or 2. The most preferable combination is one in which a³ represents 1 and b³ represents 3.

a⁴ and b⁴ each independently represents an integer of 0-4 that fulfills the relationship a⁴+b⁴=4. Particularly preferable is a combination in which a⁴ represents 1 or 2 and b⁴ represents 3 or 2. The most preferable combination is one in which a⁴ represents 1 and b⁴ represents 3.

M represents a hydrogen atom, a metal element or oxide thereof, hydride or halide.

Preferable examples of M include hydrogen atoms and metal atoms such as Li, Na, K, Mg, Ti, Zr, V, Nb, Ta, Cr, Mo, W, Mn, Fe, Co, Ni, Ru, Pd, Os, Ir, Pt, Cu, Ag, Au, Zn, Cd, Hg, Al, Ga, In, Si, Ge, Sn, Pb, Sb and Bi. Examples of oxides include VO and GeO. Examples of hydrides include Si(OH)₂, Cr(OH)₂ and Sn(OH)₂. Further, examples of halides include AlCl, SiCl₂, VCl, VCl₂, VOCl, FeCl, GaCl and ZrCl. Cu, Ni, Zn and Al are particularly preferable, with Cu being the most preferable.

Further, Pc (phthalocyanine ring) may be formed as a dimer (e.g., Pc-M-L-M-Pc) or trimer via L (divalent continuous group). In this case, M may be the same or different.

The divalent continuous group represented by L is preferably an oxy group —O—, thio group —S—, carbonyl group —CO—, sulfonyl group —SO₂—, imino group —NH—, or methyl group —CH₂.

Particularly preferable combinations for the compound represented by general formula (C-I) are as follows.

It is particularly preferable for X¹-X⁴ to each independently represents —SO₂—Z¹ or SO₂NR²¹R²².

It is preferable for Z¹ to respectively independently be a substituted or unsubstituted alkyl group, a substituted or unsubstituted aryl group, or a substituted or unsubstituted heterocyclic group, with a substituted alkyl group, a substituted aryl group and a substituted heterocyclic group being the most preferable.

It is preferable for R²¹ and R²² to respectively independently be a halogen atom, a substituted or unsubstituted alkyl group, a substituted or unsubstituted aryl group, or a substituted or unsubstituted heterocyclic group, with a halogen atom, a substituted alkyl group, a substituted aryl group and a substituted heterocyclic group being the most preferable.

It is preferable for Y¹-Y⁴ to be hydrogen atoms, halogen atoms, alkyl groups, aryl groups, cyano groups, alkoxy groups, amide groups, ureide groups, sulfonamide groups, carbamoyl groups, sulfamoyl groups, alkoxycarbonyl groups, carboxyl groups and sulfo groups, with hydrogen atoms, halogen atoms, cyano groups, carboxyl groups and sulfo groups being particularly preferable and hydrogen atoms being most preferable.

It is preferable for a¹-a⁴ to each independently be 1 or 2, with 1 being particularly preferable. It is preferable for b¹-b⁴ to each independently be 3 or 2, with 3 being particularly preferable.

M represents a hydrogen atom, a metal element or its oxide, a hydride or halide. In particular, Cu, Ni and Al are preferable, with Cu being most preferable.

With respect to combinations of preferable substituents of the compound represented by general formula (C-I), it is preferable for at least one of the various substituents to comprise a group listed as being preferable above. It is more preferable for many of the substituents to comprise groups listed as being preferable above, and most preferable for all of the substituents to comprise groups listed as being preferable above.

Among the compounds represented by general formula (C-I), the compound having a structure represented by the following general formula (C-II) is more preferable.

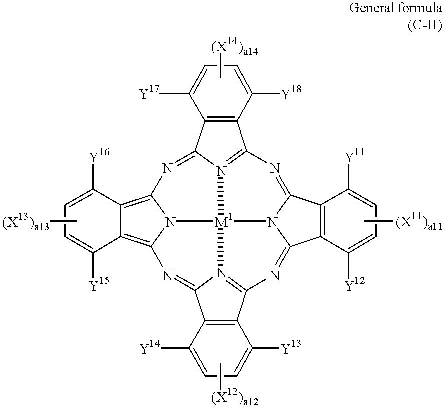

In general formula (C-II), X¹¹-X¹⁴ are the same as X¹-X⁴ in general formula (C-I), and Y¹¹-Y⁴ are the same as Y¹-Y⁴ in general formula (C-I). Preferable examples of X¹¹-X¹⁴ and Y¹¹-Y¹⁴ are the same as those respectively given for X¹-X⁴ and Y¹-Y⁴. Further, M¹ is the same as M in general formula (C-I), and preferable examples thereof are also the same as those given for M.

Specifically, in general formula (C-II), X¹¹, X¹², X¹³ and X¹⁴ each independently represents —SO—Z¹¹, —SO₂—Z¹¹ and SO₂NR²³R²⁴.

Z¹¹ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group.

R²³ represents a hydrogen atom, substituted or unsubstituted alkyl group, substituted or unsubstituted cycloalkyl group, substituted or unsubstituted alkenyl group, substituted or unsubstituted aralkyl group, substituted or unsubstituted aryl group, or substituted or unsubstituted heterocyclic group.

R²⁴ represents a substituted or unsubstituted alkyl group, substituted or unsubstituted cycloalkyl group, substituted or unsubstituted alkenyl group, substituted or unsubstituted aralkyl group, substituted or unsubstituted aryl group, or substituted or unsubstituted heterocyclic group.

Y¹¹, Y¹² Y¹³, Y¹⁴, Y¹⁵, Y¹⁶, Y¹⁷, Y¹⁸ and Y¹⁹ each independently represents hydrogen atoms, halogen atoms, alkyl groups, cycloalkyl groups, alkenyl groups, aralkyl groups, aryl groups, heterocyclic groups, cyano groups, hydroxyl groups, nitro groups, amino groups, alkylamino groups, alkoxy groups, aryloxy groups, amide groups, arylamino groups, ureide groups, sulfamoylamino groups, alkylthio groups, arylthio groups, alkoxycarbonylamino groups, sulfonamide groups, carbamoyl groups, sulfamoyl groups, sulfonyl groups, alkoxycarbonyl groups, heterocyclic oxy groups, azo groups, acyloxy groups, carbamoyloxy groups, silyloxy groups, aryloxycarbonyl groups, aryloxycarbonylamino groups, imide groups, heterocyclic thio groups, phosphoryl groups, acyl groups, carboxyl groups or sulfo groups. Each of these may have additional substituents.

a¹¹a¹⁴ each represents substituent numbers of X¹¹-X¹⁴, but all never become 0 at the same time. It should be noted that when a¹¹-a¹⁴ represent 2, two of X¹¹-X¹⁴ may respectively be the same or different. M¹ is a hydrogen atom, metal element or its oxide, hydride or halide.

In general formula (C-II), It is preferable that a¹¹-a¹⁴ represent respectively independent integers of 1 or 2, within a range of 4≦a¹¹+a¹²+a¹³+a¹⁴≦8. Particularly preferable is a range of 4≦a¹¹+a¹²+a¹³+a¹⁴≦6, with a¹¹=a¹²=a¹³=a¹⁴=1 being most preferable.

Among the compounds represented by general formula (C-II), examples of particularly preferable combinations of substituents are as follows.

It is preferable that X¹¹-X¹⁴ are respectively independently —SO₂—Z¹¹ or —SO₂NR²³R²⁴.

It is preferable that Z¹¹ is respectively independently a substituted or unsubstituted alkyl group, a substituted or unsubstituted aryl group, or a substituted or unsubstituted heterocyclic group, with a substituted alkyl group, a substituted aryl group and a substituted heterocyclic group being most preferable.

It is preferable that R²³ is respectively independently a hydrogen atom, a substituted or unsubstituted alkyl group, a substituted or unsubstituted aryl group, or a substituted or unsubstituted heterocyclic group, with a hydrogen atom, a substituted alkyl group, a substituted aryl group and a substituted heterocyclic group being most preferable.

It is preferable that R²⁴ is respectively independently a substituted or unsubstituted alkyl group, a substituted or unsubstituted aryl group, or a substituted or unsubstituted heterocyclic group, with a substituted alkyl group, a substituted aryl group and a substituted heterocyclic group being most preferable.

It is preferable for Y¹¹-Y¹⁸ to respectively independently be hydrogen atoms, halogen atoms, alkyl groups, aryl groups, cyano groups, alkoxy groups, amide groups, ureide groups, sulfonamide groups, carbamoyl groups, sulfamoyl groups and alkoxycarbonyl groups, with hydrogen atoms, halogen atoms and cyano groups being particularly preferable and hydrogen atoms being most preferable.

It is preferable for a¹¹-a¹⁴ to each independently be 1 or 2, with 1 being particularly preferable.

M¹ represents a hydrogen atom, a metal element or its oxide, a hydride or halide. In particular, Cu, Ni and Al are preferable, with Cu being most preferable.

With respect to combinations of preferable substituents of the compound represented by general formula (C-II), it is preferable for at least one of the various substituents to comprise a group listed as being preferable above. It is more preferable for many of the substituents to comprise groups listed as being preferable above, and most preferable for all of the substituents to comprise groups listed as being preferable above.

The compound represented by general formula (C-I) is generally an analogous mixture in which the position and number at which substituent Rn (n=1-4) and Yq (q=1-4) are introduced are unavoidably different depending upon the method of synthesis. There are many cases in which these analogous mixtures are expressed as statistical averages. When these analogous mixtures are classified into three classes as indicated below, specific mixtures are particularly preferable. This fact was discovered with the present invention.

In the present invention, the phthalocyanine dye analogous mixtures that are compounds represented by the general formulae (C-I) and (C-II) are defined by classifying the mixtures into the following three classes on the basis of substitution position.

(1) β-position substitution type: (phthalocyanine dye having a specific substituent at: 2- and/or 3-position; 6- and/or 7-position; 10- and/or 11-position; 14- and/or 15-position)

(2) α-position substitution type: (phthalocyanine dye having a specific substituent at: 1- and/or 4-position; 5- and/or 8-position; 9- and/or 12-position; 13- and/or 16-position)

(3) α, β-position mixed substitution type: (phthalocyanine dye having specific substituents without regularity at the 1-16 positions)

In the present specification, when describing derivatives of phthalocyanine dyes whose structures are different (particularly, substitution positions), the β-position substitution type, α-position substitution type and α, β-position mixed substitution type designations will be used.

The phthalocyanine derivatives used in the present invention can be synthesized by combining methods disclosed in, for example, Futaroshianin: Kagaku to Kinô (“Phthalocyanines: Chemistry and Functions”, by Shirai and Kobayashi, published by APC Co., pp. 1-62) and Phthalocyanines: Properties and Applications (by C. C. Leznoff and A. B. P. Lever, published by VCH, pp. 1-54), and also by similar methods.

The compound represented by general formula (C-I) of the present invention can be synthesized through, for example, a sulfonation reaction, a sulfonyl chloridation reaction or an amidation reaction of an unsubstituted phthalocyanine compound, as disclosed in WO 00/17275, WO 00/08103, WO 00/08101, WO98/41853, JP-A No. 10-36471 and the like. In this case, since sulfonation occurs easily at any position of the phthalocyanine nucleus, it is difficult to control the number of substituents that is sulfonated. Consequently, when a sulfo group is introduced under such reaction conditions, the number and position of the sulfo group introduced to the product cannot be specified, and a mixture is invariably obtained in which the number and substitution position of the substituents are different. Thus, when using as raw material the mixture in which the number and substitution positions of the subsituents are different to synthesize the compound of the present invention, because the number and substitution position of the heterocyclic substituent sulfamoyl group cannot be specified, an α, β-position mixed-substitution type mixture that includes several types of compounds in which the number and substitution position of the substituents are different is obtained as the compound of the present invention.

As described above, when many electron withdrawing groups such as, for example, a sulfamoyl group are introduced to the phthalocyanine nucleus, oxidation potential becomes nobler and ozone resistance rises. When the above method of synthesis is followed, the number of electron withdrawing groups being introduced is few, i.e., it is unavoidable for the phthalocyanine dye, which has a baser oxidation potential, to be mixed. Therefore, in order to improve ozone resistance, it is preferable to use a synthesis method that suppresses formation of compound whose oxidation potential is baser.

In contrast, the represented by general formula (C-II) of the present invention can be derived from a compound obtained by reacting the metal derivative represented by general formula (C-III) with the phthalnitrile derivative (compound P) represented by the following formula and/or the diiminoisoindoline derivative (compound Q).

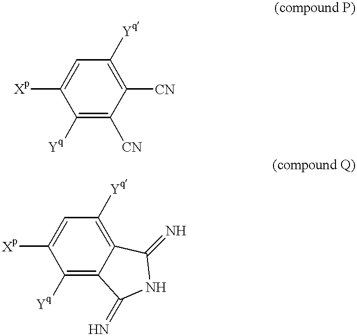

In compounds P and Q, p represents 11-14 and q and q′ each independently represents 11-18.

General formula (C-III):

M-(Y)_{d}

(In general formula (C-III), M is the same as M in the compounds represented by the general formulae (C-I) and (C-II), Y represents a monovalent or divalent ligand such as a halogen atom, negative ion acetate, acetylacetonate and oxygen, and d represents an integer from 1-4.)

That is, if the above synthesis method is followed, it is possible to introduce only a specific number of desired substituents. Particularly when, as in the present invention, many electron withdrawing groups are to be introduced in order to raise oxidation potential, the above synthesis method is superior to the method of synthesizing the compound represented by general formula (C-I).

The compound that is represented by general formula (C-II) and obtained in this manner ordinarily is a mixture of compounds, which are isomers in respective substitution positions of X^{p}, represented by general formulae (C-II-1) to (C-II-4). They are β-position substitution types (phthalocyanine dyes having specific substituents at the 2- and/or 3-position, 6- and/or 7-position, 10- and/or 11-position, 14- and/or 15-position).

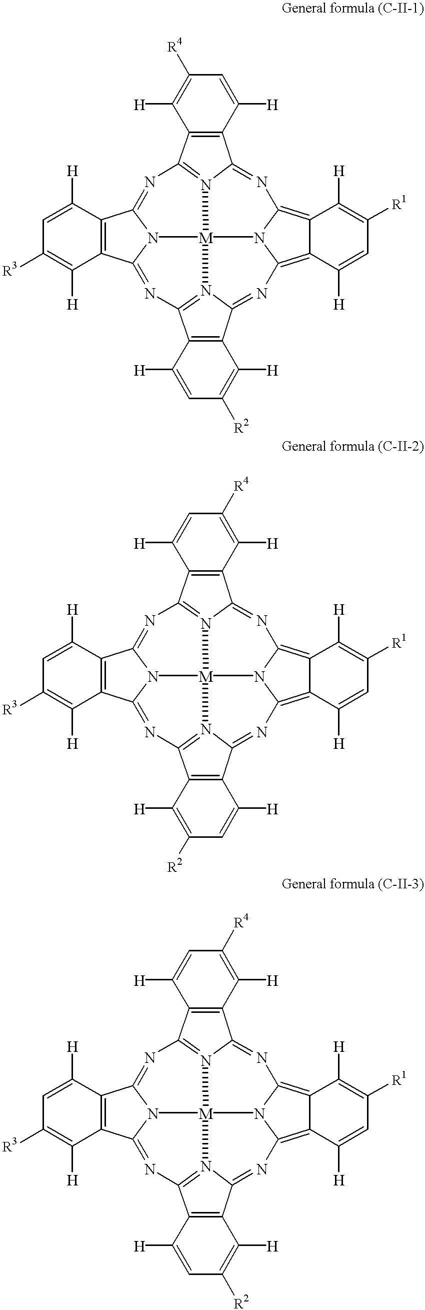

In the preceding general formulae (C-II-1) to (C-II-4), R¹ to R⁴ are the same as (X¹¹)a¹¹ to (X¹⁴)a¹⁴ in the general formula (C-II).

In the present invention, it was discovered that it is extremely important for the oxidation potential to be nobler than 1.0V (vs SCE) in each of the substitution types to improve fastness. In particular, there was a tendency for the β-position substitution type to be superior to the β-position mixed substitution type in terms of coloring, light fastness and resistance to ozone gas.

Specific examples (C-101 to C-120) of compounds represented by the general formulae (C-I) and (C-II) are given below, but the present invention is not limited to the same.

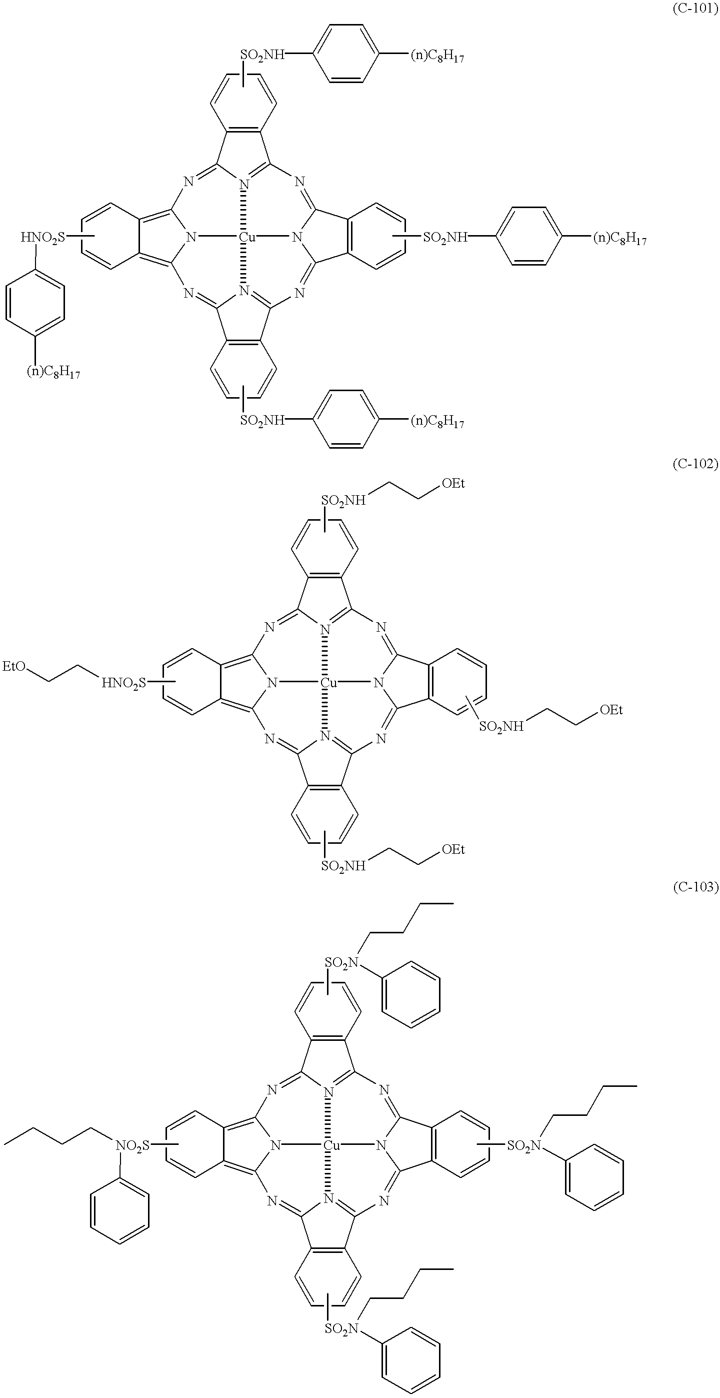

TABLE 10

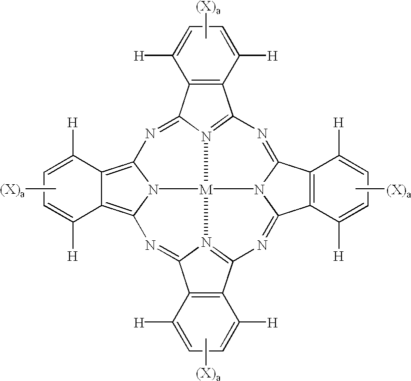

| compound No. | M | X | a |
|---|---|---|---|
| C-105 | Cu | —SO₂NHC₈H₁₇(t) | 1 |
| C-106 | Cu | 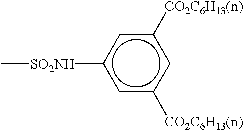 | 1 |
| C-107 | Cu | 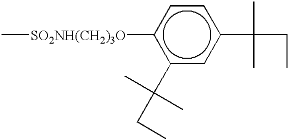 | 1 |
| C-108 | Cu | 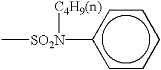 | 1 |
| C-109 | Cu | 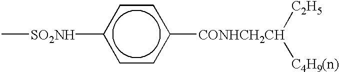 | 1 |
| C-110 | Cu | 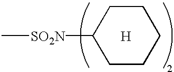 | 1 |
| C-111 | Cu | 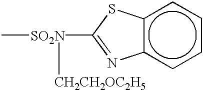 | 1 |
| C-112 | Cu | —SO₂N(CH₂CH₂OC₂H₅)₂ | 1 |

TABLE 11

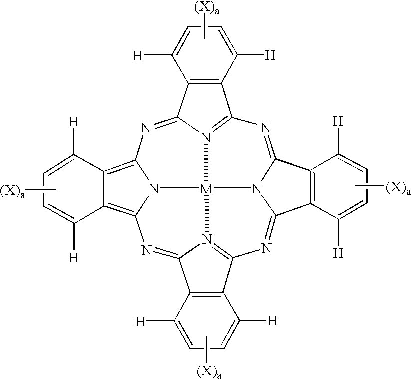

| compound No. | M | X | a |
|---|---|---|---|
| C-113 | Cu | 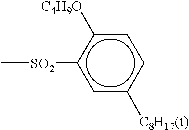 | 1 |
| C-114 | Cu | —SO₂(CH₂)₂SO₂NH(CH₂)₃OC₃H₇(i) | 1 |
| C-115 | Cu | —SO₂CH₂CO₂C₂H₅ | 1 |
| C-116 | Cu | 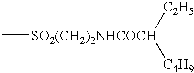 | 1 |
| C-117 | Cu | —SO₂(CH₂)₂CO₂C₆H₁₃(n) | 1 |
| C-118 | Cu | —SO₂C₄H₉(n) | 2 |
| C-119 | Cu | 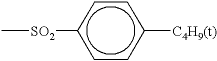 | 1 |
| C-120 | Cu | 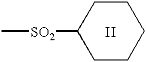 | 1 |

It is possible to synthesize the compound represented by general formula (C-I) according to the aforementioned patent. Further, the compound represented by general formula (C-II) can be synthesized by methods disclosed in JP-A No. 2000-24352, JP-A No. 2000-47013, JP-A No. 2000-57063 and JP-A No. 2000-96610. Further, the materials, coloring intermediate bodies and synthesis route are not limited to the same.

Coloring particulate dispersion

The coloring particulate dispersion included in the coloring composition of the present invention is obtained by dispersing in a water-based medium at least one respective type of oil-soluble dye and hydrophobic organic solvent having a boiling point of no less than 150° C. That is, the coloring particulate dispersion exist in a state in which the oil-soluble dyes and hydrophobic high-boiling point organic solvent as coloring particulate dispersion having a particulate configuration in a water-based medium to be emulsified and dispersed.

Hydrophobic high-boiling point organic solvent

Description will now be given of the hydrophobic high-boiling point organic solvent.

The hydrophobic high-boiling point organic solvent is hydrophobic and has a boiling point of 150° C. or more. Here, the term “hydrophobic” means that solubility in distilled water at 25° C. is 3% or less. It is preferable that the boiling point of the hydrophobic high-boiling point organic solvent is 170° C. or more. The dielectric constant of the hydrophobic high-boiling point organic solvent is preferably from 3 to 12, and more preferably from 4 to 10. The “dielectric constant” herein referred to indicates relative dielectric constant relative to a vacuum at 25° C.

There are no particular limitations on the hydrophobic high-boiling point organic solvent to be used, and the hydrophobic high-boiling point organic solvent may be appropriately selected depending on purpose. Examples thereof include compounds described in U.S. Pat. No. 2,322,027 can be used, and preferable examples thereof include, but are not limited to, hydrophobic high-boiling point organic solvents derived from phosphates, fatty esters, phthalates, benzoates, phenols and amides.

As the hydrophobic high-boiling point organic solvents, compounds represented by the following formulae [S-1]-[S-9] are particularly preferable.

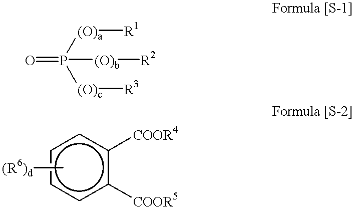

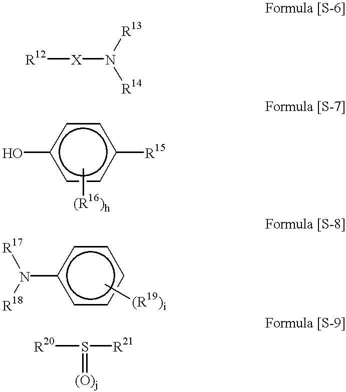

In the formula [S-1], R¹, R² and R³ each independently represents an aliphatic group or an aryl group. Symbols a, b, and c each independently represents 0 or 1.

In the formula [S-2], R⁴ and R⁵ each independently represents an aliphatic group or an aryl group.

R⁶ is a halogen atom (the halogen atom is F, Cl, Br or I, which is the same as in the following), an alkyl group, an alkoxy group, an aryloxy group, an alkoxycarbonyl group, or an aryloxycarbonyl group.

Symbol d is an integer of 0 to 3, and when d is 2 or more, R⁶ may be the same or different.

In the formula [S-3], Ar represents an aryl group, and symbol e is an integer of 1 to 6. R⁷ represents a hydrocarbon group or a hydrocarbon group having an ether bond therein, which is having e valences.

In the formula [S-4], R⁸ represents an aliphatic group, and symbol f is an integer of 1 to 6. R⁹ represents a hydrocarbon group or a hydrocarbon group having an ether bond therein, which is having f valences.

In the formula [S-5], symbol g is an integer of 2 to 6. R¹⁰ represents a hydrocarbon group (except any aryl group)having g valences. R¹¹ represents an aliphatic group or an aryl group.

In the formula [S-6], R¹², R¹³ and R¹⁴ each independently represents a hydrogen atom, an aliphatic group or an aryl group. X represents —CO— or SO₂—. R¹² and R¹³, or R¹³ and R¹⁴ may be bonded to each other to form a ring.

In the formula [S-7], R¹⁵ represents an aliphatic group, alkoxycarbonyl group, an aryloxycarbonyl group, an alkylsulfonyl group, an arylsulfonyl group, an aryl group or a cyano group.

R¹⁶ represents a halogen atom, an aliphatic group, an aryl group, an alkoxy group or an aryloxy group.

Symbol h is an integer of 0 to 3. In the case that h is 2 or more, R¹⁶ s may be the same or different.

In the formula [S-8], R¹⁷ and R¹⁸ each independently represents an aliphatic group or an aryl group. R¹⁹ is a halogen atom, an aliphatic group, an aryl group, an alkoxy group or an aryloxy group. Symbol i is an integer of 0 to 4. In the case that i is 2 or more, R¹⁹ s may be the same or different.

In the formula [S-9], R²⁰ and R²¹ each independently represents an aliphatic group or an aryl group. Symbol j is 1 or 2.

When R¹ to R⁶, R⁸, R¹¹ to R²¹ are aliphatic groups or groups containing an aliphatic group in the formulae [S-1] to [S-9], the aliphatic groups may be any one of straight chain, branched chain and cyclic forms, may contain an unsaturated bond, and may have a substituent. Examples of the substituent include a halogen atom, an aryl group, an alkoxy group, an aryloxy group, an alkoxycarbonyl group, a hydroxyl group, an acyloxy group and an epoxy group.

When R¹ to R⁶, R⁸, R¹¹ to R²¹ are cyclic aliphatic groups, i.e., cycloalkyl groups, or groups containing a cycloalkyl group in the formulae [S-1] to [S-9], the cycloalkyl group may contain an unsaturated bond in its 3 to 8-membered ring or may have a substituent or a crosslinking group. Examples of the substituent include a halogen atom, an aliphatic group, a hydroxyl group, an acyl group, an aryl group, an alkoxy group, an epoxy group, and an alkyl group. Examples of the crosslinking group include a methylene group, an ethylene group, and an isopropylidene group.

When R¹ to R⁶, R⁸, R¹¹ to R²¹ are aryl groups or groups containing an aryl group in the formulae [S-1] to [S-9], the aryl group may be substituted with a halogen atom, an aliphatic group, an aryl group, an alkoxy group, an aryloxy group, an alkoxycarbonyl group or the like.

When R⁷, R⁹ or R¹⁰ is a hydrocarbon group in the formulae [S-3], [S-4] and [S-5], the hydrocarbon group may contain a cyclic structure (for example, a benzene ring, a cyclopentane ring or a cyclohexane ring), an unsaturated bond or a substituent. Examples of the substituent include a halogen atom, a hydroxyl group, an acyloxy group, an aryl group, an alkoxy group, an aryloxy group, and an epoxy group.

Description will now be given of particularly preferable hydrophobic high-boiling point organic solvents in the present invention.

In the formula [S-1], R¹, R² and R³ each independently represents an aliphatic group having 1-24 (preferably 4-18) carbon atoms (for example, n-butyl, 2-ethylhexyl, 3,3,5-trimethylhexyl, n-dodecyl, n-octadecyl, benzyl, oleyl, 2-chloroethyl, 2,3-dichloropropyl, 2-butoxyethyl, 2-phenoxyethyl, cyclopentyl, cyclohexyl, 4-t-butylcyclohexyl, 4-methylcyclohexyl, or an aryl group having 6-24 (preferably 6-18) carbon atoms (for example, phenyl, cresyl, p-nonylphenyl, xylyl, cumenyl, p-methoxyphenyl and p-methoxycarbonylphenyl).

Symbols a, b and c each independently represents 0 or 1, and preferably a, b and c each represents 1.

In the formula [S-2], R⁴ and R⁵ each represents an aliphatic group having 1-24 (preferably 4-18) carbon atoms (for example, the same alkyl groups as described as R¹, ethoxycarbonylmethyl, 1,1-diethylpropyl, 2-ethyl-1-methylhexyl, cyclohexylmethyl, 1-ethyl-1,5-dimethylhexyl, 3,5,5-trimethylcyclohexyl, and 1-methylcyclohexyl), or an aryl group having 6-24 (preferably 6-18) carbon atoms (for example, the same aryl groups as described as R¹, 4-t-butylphenyl, 4-t-octylphenyl, 1,3,5-trimethylphenyl, 2,4-di-t-butylphenyl, and 2,4-di-t-pentylphenyl).

R⁶ represents a halogen atom (preferably Cl), an alkyl group having 1-18 carbon atoms (for example, methyl, isopropyl, t-butyl, and n-dodecyl), an alkoxy group having 1-18 carbon atoms (for example, methoxy, n-butoxy, n-octyloxy, methoxyethoxy, and benzyloxy), an aryloxy group having 6-18 carbon atoms (for example, phenoxy, p-tolyloxy, 4-methoxyphenoxy, 4-t-butylphenoxy), an alkoxycarbonyl group having 2-19 carbon atoms (for example, methoxycarbonyl, n-butoxycarbonyl and 2-ethylhexyloxycarbonyl), or an aryloxycarbonyl group having 6-25 carbon atoms.

Symbol d represents 0 or 1.

In the formula [S-3], Ar represents an aryl group having 6-24 (preferably 6-18) carbon atoms (for example, phenyl, 4-chlorophenyl, 4-methoxyphenyl, 1-naphthyl, 4-n-butoxyphenyl, and 1,3,5- trimethylphenyl), and e is an integer of 1-4 (preferably 1-3). R⁷ represents a hydrocarbon having e valences and 2-24 (preferably 2-18) carbon atoms [for example, the same alkyl groups as described as R⁴, a cycloalkyl group, an aryl group, —(CH₂)₂— the following groups],

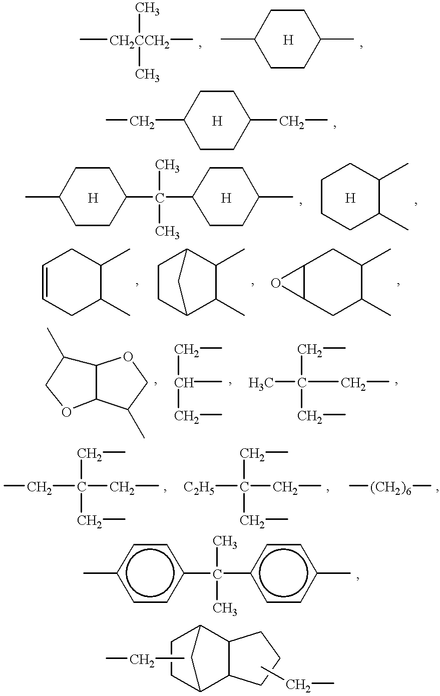

Alternatively, Ar represents a hydrocarbon group having e valences and 4-24 (preferably 4-18) carbon atoms, and having an ether bond therein [for example, —CH₂CH₂OCH₂CH₂—, —CH₂CH₂(OCH₂CH₂)₃—, —CH₂CH₂CH₂OCH₂CH₂CH₂—, and the following groups].

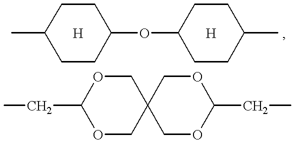

In the formula [S-4], R⁸ represents an aliphatic group having 3-24 (preferably 3-17) carbon atoms (for example, n-propyl, 1-hydroxyethyl, 1-ethylpentyl, n-undecyl, pentadecyl, 8,9-epoxyheptadecyl, cyclopropyl, cyclohexyl, and 4-methylcyclohexyl), and f is an integer of 1-4 (preferably 1-3). R⁹ represents a hydrocarbon group having f valences and 2-24 (preferably 2-18) carbon atoms, or a hydrocarbon group having f valences and 4-24 (preferably 4-18) carbon atoms and having an ether bond therein (for example, the same groups as described as R⁷).

In the formula [S-5], g is 2-4 (preferably 2 or 3), and R¹⁰ represents a hydrocarbon group having g valences [for example, —CH₂—, —(CH₂)₂—, —(CH₂)₄—, —(CH₂)₇— and the following groups].

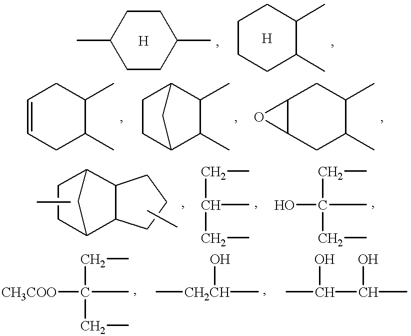

R¹¹ represents an aliphatic group having 1-24 (preferably 4-18) carbon atoms, or an aryl group having 6-24 (preferably 6-18) carbon atoms (for example, the same aliphatic groups and aryl groups as described as R⁴).

In the formula [S-6], R¹² represents an aliphatic group having 1-20 carbon atoms [for example, n-propyl, 1-ethylpentyl, n-undecyl, n-pentadecyl, 2,4-di-t-pentylphenoxymethyl, 4-t-octylphenoxymethyl, 3-(2,4-di-t-butylphenoxy)propyl, 1-(2,4-di-t-butylphenoxy)propyl, cyclohexyl, and 4-methylcyclohexyl], or an aryl group having 6-24 (preferably 6-18) carbon atoms (for example, the same aryl groups as described as the above-mentioned Ar).

R¹³ and R¹⁴ each represents an aliphatic group having 3-24 (preferably 3-18) carbon atoms (for example, isopropyl, n-butyl, n-hexyl, 2-ethylhexyl, n-dodecyl, cyclopentyl, and cyclopropyl), or an aryl group having 6-18 (preferably 6-15) carbon atoms (for example, phenyl, 1-naphthyl and p-tolyl).

R¹³ and R¹⁴ may be bonded to each other to form, together with N, a pyrrolidine ring, a piperidine ring, or a morpholine ring. R¹² and R¹³ may be bonded to each other to form a pyrrolidone ring.

X represents —CO— or —SO₂—, and is preferably —CO—.

In the formula [S-7], R¹⁵ represents an aliphatic group having 1-24 (preferably 3-18) carbon atoms (for example, methyl, isopropyl, t-butyl, t-pentyl, t-hexyl, t-octyl, 2-butyl, 2-hexyl, 2-octyl, 2-dodecy, 2-hexadecyl, t-pentadecyl, cyclopentyl and cyclohexyl), an alkoxycarbonyl group having 2-24 (preferably 5-17) carbon atoms (for example, n-butoxycarbonyl, 2-ethylhexyloxycarbonyl, and n-dodecyloxycarbonyl), an alkylsulfonyl group having 1-24 (preferably 3-18) carbon atoms (for example, n-butylsulfonyl and n-dodecylsulfonyl), an arylsulfonyl group having 6-30 (preferably 6-24) carbon atoms (for example, p-tolylsulfonyl, p-dodecylphenylsulfonyl and p-hexadecyloxyphenylsulfonyl), an aryl group having 6-32 (preferably 6-24) carbon atoms (for example, phenyl and p-tolyl), or a cyano group.

R¹⁶ represents a halogen atom (preferably Cl), an alkyl group having 1-24 (preferably 3-18) carbon atoms (for example, the same alkyl groups as described as R¹⁵), a cycloalkyl group having 5-17 carbon atoms (for example, cyclopentyl and cyclohexyl), an aryl group having 6-32 (preferably 6-24) carbon atoms (for example, phenyl and tolyl), an alkoxy group having 1-24 (preferably 1-18) carbon atoms (for example, methoxy, n-butoxy, 2-ethylhexyloxy, benzyloxy, n-dodecyloxy and n-hexadecyloxy), and an aryloxy group having 6-32 (preferably 6-24) carbon atoms (for example, phenoxy, p-t-butylphenoxy, p-t-octylphenoxy, m-pentadecylphenoxy and p-dodecyloxyphenoxy), and h is an integer of 1 or 2.

In the formula [S-8], R¹⁷ and R¹⁸ are the same as R¹³ and R¹⁴, and R¹⁹ is the same as R¹⁶.

In the formula [S-9], R²⁰ and R²¹ are the same as R¹, R² and R³, and j is 1 or 2 and is preferably 1.

Below, specific examples of the hydrophobic high-boiling point organic solvent (S-1 to S-23 as compounds represented by the formula [S-1], S-24 to S-39 as compounds represented by the formula [S-2], S-40 to S-44 as compounds represented by the formula [S-3], S-45 to S-50 as compounds represented by the formula [S-4], S-51 to S-58 as compounds represented by the formula [S-5], S-59 to S-67 as compounds represented by the formula [S-6], S-68 to S-75 as compounds represented by the formula [S-7], S-76 to S-79 as compounds represented by the formula [S-8], and S-80 to S-81 as compounds represented by the formula [S-9]).

Compound represented by the formula [S-1]

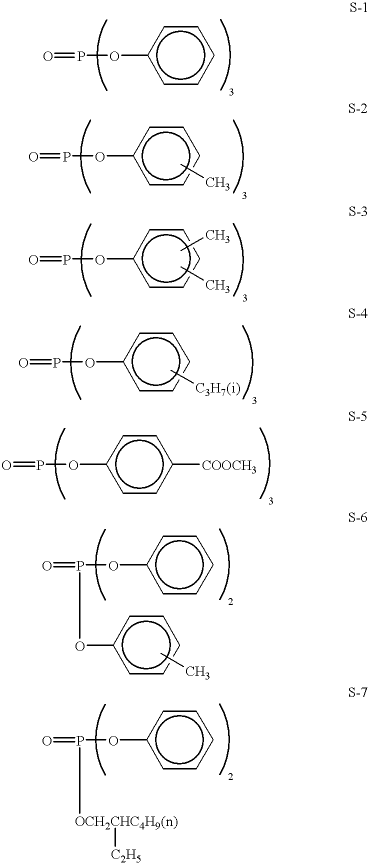

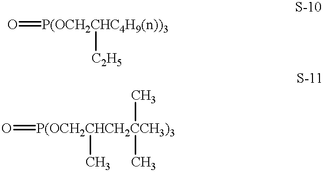

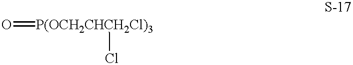

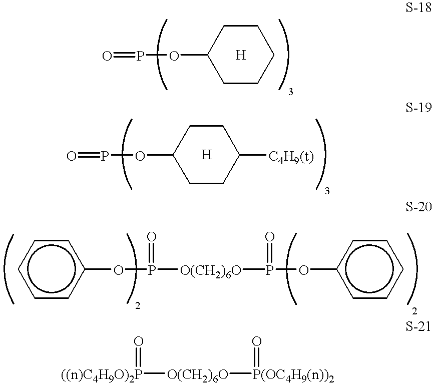

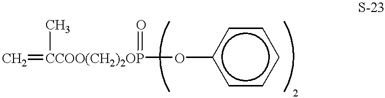

Compound represented by the formula [S-2]

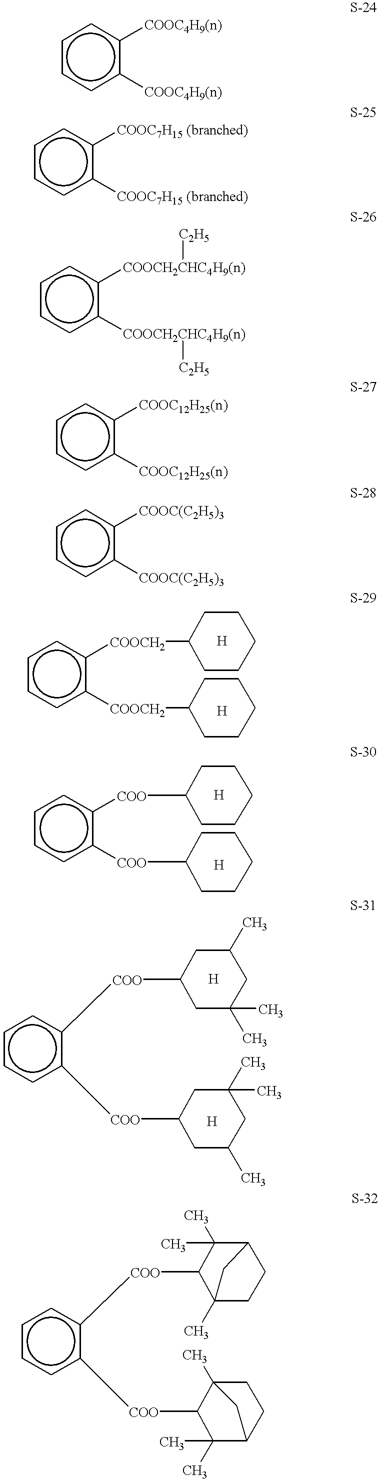

Compound represented by the formula [S-3]

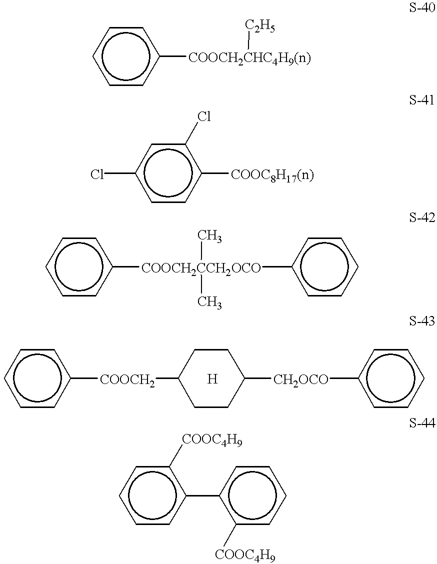

Compound represented by the formula [S-4]

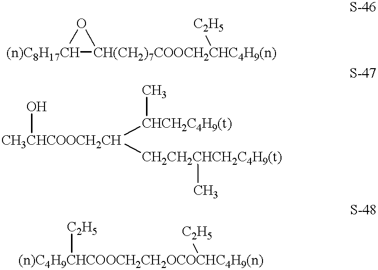

Compound represented by the formula [S-5]

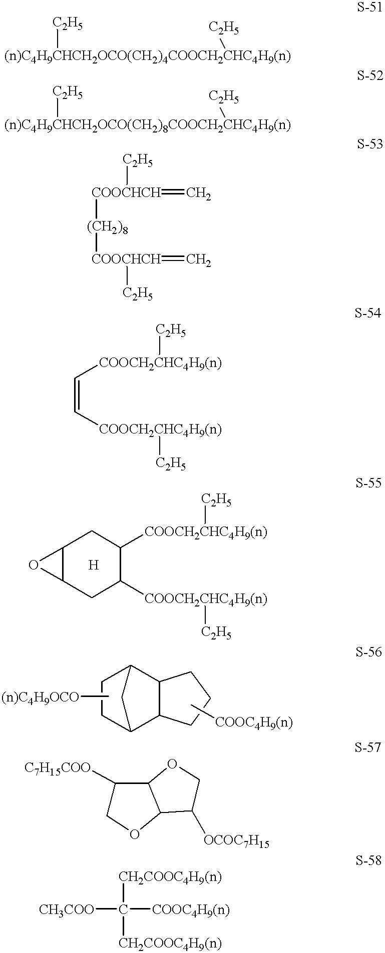

Compound represented by the formula [S-6]

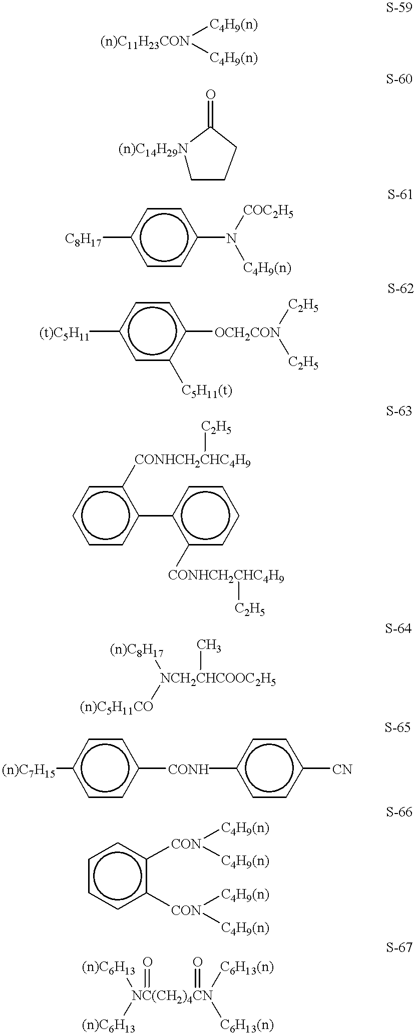

Compound represented by the formula [S-7]

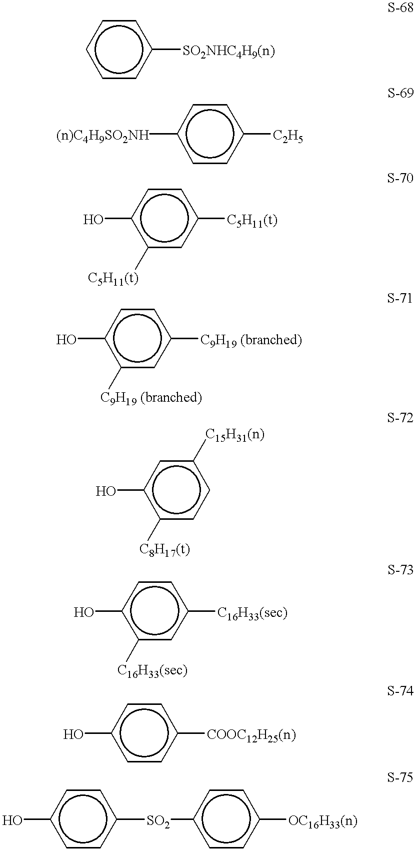

Compound represented by the formula [S-8]

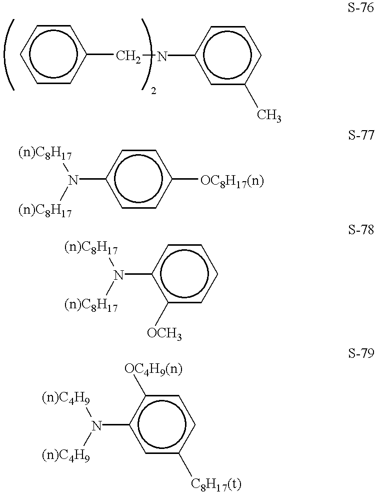

Compound represented by the formula [S-9]

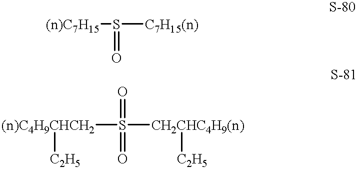

These hydrophobic high-boiling point organic solvents may be used alone or in combination of two or more. Examples of the combination include a combination of tricresyl phosphate and dibutyl phthalate, a combination of trioctyl phosphate and di(2-ethylhexyl) cebacate.

Examples of the hydrophobic high-boiling point organic solvents, other than the above-mentioned examples, and/or examples of methods of synthesizing these hydrophobic high-boiling point organic solvents are described in, for example, U.S. Pat. Nos. 2,322,027, 2,533,514, 2,772,163, 2,835,579, 3,594,171, 3,676,137, 3,689,271, 3,700,454, 3,748,141, 3,764,336, 3,765,897, 3,912,515, 3,936,303, 4,004,928, 4,080,209, 4,127,413, 4,193,802, 4,207,393, 4,220,711, 4,239,851, 4,278,757, 4,353,979, 4,363,873, 4,430,421, 4,430,422, 4,464,464, 4,483,918, 4,540,657, 4,684,606, 4,728,599, 4,745,049, 4,935,321 and 5,013,639, EP-Nos. 276,319A, 286,253A, 289,820A, 309,158A, 309,159A, 309,160A, 509,311A and 510,576A, East Germany Patent Nos. 147,009, 157,147, 159,573 and 225,240A, GB-2,091,124A, JP-A No. Nos. 48-47335, 50-26530, 51-25133, 51-26036, 51-27921, 51-27922, 51-149028, 52-46816, 53-1520, 53-1521, 53-15127, 53-146622, 54-91325, 54-106228, 54-118246, 55-59464, 56-64333, 56-81836, 59-204041, 61-84641, 62-118345, 62-247364, 63-167357, 63-214744, 63-301941, 64-9452, 64-9454, 64-68745, 1-101543, 1-102454, 2-792, 2-4239, 2-43541, 4-29237, 4-30165, 4-232946 and 4-346338, and so on.

Fabrication of coloring particulate dispersion

The coloring particulate dispersion included in the coloring composition of the present invention is obtained by dispersing in a water-based medium at least one respective type of oil-soluble dye and hydrophobic organic solvent having a high-boiling point of no less than 150° C. Specifically, an example of one way in which the coloring particulate dispersion may be obtained is a method in which the oil-soluble dyes and the hydrophobic high-boiling point organic solvent are co-emulsified and dispersed (co-emulsification dispersing method). Suitable examples of the co-emulsification dispersing method include a method in which, by either adding water to an organic solvent phase containing the hydrophobic high-boiling point organic solvent and the oil-soluble dyes, or by adding the organic solvent phase to water, the organic solvent phase is emulsified to create particulates.

As an emulsifying apparatus used in the co-emulsification dispersing method, there can be used a known apparatus such as a simple stirrer or an impeller stirring mode apparatus, inline stirring mode apparatus, mill mode apparatus like a colloid mill or the like, ultrasonic mode apparatus, or the like. In the present invention, use of a high pressure emulsification dispersing device is preferable, and a high pressure homogenizer is particularly preferable.

Detailed mechanisms of the high pressure homogenizer are described in U.S. Pat. No. 4,533,254, JP-A No. 6-47264 and the like and, as a commercially available apparatus, GAULIN HOMOGENIZER (A. P. V Gaulin Inc.), MICROFLUIDIZER (Microfluidex Inc.), ALTIMIZER (Sugino Machine K.K.) and the like can be used.

Recently, a high pressure homogenizer equipped with a mechanism to form fine particulates in an ultrahigh pressure jet flow as described in U.S. Pat. No. 5,720,551 is particularly effective for emulsifying dispersion of the present invention. DEBEE2000 (Bee International Ltd.) is used as an example of this emulsifying apparatus using an ultrahigh pressure jet flow.

Pressure when emulsifying by a high pressure emulsifying dispersion apparatus is generally 50 MPa or more (500 bar or more), preferably 60 MPa or more (600 bar or more), and further preferably 180 MPa or more (1800 bar or more).

It is particularly preferable to use two or more emulsifying apparatuses together in a method, for example a method in which emulsification is conducted by a stirring emulsifier, then the emulsion is passed through a high pressure homogenizer. Further, a method in which emulsification is once conducted by such an emulsification apparatus, then additives such as a wetting agent, a surfactant and the like are added, then the emulsion is again passed through a high pressure homogenizer when a cartridge is being filled with ink is also a preferable method.

When a low-boiling point organic solvent is used in addition to the hydrophobic high-boiling point organic solvent, it is preferable to remove the low-boiling point organic solvent from the standpoints of stability and health and safety of the emulsion.

For removing the low-boiling point organic solvent, various known methods can be used depending on the type of the solvent. Namely, a vaporization method, vacuum vapor deposition method, ultrafiltration method and the like can be used. It is preferable to remove this low-boiling point organic solvent as quickly as possible directly after emulsification.

Various surfactants can be used in emulsification dispersion. For example, anionic surfactants such as fatty acid salts, alkylsulfate salts, alkylbenzenesuccinate salts, alkylnaphthalenesulfonate salts, dialkylsulfosuccinate salts, alkylphosphate salts, naphthalenesulfonic acid formalin condensate, polyoxyethylenealkylsulfate salts and the like, and nonionic surfactants such as polyoxyethylene alkyl ethers, polyoxyethylene alkylaryl ether, polyoxyethylene fatty acid esters, sorbitan fatty acid esters, polyoxyethylene sorbitan fatty acid esters, polyoxyethylene alkyl amines, glycerine fatty acid esters, oxyethylene oxypropylene block copolymers and the like, are preferable. Further, SURFYNOLS (Air Products & Chemicals), an acetylene-based polyoxyethylene oxide surfactant is also preferably used. Furthermore, amine oxide type ampholytic surfactants such as N,N-dimethyl-N-alkylamine oxide, and the like are also preferable. Further, surfactants listed in JP-A No. 59-157,636, pp. 37-38 and Research Disclosure No. 308119 (1989) can be used.

When coloring particulate dispersion containing the hydrophobic high-boiling point organic solvent and oil-soluble dyes are made into water-based ink by co-emulsification dispersion, control of particulate size is particularly important.

To enhance color purity and concentration when images are formed by ink jet, it is preferable to reduce the average particulate size. Specifically, the volume-average particulate size of the coloring particulate dispersion is preferably 100 nm or less, and more preferably 1 nm or more and 80 nm or less.

Further, when the above-mentioned coloring particulate dispersion contains coarse particulates, printing ability may be decreased. For example, there may be adverse influences on printing abilities, such as a case in which coarse particulates cause clogging in a head, a case in which discharge failure or discharge drip of ink is caused by formation of stains even though no clogging occurs, and the like.

Therefore, the existence ratio of coarse particulates is preferably low, and it is preferable that, when ink is prepared, 10 or less particulates having a particulate size of 5 μm or more and 1000 or less particulates having a particulate size of 1 μm or more are present in 1 μl of the ink.

For removing coarse particulates, a known centrifugal separation method, precision filtration method or the like can be utilized. These separation means may be conducted directly after emulsifying dispersion, or may be conducted after adding various additives such as a wetting agent, surfactant and the like to an emulsified dispersion and directly before charging the mixture into an ink cartridge. For decreasing the average particulate size of a coloring particulate dispersion and reducing coarse particulates, it is effective to use a mechanical emulsifying apparatus.

There are no particular limitations on the amount of the hydrophobic high-boiling point organic solvent contained in the coloring particulate dispersion of the present invention. However, from the standpoint of good retention of the ink in recording paper, it is preferable for the amount used to be 30 mass % with respect to the total mass of the oil-soluble dyes and hydrophobic high-boiling point organic solvent.

When the amount of the hydrophobic high-boiling point organic solvent used is too much, there is a tendency for stable, minute dispersion to be become difficult due to the proportion of oil phase being too large. Therefore, it is preferable for the amount of the hydrophobic high-boiling point organic solvent used to be 50 mass % to 1500 mass % with respect to the oil-soluble dyes, and more preferable for the amount used to be 100 mass % to 1000 mass % with respect to the same.

Co-Emulsification Dispersion of Water-Insoluble Polymers

In the present invention, water-insoluble polymers may be added at the time of co-emulsification dispersion in addition to the oil-soluble dyes and the hydrophobic high-boiling point organic solvent to obtain coloring particulate dispersion including the oil-soluble dyes, the hydrophobic high-boiling point organic solvent and the water-insoluble polymers.

Nonionic polymers or polymers containing ionic groups may be used as the water-insoluble polymer.

Examples of the ionic group include cationic groups such as tertiary amino groups and anion groups such as carboxylic acids and sulfonic acids. Examples of polymers containing the ionic group include vinyl polymers, condensed polymers (polyurethanes, polyesters, polyamides, polyureas, polycarbonates) and the like.

Methods of co-emulsifying and dispersing these nonionic polymers, polymers including ionic groups, oil-soluble dyes and hydrophobic high-boiling point organic solvents, and also specific examples of water-insoluble polymers are disclosed in detail in Japanese Patent Application No. 2000-203856 and Japanese Patent Application No. 2000-203857.

Organic solvent

There are no particular limitations on the organic solvent used together with the hydrophobic high-boiling point organic solvent in producing the coloring particulate dispersion. The organic solvent can be appropriately selected based on solubility of the oil-soluble dye. Examples of the organic solvent include ketone-based solvents such as acetone, methyl ethyl ketone, diethyl ketone and the like, alcohol-based solvents such as methanol, ethanol, 2-propanol, 1-propanol, 1-butanol, tert-butanol and the like, chlorine-based solvents such as chloroform, methylene chloride and the like, aromatic solvents such as benzene, toluene and the like, ester-based solvents such as ethyl acetate, butyl acetate, isopropyl acetate and the like, ether-based solvents such as diethyl ether, tetrahydrofuran, dioxane and the like, glycol ether-based solvents such as ethylene glycol monomethyl ether, ethylene glycol dimethylether and the like, and other solvents.

One type of organic solvent may be used singly, or two or more types of organic solvents may be used in combination. A solvent mixed with water may also be used, depending on the solubility of the oil-soluble dyes and water-insoluble polymers.

There are no particular limitations on the amount of organic solvent used, as long as the amount is in a range in which the effects of the present invention are not hindered. The amount used is preferably no more than 2000 parts by mass with respect to 100 parts by mass of the oil-soluble dyes, and more preferably 100 to 1000 parts by mass with respect to the same.

When the amount of organic solvent used exceeds 2000 parts by mass, processes of de-solution and concentration for removing the above-mentioned organic solvent become essential and complicated, and tolerance in composition tends to disappear.

When solubility of the organic solvent in water is less than 10%, or when the vapor pressure of the organic solvent is larger than that of water, it is preferable that the organic solvent is removed from the standpoint of stability of the coloring particulate dispersion.

The organic solvent can be removed under atmospheric or reduced pressure at 10° C. to 100° C. The organic solvent is preferably removed under atmospheric pressure at 40° C. to 100° C. or under reduced pressure at 10° C. to 50° C.

At the time of co-emulsification dispersion, the coloring particulate dispersion in the coloring composition or the ink for ink jet recording is preferably contained from an amount of 1 mass % to 45 mass % with respect to a total mass of the ink, and more preferably contained from an amount of 2 mass % to 30 mass % with respect to a total mass of the ink. The amount can be appropriately adjusted by, for example, dilution, evaporation and ultrafiltration.

Polymer Latex

The polymer latex included in the coloring composition of the present invention is produced by so-called emulsion polymerization that uses vinyl polymer, so that polymers are dispersed in particulate configuration in a water-based medium. It is preferable for the particle diameter to be 0.001 μm to 1 μm, and more preferably 0.01 μm to 0.5 μm.

With respect to the structure of the polymer structuring the polymer latex, homopolymers of monomers that may be optionally selected from the monomers indicated below as specific examples or copolymers combined freely may be used. There are no particular limitations on the monomer units that may be used. As long as the monomer is one that is capable of being polymerized by ordinary radical polymerization, optional monomers may be used.

Although specific examples of monomers that are used in the synthesis of the polymer structuring the polymer latex are listed below, the present invention is by no means limited to the same.

Examples of monomer groups include olefins, α, β-unsaturated carboxylic acids and their salts, derivatives of α, β-unsaturated carboxylic acids, amides of α, β-unsaturated carboxylic acids, styrenes and their derivatives, vinyl ethers, vinyl esters, and other polymerizable monomers.

Examples of the olefins include ethylene, propylene, isoprene, butadiene, vinyl chloride, vinylidene chloride, 6-hydroxy-1-hexene, cyclopentadiene, 4-pentenoic acid, 8-methyl nonanoate, vinyl sulfonic acid, trimethylvinylsilane, trimethoxyvinylsilane, pentadiene, 1,4-divinylcyclohexane, 1,2,5-trivinylcyclohexane, and the like.

Examples of the α, β-unsaturated carboxylic acids and their salts include acrylic acid, methacrylic acid, itaconic acid, maleic acid, sodium acrylate, ammonium methacrylate, potassium itaconate, and the like.

Examples of derivatives of α, β-unsaturated carboxylic acids include alkyl acrylates (e.g., methyl acrylate, ethyl acrylate, n-butyl acrylate, cyclohexyl acrylate, 2-ethyl hexyl acrylate, n- dodecyl acrylate, and the like), substituted alkyl acrylates (e.g., 2-chloroethyl acrylate, benzyl acrylate, 2-cyanoethyl acrylate, n-dodecyl metacrylate, and the like), substituted alkyl metacrylates {e.g., 2-hydroxyethyl metacrylate, glycidyl metacrylate, glycerine monometacrylate, 2-acetoxy ethyl metacrylate, tetrahydro furfuryl metacrylate, 2-methoxy ethyl metacrylate, ω-methoxy polyethylene glycol metacrylate (with 2-100 moles of polyoxyethylene added thereto), polyethylene glycol monometacrylate (with 2-100 moles of polyoxyethylene added thereto), polypropylene glycol monometacrylate (with 2-100 moles of polyoxypropylene added thereto), 2-carboxyethylmetacrylate, 3-sulfopropylmetacrylate, 4-sulfobutylmetacrylate, 3-trimethoxysilylpropylmetacrylate, allyl metacrylate, and the like}, derivatives of unsaturated dicarboxylic acids (e.g., maleic acid monobutyl, maleic acid dimethyl, itaconic acid monomethyl, itaconic acid dibutyl, and the like), multifunctional esters (e.g., ethylene glycol diacrylate, ethylene glycol dimetacrylate, 1,4-cyclohexane diacrylate, pentaerythritolpropylmetacrylate, pentaerythritolacrylate, trimethylolpropantriacrylate, trimethylolethantriacrylate, dipentaerythritolpentametacrylate, pentaerythritolhexacrylate, 1,2,4-cyclohexanetetrametacrylate, and the like).

Examples of amides of α, β-unsaturated carboxylic acids include acrylamides, methacrylamides, N-methylacrylamides, N,N-dimethylacrylamides, N-methyl-N-hydroxyethylacrylamides, N-tertbutylacrylamides, N-tertoctylmethacrylamides, N-cyclohexylacrylamides, N-phenylacrylamides, N-(2-acetoacetoxyethyl)acrylamides, N-acryloylmorpholines, diacetoneacrylamides, diamide itaconates, N-methylmaleimides, 2-acrylamide-2-methylpropanesulfonic acids, methylenebisacrylamides, dimethacryloylpiperazines and the like.

Examples of the styrenes and their derivatives include styrenes, vinyltoluene, p-tertbutylstyrene, vinyl benzoate, vinyl methyl benzoate, α-methylstyrene, p-chloromethylstyrene, vinylnapthalene, p-hydroxymethylstyrene, p-styrenesulfonate sodium, p-styrenesulfinic acid potassium, 1,4-divinylbenzyne, 4-vinyl benzoate-2-acryloylethylesther and the like.

Examples of the vinyl ethers include methylvinylethers, butylvinylethers, methoxyethylvinylethers, and the like.

Examples of the vinyl esters include vinyl acetate, vinyl propionate, vinyl benzoate, vinyl salicylate vinyl chloroacetate, and the like.

Examples of other polymerizable compounds include N-vinylpyrrolidone, 2-vinyloxazoline, 2-isopropenyloxazoline, divinylsulfone, and the like.

The polymer that is selected as the polymer latex of the present invention and that is synthesized by copolymerization in which the above monomers are combined is preferably a polymer comprising a homopolymer or copolymer having as main components thereof acryl methacryl resins, sytrene resins, conjugate diene resins, vinyl acetate resins, polyolefin resins and the like. Among these, a polymer having on a main chain or side chain thereof an ethylene unsaturated group, i.e., a polymer that has conjugate dienes or at least two kinds of disconjugate ethylene resin groups and that has as a structural monomer component at least one kind of monomer having unsaturated groups whose respective polymerabilities are different, is more preferable. A polymer that takes as a structural component conjugate dienes is particularly preferable.

Of monomers comprising polymers having on a main chain or side chain thereof an ethylene unsaturated group, suitable examples of monomers whose respective unsaturated groups have different polymerabilities include allyl acrylates, allyl methacrylates, N-allyl acrylamides, N-allyl methacrylamides, and the like.

Examples of the conjugate dienes include 1,3-butadiene; isoprene; 1,3-pentadiene; 2-ethyl-1,3-butadiene; 2-n-propyl-1,3-butadiene; 3-dimethyl-1,3-butadiene; 2-methyl-1,3-butadiene; 2-methyl-1,3-butadiene; 1-phenyl-1,3-butadiene; 1-α-naphthyl-1,3-butadiene; 1-β-naphthyl-1,3-butadiene; 2-chloro-1,3-butadiene; 1-brom-1,3-butadiene; 1-chlorbutadiene; 2-fluoro-1,3-butadiene; 2,3-dichloro-1,3-butadiene; 1,1,2-trichloro-1,3-butadiene; 2-cyano-1,3-butadiene; 1,4-hexadiene; cyclopentadiene; ethylidene norbornene; and the like.

Preferable examples of the polymer latex are listed below, but the present invention is by no means limited to the same. Unless otherwise specified, the numerical values showing compositional ratios for each monomer are expressed as mass percentages.

P-1) styrene/butadiene (80/20)

P-2) styrene/butadiene/acrylic acid (70/27/3)

P-3) styrene/butadiene/acrylic acid (48/49/3)

P-4) styrene/butadiene (37/63)

P-5) styrene/butadiene (23/77)

P-6) butadiene (homopolymer)

P-7) isoprene (homopolymer)

P-8) ethyl acrylate/butadiene (40/60)

P-9) ethyl acrylate/styrene/butadiene (40/30/30)

P-10) isoprene/styrene/vinyltuorene (50/25/25)

P-11) methylacrylate (homopolymer)

P-12) ethylacrylate (homopolymer)

P-13) ethylacrylate /methylmetacrylate (70/30)

P-14) ethylacrylate/styrene/2-acrylamide-2-methylpropane sulfonate soda (55/40/5)

P-15) n-butylacrylate/styrene (40/60)

P-16) n-butylacrylate/t-butylacrylate/acrylate (47/50/3)

P-17) 2-ethylhexylacrylate/styrene (50/50)

P-18) n-butylmethacrylate (homopolymer)

P-19) n-butylmethacrylate/methacrylate (90/10)

P-20) n-butylmethacrylate/methoxypolyethyleneglycol (n=9) monomethacrylate (80/20)

P-21) 2-ethylhexylmethacrylate/styrene/2-hydroxyethylmethacrylate/acrylate (40/40/18/2)

P-22) n-dodecylmethacrylate/methylmethacrylate/styrene/styrene sulfonate soda(45/25/25/5)

P-23) benzylmethacrylate/methylacrylate (80/20)

P-24) styrene/n-butylacrylate/allyl methacrylate (40/30/30)

P-25) 2-ethylhexylmethacrylate/styrene/allyl methacrylate/methacrylate (30/35/30/5)

P-26) vinyl acetate (homopolymer)

P-27) t-butylacrylamide/n-butylacrylate/2-carboxyethylacrylate (45/45/10)

P-28) methylacrylate/2-acetoacetoxyethylmethacrylate/acrylate (80/17/3)

P-29) ethyleneglycoldimethacrylate/n-butylmethacrylate/acrylate (5/92/3)

P-30) ethyleneglycoldimethacrylate/styrene/n-butylacrylate (10/45/45)

P-31) ethyleneglycoldimethacrylate/ethylmethacrylate/glycidylmethacrylate/methoxypolyethyleneglycol (n=23) monomethacrylate (5/60/20/15)

P-32) divinylbenzene/styrene/2-ethylhexylmethacrylate (5/45/50)

P-33) trivinylcyclohexane/n-butylmethacrylate/2-carboxyethylacrylate (5/75/20)

One type of polymer latex may be used singly, or two or more types of polymer latex may be used in combination as needed.

As long as no chain transfer agent is used, the polymer latex of the present invention synthesized by emulsification polymerization has a high molecular weight in comparison to ordinary solution polymerization, and ordinarily has a weight average molecular weight of 100,000 or more. Further, when using a conjugate diene monomer or when using a monomer having two or more ethylene unsaturated groups, sometimes the molecular weight becomes substantially infinite due to a crosslinking reaction.

In the present invention, it is thought that a more preferable effect is achieved with respect to image fastness due to the polymer latex existing independently of the coloring particulate dispersion. That is, it is thought that when the ink for ink jet recording having the coloring composition of the present invention is discharged to the image-receiving material, there is a difference between the retention of the coloring particulate dispersion and the retention of the polymer latex at the image-receiving material. When the polymer latex has an action that cuts off connection between the oil-soluble dyes and the outside, or when the polymer latex has double bonds on the main chain or side chain thereof, through the effect whereby fading-acceleration substances such as ozone are seized, resistance to fading of the oil-soluble dyes and image fastness are improved. Accordingly, from this standpoint, it is preferable that the molecular weight of the polymer latex be 100,000 or more.

There are no particular limitations on the amount of polymer latex used. However, it is preferable for the amount of the polymer latex included in the coloring composition or the ink for ink jet recording to be 0.1 to 30 mass % with respect to a total mass of the ink, and more preferably 1 to 20 mass % with respect to a total mass of the ink. The amount of polymer latex to be included in the coloring composition can be suitably adjusted depending on types and weights of the hydrophobic high-boiling point organic solvent, oil-soluble dyes and other components, and depending on the viscosity of the polymer latex itself.

Description will now be given of the emulsification polymerization method used to synthesize the polymer latex.

The emulsification polymerization method is conducted as follows. Using at least one type of emulsifier, monomers at 5-150 mass % with respect to the dispersion medium are added to water or a solvent comprising a mixture of water and an organic solvent (e.g., methanol, ethanol, acetone, etc.) to be emulsified by the addition of the emulsifier at 0.1-20 mass % with respect to the monomer. Using a radical polymerization initiator at 0.02-5 mass % with respect to the monomer, the mixture is stirred at a temperature of preferably 30° C. to about 100° C., and more preferably 40° C. to 90° C.

It is preferable that the amount of the organic solvent obtained by mixing with water is 0-100%, and more preferably 0-50%, at a volume ratio with respect to the water.

Examples of the polymerization initiator include azobis compounds, peroxides, hydroperoxides, redox catalysts and the like. Preferable examples include inorganic peroxides such as potassium persulfates and ammonium persulfates; organic peroxides such as t-butyl peroctate, benzoyl peroxide, isopropyl percarbonate, 2,4-dichlorobenzoyl peroxide, methylethylketon peroxide, cumenehydroperoxide, dicumyl peroxide and the like; and azo compounds such as 2,2′-azobis isobutylate, sodium salt of 2,2′-azobiscyano valeric acid, 2,2′-azobis(2-amidinopropane)hydrochloride, 2,2′azobis[2-(5-methyl-2-imidazoline-2-yl)propane]hydrochloride, 2,2′-azobis{2-methyl-N-[1,1′-bis(hydroxymethyl)-2-hydroxyethyl]propionamide} and the like. Among these, potassium persulfates and ammonium persulfates are preferable.

Examples of the emulsifier include, in addition to anionic, cationic, amphionic and nonionic surfactants, water-soluble polymers and the like. Specific examples include lauric acid soda, sodium dodecyl sulfate, 1-octoxycarbonylmethyl-1-octoxycarbonylmethansulfonate, laurylnaphthalenesulfonate, laurylbenzensulfonate, laurylsodium phosphate, cetyltrimethylammonium chloride, N-2-ethylpyridinium chloride, polyoxyethylene nonylphenolethyl, polyoxyethylene sorbitanlaurylesther, polyvinyl alcohol, and the emulsifiers and water-soluble polymers disclosed in Japanese National Publication No. 53-6190.

In the emulsification polymerization method, it is possible to widely and easily change the polymerization initiators, concentration, polymerization temperature and reaction time as needed. Further, the emulsification polymerization method may be conducted by placing beforehand the entire amounts of the monomers, surfactants and water-base medium into a reaction container and then throwing in the initiators. The emulsification polymerization method may also be conducted by dropping entire amounts or portions of the monomers or initiators or both.

The polymer latex is capable of being synthesized easily by using ordinary emulsification polymerization methods. The following publications contain details on general methods of emulsification polymerization: Gôsei Jushi Emurujon (“Synthetic Resin Emulsion”, edited by Taira Okuda and Hiroshi Inagaki, Polymer Publishing Association, 1978), Gôsei Ratekkusu no Ôyô (“Synthetic Latex Applications”, edited by Takaaki Sugimura, Yasuo Tetsuoka, Sôichi Suzuki, Keishi Kasahara, Polymer Publishing Association, 1993), and Gôsei Ratekkusu no Kagaku (“Synthetic Latex Chemistry”, by Sôichi Muroi, Polymer Publishing Association, 1970).

### Ink for Ink Jet Recording

The ink for ink jet recording of the present invention includes the coloring composition of the present invention. The ink for ink jet recording includes the oil-soluble dye (The oil-soluble dye includes the compounds represented by general formulae (I), (M-I) or (C-I), or a dye derived from the compounds represented by these same general formulae) preferably at 0.1 to 20 mass %. Additionally, the ink for ink jet recording of the present invention may also include other components other than these which are appropriately selected as needed.

Other Components

Examples of the aforementioned other components include components in a range in which the effects of the present invention are not comprised, such as known additives like drying prevention agents, permeation promoting agents, ultraviolet ray absorbers, antioxidants, anti-fungus agents, pH controlling agents, surface tension controlling agents, de-foaming agents, viscosity controlling agents, dispersion stabilizers, rust-prevention agents, chelating agents and the like.

The drying prevention agent is suitably used for the purpose of inhibiting clogging due to drying of the above-mentioned ink jet ink at the ink discharge port of the nozzle used in the ink jet recording method.

For the drying prevention agent, a water-soluble organic solvent having a lower vapor pressure than that of water is preferable. Specific examples thereof include polyhydric alcohols, typified by ethylene glycol, propylene glycol, diethylene glycol, polyethylene glycol, thiodiglycol, dithiodiglycol, 2-methyl-1,3-propanediol, 1,2,6-hexanetriol, acetylene glycol derivatives, glycerine, trimethylolpropane and the like; lower alkyl ethers of polyhydric alcohol such as ethylene glycol monomethyl (or ethyl) ether, diethylene glycol monomethyl (or ethyl) ether, triethylene glycol monoethyl (or butyl) ether and the like; heterocyclic rings such as 2-pyrrolidone, N-methyl-2-pyrrolidone, 1,3-dimethyl-2-imidazolidinone, N-ethylmorpholine and the like; sulfur-containing compounds such as sulfolane, dimethylsulfoxide, 3-sulfolene and the like; polyfunctional compounds such as diacetone alcohol, diethanolamine and the like; and urea derivatives.

Of these, polyhydric alcohols such as glycerine, diethylene glycol and the like are more preferable. These drying prevention agents may be used alone or in a combination of two or more. The content of the above-mentioned drying prevention agent in the above-mentioned ink-jet ink is preferably from 10 to 50% by mass.

The above-mentioned permeation promoting agent is suitably used for the purpose of more excellent permeation of the ink jet ink into paper.

Examples of the above-mentioned permeation promoting agent include, for example, alcohols such as ethanol, isopropanol, butanol, di(tri)ethylene glycol monobutyl ether, 1,2-hexanediol and the like, sodium laurylsulfate, sodium oleate, and nonionic surfactants and the like.

The above-mentioned permeation promoting agent is contained in an amount in a range wherein blotting of print, passing through paper (print through) and the like do not occur, and usually a sufficient effect is manifested when the permeation promoting agent is contained in an amount of about 5 to 30% by mass in the ink-jet ink.

The above-mentioned ultraviolet ray absorber is used for the purpose of improving storability of images. Examples of the ultraviolet ray absorber include, for example, benzotriazole-based compounds described in JP-A Nos. 58-185677, 61-190537, 2-782, 5-197075, 9-34057 and the like, benzophenone-based compounds described in JP-A Nos. 46-2784, 5-194483, U.S. Pat. No. 3,214,463 and the like, cinnamic acid-based compounds described in JP-B Nos. 48-30492, 56-21141, JP-A No. 10-88106 and the like, triazine compounds described in JP-A Nos. 4-298503, 8-53427, 8-239368, 10-182621, 8-501291 (PCT National Publication), and the like, compounds that emit fluorescence when absorbing ultraviolet rays, called fluorescent brighteners, typified by compounds described in Research Disclosure No. 24239, stilbene-based compounds and benzozazole-based compounds, and the like.

The above-mentioned antioxidant is used for the purpose of improving the storability of images.

As the above-mentioned antioxidant, examples that can be used include organic and metal complex-based discoloration preventing agents.

As the above-mentioned organic discoloration preventing agent, examples include hydroquinones, alkoxyphenols, dialkoxyphenols, phenols, anilines, amines, indanes, chromans, alkoxyanilines, heterocyclic rings and the like.

As the above-mentioned metal complex-based discoloration preventing agent, examples include a nickel complex, a zinc complex and the like. Specifically, there can be used compounds described in patents cited in Research Disclosure No. 17643, vol. VII, column I to J, No. 15162, No. 18716, page 650, left column, No. 36544, page 527, No. 307105, page 872 and No. 15162, and compounds included in examples and general formulae of typical compounds described in JP-A No. 62-215272, pp. 127 to 137.

Examples of the anti-fungus agent include dehydro sodium acetate, sodium benzoate, sodiumpyridienthione-1-oxide, ethyl p-hydroxybenzoate, 1,2-benzisothiazoline-3-one and salts thereof. These are preferably used in an amount of 0.02 to 1.00% by mass in ink.

The pH controlling agent can be suitably used in terms of adjusting the pH of and providing dispersion stability to the ink for ink jet recording. It is preferable that the pH controlling agent is added so that the ink for ink jet recording has a pH of 4.5 to 10.0, and more preferably so that the ink for ink jet recording has a pH of 6 to 10.

For the pH controlling agent, organic bases and inorganic alkalis are preferable as bases and organic acids and inorganic acids are preferable as acids.

Examples of preferable organic bases for base pH controlling agents include triethanolamine, diethanolamine, N-methyldiethanolamine, dimethylethanolamine and the like. Examples of preferable inorganic bases for base pH controlling agents include hydrides of alkali metals, carbonates, ammonia and the like. Among hydrides of alkali metals, sodium hydride, lithium hydride and potassium hydride are especially preferable. Among carbonates, sodium carbonate and sodium bicarbonate are especially preferable.

Further, examples of preferable organic acids for acidic pH controlling agents include acetic acid, propionic acid, trifluoroacetic acid, alkyl sulfonic acid and the like. Examples of preferable inorganic acids for acidic pH controlling agents include hydrochloric acid, sulfuric acid, phosphoric acid and the like.

As the above-mentioned surface tension controlling agent, nonionic, cationic or anionic surfactants are listed as examples.

The surface tension of the ink for ink jet recording of the present invention is preferably from 25 to 70 mN/m, and more preferably from 25 to 60 mN/m.

The viscosity of the ink for ink jet recording of the present invention is preferably 30 mPa.s or less, and more preferably 20 mPa.s or less.

As the above-mentioned defoaming agent, fluorine-based compounds and silicone-based compounds, and chelating agents typified by EDTA, and the like can also be used, if necessary.

### Ink Jet Recording Method

In the ink jet recording method of the present invention, recording is carried out on image-receiving material using the ink for ink jet recording. There are no particular restrictions on the ink nozzle and such used at the time of recording. These can be appropriately selected according to purpose.

Image-Receiving Material

There are no particular restrictions on the image-receiving material. Known recording materials, such as normal paper, resin coated paper, ink jet dedicated paper, films, general electrophotographic paper, cloth, glass, metals, ceramics and the like may be used.

Among such recording materials, ink jet dedicated paper is preferable. Particularly preferable examples of the ink jet dedicated paper include those disclosed in JP-A Nos. 8-169172, 8-27693, 2-276670, 7-276789, 9-323475, 62-238783, 10-153989, 10-217473, 10-235995, 10-337947, 10-217597, 10-337947 and the like.

In the present invention, the following recording paper and recording film are particularly preferable as the image-receiving material.

The recording paper or recording film has a substrate with an ink receiving layer laminated thereon and, if necessary, has other layers such as a back coat layer and the like laminated thereto.

The layers typically including an ink receiving layer may be used each in a single layer, or in two or more layers.

As the above-mentioned substrate, examples include those made of chemical pulp such as LBKP, NBKP and the like, those made of mechanical pulp such as GP, PGW, RMP, TMP, CTMP, CMP CGP and the like, and those made of waste pulp such as DIP and the like. In the above-mentioned pulp, conventionally known pigments, binders, sizing agents, fixing agents, cationic agents, paper strength reinforcing agents and the like may be added and mixed as necessary. The above-mentioned substrate can be formed by using various apparatuses such as a long net paper machine, round net paper machine or the like. The above-mentioned substrate may further be synthetic paper, plastic film sheet and the like.

The thickness of the above-mentioned substrate is from about 10 to 250 μm, and the basic weight is desirably from 10 to 250 g/m².

On the substrate, the ink receiving layer, and further the back coat layer selected as necessary, may be directly laminated, or the above-mentioned ink receiving layer and the above-mentioned back coat layer may be provided after a size press or anchor coat layer is formed of starch, polyvinyl alcohol or the like.

Further, on the substrate, a flattening treatment may be performed by a calendering machine such as a machine calender, TG calender, soft calender or the like.

Of the above-mentioned substrates, paper and plastic films laminated on both surfaces with a polyolefin (for example, polyethylene, polystyrene, polyethylene terephthalate, polybutene, or a copolymer thereof) are preferable, and it is more preferable that a white pigment (for example, titanium oxide, zinc oxide) or coloring dyer (for example, cobalt blue, ultramarine, neodymium oxide) is added in the above-mentioned polyolefin.

The above-mentioned ink receiving layer contains a pigment, water-based binder, mordanting agent, water resistant agent, light resistance improving agent, surfactant, and other additives.

As the pigment, a white pigment is preferable. Examples of the white pigment include, for example, inorganic white pigments such as calcium carbonate, kaolin, talc, clay, diatomaceous earth, synthetic amorphous silica, aluminum silicate, magnesium silicate, calcium silicate, aluminum hydroxide, alumina, lithopone, zeolite, barium sulfate, calcium sulfate, titanium dioxide, zinc sulfate, zinc carbonate and the like; and organic pigments such as styrene-based pigments, acrylic pigments, urea resins, melamine resins and the like.

Of these, porous inorganic pigments are preferable, and a synthetic amorphous silica having a large fine pore area or the like is particularly preferable.

As the above-mentioned synthetic amorphous silica, any of anhydrous silic acid obtained by a dry production method and water-containing silic acid obtained by a wet production method can be used, and water-containing silic acid is particularly preferable.

Examples of the aforementioned water-based binder include, for example, water-soluble polymers such as polyvinyl alcohol, silanol-modified polyvinyl alcohol, starch, cationized starch, casein, gelatin, carboxymethylcellulose, hydroxyethylcellulose, polyvinylpyrrolidone, polyalkylene oxide, polyalkylene oxide derivatives, and the like; and water-dispersible polymers such as styrene butadiene latex, acryl emulsion and the like.

These may be used alone or in a combination of two or more. Of these, polyvinyl alcohol and silanol-modified polyvinyl alcohol are preferable from the standpoints of adhesion to the pigment and an anti-peeling property of the ink receiving layer.

The mordanting agent is preferably immobilized and, therefore, a polymer mordanting agent is preferable.

Examples of the polymer mordanting agent include those disclosed in JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134, and 1-161236, and U.S. Pat. Nos. 2,484,430, 2,548,564, 3,148,061, 3,309,690, 4,115,124, 4,124,386, 4,193,800, 4,273,853, 4,282,305, and 4,450,224. Polymer mordanting agents described in JP-A No. 1-161236, pp. 212 to 215 are suitably listed as examples. When these polymer mordanting agents are used, an image having excellent image quality is obtained, and light resistance of the image is improved, which is preferable.

The above-mentioned water resistant agent is used for the purpose of rendering an image water-resistant.

A cationic resin is preferable as the water-resistant agent.

As the cationic resin, there are listed, for example, polyamidepolyamineepichlorohydrin, polyethyleneimine, polyamineslfone, dimethyldiallylammonium chloride polymer, cation polyacrylamide and the like. Of these cationic resins, polyamidepolyamineepichlorohydrin is particularly preferable.

The content of the cationic resin is preferably from 1 to 15% by mass, and more preferably from 3 to 10% by mass based on the total solid component of the ink receiving layer.

As the light resistance improving agent, there are listed, for example, zinc sulfate, zinc oxide, hindered amine-based antioxidant, benzophenone-based and benzotriazole-based ultraviolet ray absorbers and the like. Of these, zinc sulfate is particularly preferable.

The above-mentioned surfactant functions as a coating aid, peeling property improving agent, sliding property improving agent or antistatic agent. Examples of the surfactant include those described in JP-A No. 62-173463 and No. 62-183457.

An organic fluoro compound may be used instead of the surfactant. The organic fluoro compound is preferably hydrophobic. The organic fluoro compound includes, for example, a fluorine surfactant, oily fluorine compound (for example, fluorine oil) and a solid fluorine compound resins (for example, ethylene tetrafluoride resin).

Examples of the organic fluoro compound include those described in JP-B No. 57-9053 (columns 8 to 17), and JP-A Nos. 61-20994 and 62-135826.

Examples of the above-mentioned other additives, include pigment dispersing agents, thickening agents, defoaming agents, dyes, fluorescent brighteners, preservatives, pH controlling agents, matting agents, film hardening agents and the like.

The back coat layer contains a white pigment, water-based binder, and other components.

Examples of the white pigment include inorganic white pigments such as light calcium carbonate, heavy calcium carbonate, kaolin, talc, clay, calcium sulfate, barium sulfate, titanium dioxide, zinc oxide, zinc sulfate, zinc carbonate, satin white, aluminum silicate, diatomaceous earth, calcium silicate, magnesium silicate, synthetic amorphous silica, colloidal silica, colloidal alumina, pseudo bohemite, aluminum hydroxide, alumina, lithopone, zeolite, water-added halloysite, magnesium carbonate, magnesium hydroxide and the like; and organic pigments such as styrene-based plastic pigments, acrylic plastic pigments, polyethylene, microcapsule, urea resins, melamine resins and the like.

Examples of the water-based binder include water-soluble polymers such as styrene/maleic acid salt copolymer, styrene/acrylic acid salt copolymer, polyvinyl alcohol, silanol-modified polyvinyl alcohol, starch, cationized starch, casein, gelatin, carboxymethylcellulose, hydroxyethylcellulose, polyvinylpyrrolidone, and the like; and water-dispersible polymers such as styrene butadiene latex, acryl emulsion and the like.

As the above-mentioned other components, examples include defoaming agents, foaming suppressing agents, dyes, fluorescent brighteners, preservatives, water resistance imparting agents and the like.

A polymer latex may be added to each layer of the above-mentioned recording paper or recording film.

The polymer latex is used for the purpose of improving film physical properties such as dimension stability, curl prevention, adhesion prevention, and film cracking prevention.

As the polymer latex, examples include those described in JP-A Nos. 62-245258, 62-136648 and 62-110066. If a polymer latex having a low glass transition temperature (40° C. or less) is added to a layer containing the above-mentioned mordanting agent, cracking and curl of the layer can be prevented. Further, if a polymer latex having a high glass transition temperature is added to the above-mentioned back coat layer, curl can be prevented.

There are no particular restrictions on the image-receiving material used in the ink jet recording method of the present invention. When a recording medium having a substrate on which is laminated an ink receiving layer containing white pigment is used as the recording medium, the formed image obtains high image quality, which is preferable.

In the case of a conventional ink, there is a problem that, when recording paper having an ink receiving layer containing a porous inorganic pigment such as a white pigment or the like is used, the sinking property into the recording paper is poor, and when the formed image is rubbed with a hand, dye is peeled off from the surface. In the case of the ink of the present invention, such a problem has been solved since the sinking property is excellent. Therefore, when the above-mentioned recording medium is used, an image having high image quality and high strength can be formed.

The ink-jet ink of the present invention can be applied to any ink jet recording method, and suitably used for, for example, an electric charge controlling method in which ink is discharged by utilizing an electrostatic attracting force, a drop-on-demand method (pressure pulse method) utilizing vibration pressure of a piezo element, an acoustic ink jet method in which an electric signal is converted into an acoustic beam, ink is irradiated with this beam and the ink is discharged by utilizing radiation pressure, a thermal ink jet (bubble jet) method in which ink is heated to form bubbles, and generated pressure is utilized, and the like.

The ink jet recording method includes a method in which an ink having a lower concentration, called a photo ink, is discharged though a lot of ports in small volume, a method in which an image is improved by using a plurality of inks having substantially the same hue and different concentrations, and a method using a colorless, transparent ink.

### EXAMPLES

Examples of the present invention will be described hereinafter. However, the present invention is by no means limited to the same.

### Example 1

Production of Ink Set 101

8 g of dye (M-6) and 5 g of dioctyl sodium sulfosuccinate were dissolved at 70° C. in a mixture of 6 g of hydrophobic high-boiling point organic solvent (S-2), 5.0 g of ultraviolet absorbants UV1-UV5 (weight ratio=1:2:2:3:1 of the mixture), and 50 ml of ethyl acetate. 500 ml of deionized water was added to the solution while stirring with a magnetic stirrer, and an oil-in-water type coarse particulates dispersed product was produced.

Next, the obtained coarse particulates dispersed product was passed five times through MICROFLUIDIZER (MICROFLUIDEX INC) at a pressure of 60 MPa (600 bar) to obtain fine particulates.

Further, the obtained emulsified product was desolvated by a rotary evaporator until odor of the ethyl acetate disappeared.

Additives such as 160 g of diethylene glycol, 64 g of glycerin, 7 g of SURFYNOL 465 (Air Products & Chemicals), urea, and the like were added to the obtained coloring composition. Thereafter, deionized water was added thereto. The pH of the coloring composition was adjusted to 9 using 1 mol/liter of KOH. Accordingly, a light magenta ink according to Table 1 was produced. The volume average particulate size of the obtained emulsified and dispersed ink was measured using MICROTRACK UPA (Nikkiso Co., Ltd.). The volume average particulate size was 47 nm.

The type of dye and the hydrophobic high-boiling point organic solvent were altered to produce a magenta ink, a light cyan ink, a cyan ink, a yellow ink, and a black ink shown in comparative ink set 101 in Table 12.

TABLE 12
Ink Set 101

| | Light | | Light Cyan | | | |
|---|---|---|---|---|---|---|
| | Magenta Ink | Magenta Ink | Ink | Cyan Ink | Yellow Ink | Black Ink |
| Dye (g/l) | M-6 5.00 | M-6 20.0 | C-1 9.3 | C-1 37.2 | Y-1 27.2 | M-6 10.0 |
| Dye (g/l) | | | | | | C-1 18.6 |
| | | | | | | Y-1 13.6 |
| HBPOS | S-1 3.8 | S-1 15.0 | S-1 7.0 | S-1 27.9 | S-1 20.4 | S-1 31.7 |
| (g/l) | S-2 6.3 | S-2 25.0 | S-2 11.8 | S-2 47.0 | S-2 34.0 | S-2 53.3 |
| Ultraviolet | 3.13 | 12.5 | 5.8 | 23.3 | 17.0 | 26.4 |
| Absorbants | | | | | | |
| (g/l) (UV- | | | | | | |
| 1/2/3/4/5 = | | | | | | |
| 1:2:2:3:1 | | | | | | |
| mixture) | | | | | | |
| Dioctyl | 3.13 | 12.5 | 5.8 | 23.3 | 17.0 | 26.4 |
| Sodium | | | | | | |
| Sulfosucci- | | | | | | |
| nate (g/l) | | | | | | |
| Diethylene | 100.0 | 100.0 | 100.0 | 100.0 | 100.0 | 100.0 |
| Glycol (g/l) | | | | | | |
| Urea g/l | 46.0 | 46.0 | 46.0 | 46.0 | 46.0 | 46.0 |
| Glycerin | 40.0 | 40.0 | 40.0 | 40.0 | 40.0 | 40.0 |
| (g/l) | | | | | | |
| SURFYNOL | 5.5 | 5.5 | 5.5 | 5.5 | 5.5 | 5.5 |
| 465 (g/l) | | | | | | |
| Triethanol- | 7.5 | 7.5 | 7.5 | 7.5 | 7.5 | 7.5 |
| amine (g/l) | | | | | | |
| Benzo- | 0.075 | 0.075 | 0.075 | 0.075 | 0.075 | 0.075 |
| triazole | | | | | | |
| (g/l) | | | | | | |
| Proxel XL2 | 2.5 | 2.5 | 2.5 | 2.5 | 2.5 | 2.5 |
| (g/l) | | | | | | |
| Deionized water | | | | | | |
| added to make | | | | | | |
| one liter. | | | | | | |
| VAPS(nm) | 47 | 53 | 56 | 57 | 49 | 64 |

Note:
In the preceding table, HBPOS =High-boiling Point Organic Solvent and VAPS = Volume Average Particulate Size.

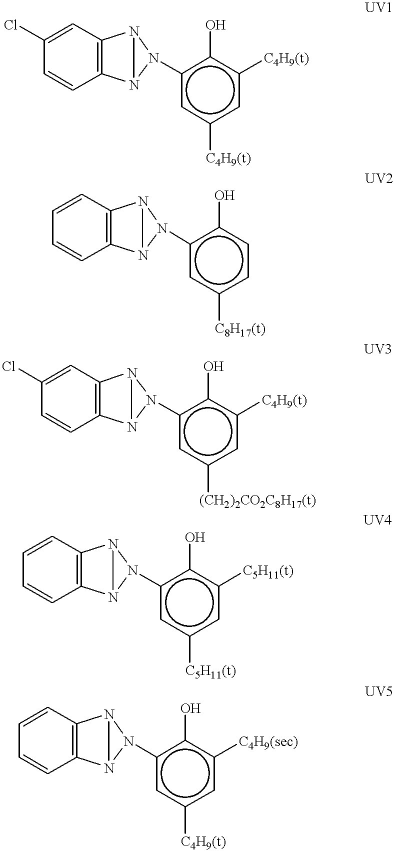

Production of Ink Sets 102 to 105

Ink sets 102-105 of the present invention were produced in the same manner as ink set 101, except that polymer latex of the present invention shown in Table 13 was added after the deionized water was added. (It should be noted that total liquid amounts of the deionized water and the polymer latex of the present invention were kept constant. Further, the masses of the polymer latexes indicated in Tables 13 and 14 indicate the solid component of the polymer in one liter of ink.)

Production of Ink Sets 106 to 117

Next, comparative ink sets 106, 110 and 113 were produced in the same manner as ink set 101, except that the types of dyes and hydrophobic high-boiling point organic solvents were changed to those shown in Tables 13 and 14.

Further, the polymer latexes of the present invention shown in Table 13 and 14 were added by the same method as that used for ink sets 102-105, and ink sets 107-109, 111-112 and 114-116 respectively corresponding to comparative ink sets 106, 110 and 113 were produced.

Also, ink set 117 according to Table 15 was produced as a comparative ink set using a water-soluble dye.

TABLE 13
Ink Sets 101-108

| | | Light | | | | | | |
|---|---|---|---|---|---|---|---|---|
| Ink | | Magenta | Magenta | Light Cyan | | | | |
| Set | | Ink | Ink | Ink | Cyan Ink | Yellow Ink | Black Ink | Remarks |
| 101 | Dye (g/l) | M-6 5.0 | M-6 20.0 | C-1 9.3 | C-1 37.2 | Y-1 27.2 | M-6 10.0 | Comp. |
| | | | | | | | C-1 18.6 | Example |
| | | | | | | | Y-1 13.6 | |
| | HBPOS | 3.8/ | 15.0/ | 7.0/ | 27.9/ | 20.4/ | 31.7/ | |
| | (g/l) | 6.3 | 25.0 | 11.8 | 47.0 | 34.0 | 533 | |
| | S-2/S-11 | | | | | | | |
| | VAPS(nm) | 47 | 53 | 56 | 57 | 49 | 64 | |
| 102 | Dye (g/l) | M-6 5.0 | M-6 20.0 | C-1 9.3 | C-1 37.2 | Y-1 27.2 | M-6 10.0 | Present |
| | | | | | | | C-1 18.6 | Invention |
| | | | | | | | Y-1 13.6 | |
| | HBPOS | 3.8/ | 15.0/ | 7.0/ | 27.9/ | 20.4/ | 31.7/ | |
| | (g/l) | 6.3 | 25.0 | 11.8 | 47.0 | 34.0 | 53.3 | |
| | S-2/S-11 | | | | | | | |
| | VAPS(nm) | 47 | 53 | 56 | 57 | 49 | 64 | |
| | Polymer | P-2 20 | P-2 10 | P-2 20 | P-2 10 | P-2 10 | P-2 10 | |
| | Latex (g/l) | P-4 30 | P-4 15 | P-4 30 | P-4 15 | P-4 15 | P-4 15 | |
| 103 | Dye (g/l) | M-6 5.0 | M-6 20.0 | C-1 9.3 | C-1 37.2 | Y-1 27.2 | M-6 10.0 | Present |
| | | | | | | | C-1 18.6 | Invention |
| | | | | | | | Y-1 13.6 | |
| | HBPOS | 3.8/ | 15.0/ | 7.0/ | 27.9/ | 20.4/ | 31.7/ | |
| | (g/l) | 6.3 | 25.0 | 11.8 | 47.0 | 34.0 | 53.3 | |
| | S-2/S-11 | | | | | | | |
| | VAPS(nm) | 47 | 53 | 56 | 57 | 49 | 64 | |
| | Polymer | P-3 50 | P-3 25 | P-3 50 | P-3 25 | P-3 25 | P-3 25 | |
| | Latex (g/l) | | | | | | | |
| 104 | Dye (g/l) | M-6 5.0 | M-6 20.0 | C-1 9.3 | C-1 37.2 | Y-1 27.2 | M-6 10.0 | Present |
| | | | | | | | C-1 18.6 | Invention |
| | HBPOS | 3.8/ | 15.0/ | 7.0/ | 27.9/ | 20.4/ | 31.7/ | |
| | (g/l) | 6.3 | 25.0 | 11.8 | 47.0 | 34.0 | 53.3 | |
| | S-2/S-11 | | | | | | | |
| | VAPS(nm) | 47 | 53 | 56 | 57 | 49 | 64 | |
| | Polymer | P-19 50 | P-19 25 | P-19 50 | P-19 25 | P-19 25 | P-19 25 | |
| | Latex (g/l) | | | | | | | |
| 105 | Dye (g/l) | M-6 5.0 | M-6 20.0 | C-1 9.3 | C-1 37.2 | Y-1 27.2 | M-6 10.0 | Present |
| | | | | | | | C-1 18.6 | Invention |
| | | | | | | Y-1 13.6 | | |
| | HBPOS | 3.8/ | 15.0/ | 7.0/ | 27.9/ | 20.4/ | 31.7/ | |
| | (g/l) | 6.3 | 25.0 | 11.8 | 47.0 | 34.0 | 53.3 | |
| | S-2/S-11 | | | | | | | |
| | VAPS(nm) | 47 | 53 | 56 | 57 | 49 | 64 | |
| | Polymer | P-6 10 | P-6 5 | P-6 10 | P-6 5 | P-6 5 | P-6 5 | |
| | Latex (g/l) | P-19 40 | P-19 20 | P-19 40 | P-19 20 | P-19 20 | P-19 20 | |
| 106 | Dye (g/l) | M-6 5.0 | M-6 20.0 | C-1 9.3 | C-1 37.2 | Y-1 27.2 | M-6 10.0 | Comp. |
| | | | | | | | C-1 18.6 | Example |
| | | | | | | | Y-1 13.6 | |
| | HBPOS | 7.5/ | 30.0/ | 4.7/ | 18.8/ | 13.6/ | 21.8/ | |
| | (g/l) | 2.5 | 10.0 | 14.1 | 56.4 | 40.8 | 63.8 | |
| | S-10/S-15 | | | | | | | |
| | VAPS(nm) | 48 | 51 | 49 | 56 | 45 | 60 | |
| 107 | Dye (g/l) | M-6 5.0 | M-6 20.0 | C-1 9.3 | C-1 37.2 | Y-1 27.2 | M-6 10.0 | Present |
| | | | | | | | C-1 18.6 | Invention |
| | | | | | | | Y-1 13.6 | |
| | HBPOS | 75/ | 30.0/ | 4.7/ | 18.8/ | 13.6/ | 21.8/ | |
| | (g/l) | 2.5 | 10.0 | 14.1 | 56.4 | 40.8 | 63.8 | |
| | VAPS(nm) | 48 | 51 | 49 | 56 | 45 | 60 | |
| | Polymer | P-16 40 | P-16 20 | P-16 40 | P-16 20 | P-16 20 | P-16 20 | |
| | Latex (g/l) | | | | | | | |
| 108 | Dye (g/l) | M-6 5.0 | M-6 20.0 | C-1 9.3 | C-1 37.2 | Y-1 27.2 | M-6 10.0 | Present |
| | | | | | | | C-1 18.6 | Invention |
| | | | | | | | Y-1 13.6 | |
| | HBPOS | 75/ | 30.0/ | 4.7/ | 18.8/ | 13.6/ | 21.8/ | |
| | (g/l) | 2.5 | 10.0 | 14.1 | 56.4 | 40.8 | 63.8 | |
| | S-10/S-15 | | | | | | | |
| | VAPS(nm) | 48 | 51 | 49 | 56 | 45 | 60 | |
| | Polymer | P-3 70 | P-3 30 | P-3 70 | P-3 35 | P-3 35 | P-3 35 | |
| | Latex (g/l) | | | | | | | |

Note:
In the preceding table, HBPOS = High-boiling Point Organic Solvent and VAPS = Volume Average Particulate Size.

TABLE 14
Ink Sets 109-116

| Ink | | Light | Magenta | Light | | | | |
|---|---|---|---|---|---|---|---|---|
| Set | | Magenta Ink | Ink | Cyan Ink | Cyan Ink | Yellow Ink | Black Ink | Remarks |
| 109 | Dye (g/l) | M-6 5.0 | M-6 20.0 | C-1 9.3 | C-1 37.2 | Y-1 27.2 | M-6 10.0 | Present |
| | | | | | | | C-1 18.6 | Invention |
| | | | | | | | Y-1 13.6 | |
| | HBPOS | 7.5/ | 30.0/ | 4.7/ | 18.8/ | 13.6/ | 21.3/ | |
| | (g/l) | 2.5 | 10.0 | 14.1 | 56.4 | 40.8 | 63.8 | |
| | S-10/S-15 | | | | | | | |
| | VAPS | 48 | 51 | 49 | 56 | 45 | 60 | |
| | (nm) | | | | | | | |
| | Polymer | P-24 50 | P-24 25 | P-24 50 | P-24 25 | P-24 25 | P-24 25 | |
| | Latex (g/l) | | | | | | | |
| 110 | Dye (g/l) | MM-2 3.6 | MM-2 14.4 | CC-2 17.4 | CC-2 69.6 | YY-2 26.5 | MM-2 6.5 | Comp. |
| | | | | | | | CC-2 34.8 | Example |
| | | | | | | | YY-2 13.3 | |
| | HBPOS | 2.6/ | 10.5/ | 12.6/ | 50.5/ | 19.2/ | 39.6/ | |
| | (g/l) | 4.6 | 18.1 | 22.1 | 88.7 | 33.7 | 69.6 | |
| | S-2/S-11 | | | | | | | |
| | VAPS | 43 | 48 | 53 | 56 | 47 | 61 | |
| | (nm) | | | | | | | |
| 111 | Dye (g/l) | MM-2 3.6 | MM-2 14.4 | CC-2 17.4 | CC-2 69.6 | YY-2 26.5 | MM-2 6.5 | Present |
| | | | | | | | CC-2 34.8 | Invention |
| | | | | | | | YY-2 13.3 | |
| | HBPOS | 2.6/ | 10.5/ | 12.6/ | 50.5/ | 19.2/ | 39.6/ | |
| | (g/l) | 4.6 | 18.1 | 22.1 | 88.7 | 33.7 | 69.6 | |
| | S-2/S-11 | | | | | | | |
| | VAPS | 43 | 48 | 53 | 56 | 47 | 61 | |
| | (nm) | | | | | | | |
| | Polymer | P-2 50 | P-2 25 | P-2 50 | P-2 25 | P-2 25 | P-2 25 | |
| | Latex (g/l) | | | | | | | |
| 112 | Dye (g/l) | MM-2 3.6 | MM-2 14.4 | CC-2 17.4 | CC-2 69.6 | YY-2 26.5 | MM-2 6.5 | Present |
| | | | | | | | CC-2 34.8 | Invention |
| | | | | | | | YY-2 13.3 | |
| | HBPOS | 2.6/ | 10.5/ | 12.6/ | 50.5/ | 19.2/ | 39.6/ | |
| | (g/l) | 4.6 | 18.1 | 22.1 | 88.7 | 33.7 | 69.6 | |
| | S-2/S-11 | | | | | | | |
| | VAPS | 43 | 48 | 53 | 56 | 47 | 61 | |
| | (nm) | | | | | | | |
| | Polymer | P-3 25 | P-3 12.5 | P-3 25 | P-3 12.5 | P-3 12.5 | P-3 12.5 | |
| | Latex (g/l) | P-30 25 | P-30 12.5 | P-30 25 | P-30 12.5 | P-30 12.5 | P-30 12.5 | |
| 113 | Dye (g/l) | MM-3 3.6 | MM-3 14.4 | CC-3 17.4 | CC-3 69.6 | YY-2 26.5 | MM-3 6.5 | Comp. |
| | | | | | | | CC-3 34.8 | Example |
| | | | | | | | YY-2 13.3 | |
| | HBPOS | 2.9/ | 11.5/ | 13.9/ | 55.7/ | 21.2/ | 43.5/ | |
| | (g/l) | 4.3 | 17.3 | 20.9 | 83.5 | 31.8 | 65.5 | |
| | S-9/S-24 | | | | | | | |
| | VAPS | 42 | 45 | 50 | 58 | 47 | 62 | |
| | (nm) | | | | | | | |
| 114 | Dye (g/l) | MM-3 3.6 | MM-3 14.4 | CC-3 17.4 | CC-3 69.6 | YY-2 26.5 | MM-3 6.5 | Present |
| | | | | | | | CC-3 34.8 | Invention |
| | | | | | | | YY-2 13.3 | |
| | HBPOS | 2.9/ | 11.5/ | 13.9/ | 55.7/ | 21.2/ | 43.5/ | |
| | (g/l) | 4.3 | 17.3 | 20.9 | 83.5 | 31.8 | 65.5 | |
| | VAPS | 42 | 45 | 50 | 58 | 47 | 62 | |
| | (nm) | | | | | | | |
| | Polymer | P-3 50 | P-3 50 | P-3 50 | P-3 50 | P-3 50 | P-3 50 | |
| | Latex (g/l) | | | | | | | |
| 115 | Dye (g/l) | MM-3 3.6 | MM-3 14.4 | CC-3 17.4 | CC-3 69.6 | YY-2 26.5 | MM-3 6.5 | Present |
| | | | | | | | CC-3 34.8 | Invention |
| | | | | | | | YY-2 13.3 | |
| | HBPOS | 2.9/ | 11.5/ | 13.9/ | 55.7/ | 21.2/ | 43.5/ | |
| | (g/l) | 4.3 | 17.3 | 20.9 | 83.5 | 31.8 | 65.5 | |
| | S-9/S-24 | | | | | | | |
| | VAPS | 42 | 45 | 50 | 58 | 47 | 62 | |
| | (nm) | | | | | | | |
| | Polymer | P-17 80 | P-17 40 | P-17 80 | P-17 40 | P-17 40 | P-17 40 | |
| | Latex (g/l) | | | | | | | |
| 116 | Dye (g/l) | MM-3 3.6 | MM-3 14.4 | CC-3 17.4 | CC-3 69.6 | YY-2 26.5 | MM-3 6.5 | Present |
| | | | | | | | CC-3 34.8 | Invention |
| | | | | | | | YY-2 13.3 | |
| | HBPOS | 2.9/ | 11.5/ | 13.9/ | 55.7/ | 21.2/ | 43.5/ | |
| | (g/l) | 4.3 | 17.3 | 20.9 | 83.5 | 31.8 | 65.5 | |
| | S-9/S-24 | | | | | | | |
| | VAPS | 42 | 45 | 50 | 58 | 47 | 62 | |
| | (nm) | | | | | | | |
| | Polymer | P-32 50 | P-32 25 | P-32 50 | P-32 25 | P-32 25 | P-32 25 | |
| | Latex (g/l) | | | | | | | |

Note:
In the preceding table, HBPOS = High-boiling Point Organic Solvent and VAPS = Volume Average Particulate Size.

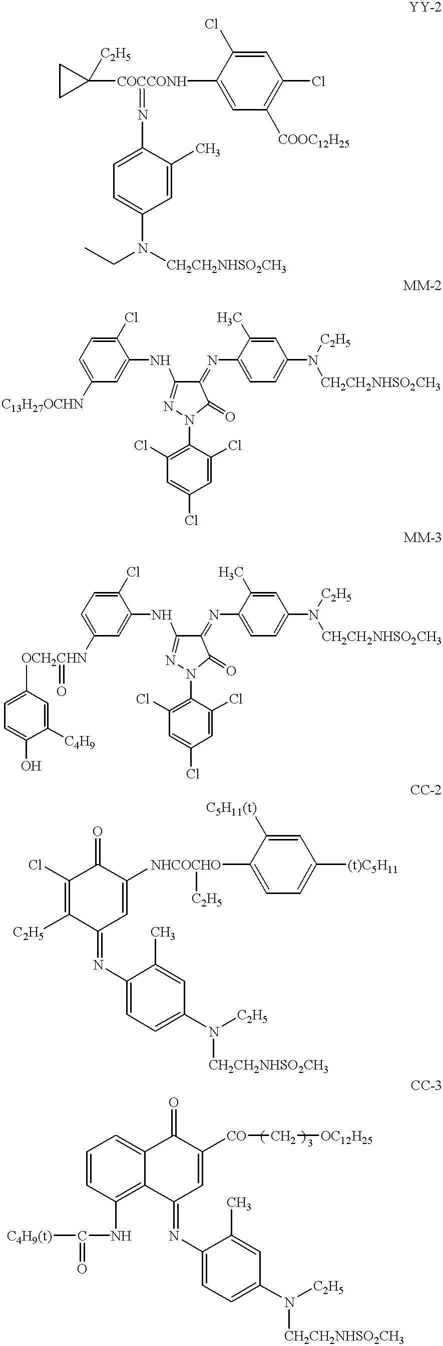 TABLE 15
Ink Set 117

| | Light | | Light Cyan | | | |
|---|---|---|---|---|---|---|
| | Magenta Ink | Magenta Ink | Ink | Cyan Ink | Yellow Ink | Black Ink |
| Dye (g/l) | A-1 7.0 | A-1 28.0 | A-2 8.75 | A-2 35.0 | A-3 14.7 | A-5 20.0 |
| | | | | | A-4 14.0 | A-6 20.0 |
| | | | | | | A-7 20.0 |
| | | | | | | A-3 21.0 |
| Diethylene | 150 | 110 | 130 | 200 | 160 | 20.0 |
| Glycol (g/l) | | | | | | |
| Urea (g/l) | 37 | 46 | — | — | — | — |
| Glycerin | 130 | 130 | 150 | 180 | 150 | 120 |
| (g/l) | | | | | | |
| Triethylene | 130 | 140 | 130 | 140 | 130 | — |
| Glycol | | | | | | |
| Monobutyl | | | | | | |
| Ether (g/l) | | | | | | |
| Diethylene | — | — | — | — | — | 230 |
| Glycol | | | | | | |
| Monobutyl | | | | | | |
| Ether (g/l) | | | | | | |
| 2- | — | — | — | — | — | 80 |
| Pyrrolidone | | | | | | |
| (g/l) | | | | | | |
| SURFYNOL | 10.5 | 11.5 | 11.1 | 9.8 | — | — |
| 465 (g/l) | | | | | | |
| SURFYNOL | — | — | — | — | 9.0 | 8.5 |
| TG (g/l) | | | | | | |
| Triethanol- | 6.9 | 7.4 | 6.8 | 6.7 | 0.8 | 17.9 |
| amine (g/l) | | | | | | |
| Benzo- | 0.08 | 0.07 | 0.08 | 0.08 | 0.06 | 0.06 |
| triazole | | | | | | |
| (g/l) | | | | | | |
| Proxel XL2 | 3.5 | 2.5 | 1.8 | 2.0 | 2.5 | 1.8 |
| (g/l) | | | | | | |

Deionized water added to produce 1 liter.

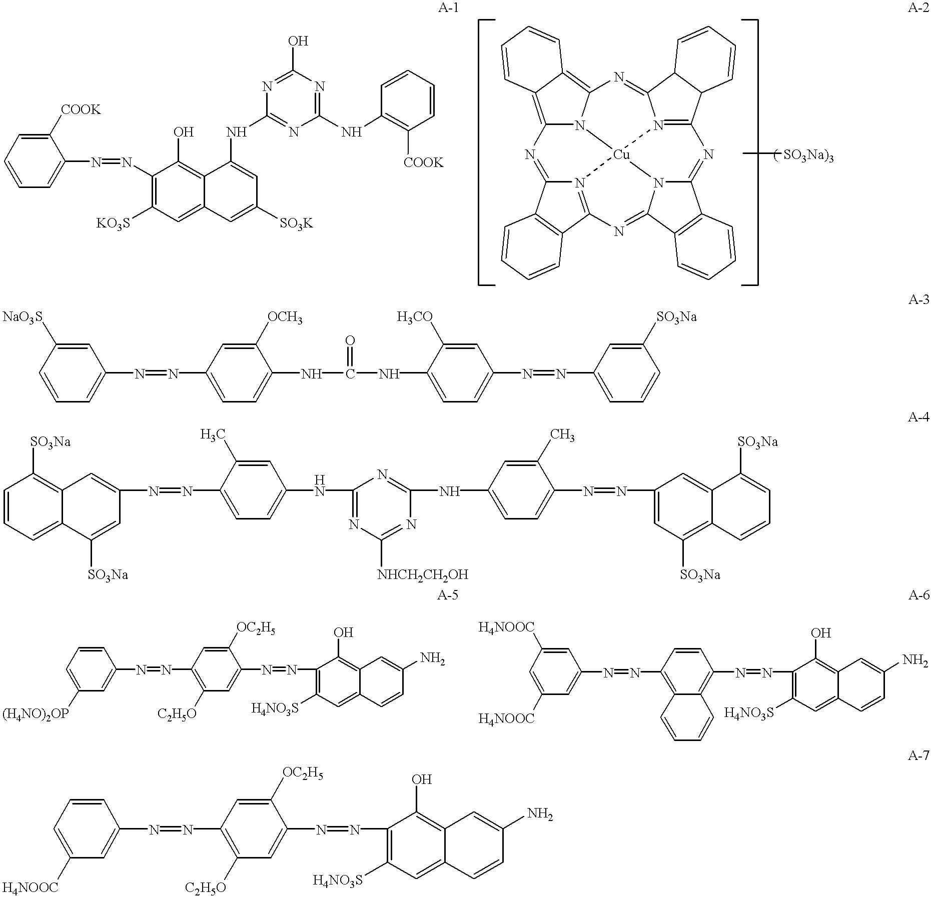

Image Recording and Evaluation

Next, the produced Ink Sets 101 to 117 were filled into a cartridge of an ink jet printer, PM670C (manufactured by EPSON), images were printed on ink jet paper, photo gloss paper EX manufactured by Fuji Photo Film Co., Ltd., using the same machine, and the following evaluations were conducted.

Evaluation of printing ability (1)

The cartridge was set in the printer, discharge of ink from all nozzles was confirmed, and then images were output on 20 pieces of

A4 paper and disturbance of printing was evaluated according to the following standards.

A: No disturbance from initiation to completion of printing.

B: Some disturbances occurred at some times from initiation to completion of printing.

C: Disturbances occurred from initiation to completion of printing.

Evaluation of printing ability (2)

The cartridge was left at room temperature to 60° C. for 3 days, and then disturbance of printing was evaluated according to the same standards as in Evaluation of printing ability (1).

Evaluation of drying property

Images were printed in the same manner as described above and, immediately, the image parts were touched with a finger; generated staining was evaluated visually. Excellent drying property was indicated by an “O”, and poor drying property was indicated by an “X”.

Evaluation of Blotting of Narrow Lines

Evaluation of blotting of narrow lines (1) was conducted by printing narrow line patterns of yellow, magenta, cyan and black were printed and evaluating the results visually. For black, a magenta ink was printed in solid condition, then, black narrow lines were printed, and blotting by contact of the two colors was evaluated for Evaluation of blotting of narrow lines (2). No occurrence of blotting was indicated by an “O”, and occurrence of blotting was indicated by an “X”.

Water resistance

Obtained images were immersed in deionized water for 10 seconds, then blotting generated on image parts was evaluated visually. No occurrence of blotting was indicated by an “O”, and occurrence of blotting was indicated by an “X”.

Image fastness

Print samples of Yellow (Y), Magenta (M), Cyan (C) and Black (BK) were produced, and dark heat storability, i.e., color residual ratio (%), was measured and evaluated.

Under conditions of 10% RH and 80° C., concentration ratio prior to and after storage of samples for fourteen days was determined by the following equation as color residual ratio (%).

color residual ratio (%)=(80°−10% RH concentration after fourteen days)/concentration directly after printing×100

The evaluation was conducted in four stages by designating cases in which the color residual ratio was 80%-100% as A, designating cases in which the color residual ratio was 60%-80% as B, designating cases in which the color residual ratio was 40%-60% as C, and designating cases in which the color residual ratio was below 40% as D.

The results of the evaluations are shown in Tables 16 and 17.

TABLE 16

| | | | | Blotting | Blotting | | |
|---|---|---|---|---|---|---|---|
| | Printing | Printing | | of | of | | |
| | Ability | Ability | Drying | Narrow | Narrow | Water | |
| Ink Set | (1) | (2) | Property | Lines (1) | Lines (2) | Resistance | Remarks |
| 101 | A | A | ◯ | ◯ | ◯ | ◯ | Comp. Example |
| 102 | A | A | ◯ | ◯ | ◯ | ◯ | Present Invention |
| 103 | A | A | ◯ | ◯ | ◯ | ◯ | Present Invention |
| 104 | A | A | ◯ | ◯ | ◯ | ◯ | Present Invention |
| 105 | A | A | ◯ | ◯ | ◯ | ◯ | Present Invention |
| 106 | A | B | ◯ | ◯ | ◯ | ◯ | Comp. Example |
| 107 | A | A | ◯ | ◯ | ◯ | ◯ | Present Invention |
| 108 | A | A | ◯ | ◯ | ◯ | ◯ | Present Invention |
| 109 | A | A | ◯ | ◯ | ◯ | ◯ | Present Invention |
| 110 | A | B | ◯ | ◯ | ◯ | ◯ | Comp. Example |
| 111 | A | A | ◯ | ◯ | ◯ | ◯ | Present Invention |
| 112 | A | A | ◯ | ◯ | ◯ | ◯ | Present Invention |
| 113 | A | B | ◯ | ◯ | ◯ | ◯ | Comp. Example |
| 114 | A | A | ◯ | ◯ | ◯ | ◯ | Present Invention |
| 115 | A | A | ◯ | ◯ | ◯ | ◯ | Present Invention |
| 116 | A | A | ◯ | ◯ | ◯ | ◯ | Present Invention |
| 117 | A | A | X | X | X | X | Comp. Example |

TABLE 17

| Ink | Light Fastness | | | | |
|---|---|---|---|---|---|
| Set | Y | M | C | BK | Remarks |
| 101 | C | C | C | C | Comp. Example |
| 102 | B | B | B | B | Present Invention |
| 103 | B | B | B | B | Present Invention |
| 104 | B | B | B | B | Present Invention |
| 105 | B | B | B | B | Present Invention |
| 106 | B | B | B | B | Comp. Example |
| 107 | A | A | A | A | Present Invention |
| 108 | A | A | A | A | Present Invention |
| 109 | A | A | A | A | Present Invention |
| 110 | C | D | D | D | Comp. Example |
| 111 | B | C | C | C | Present Invention |
| 112 | B | C | C | C | Present Invention |
| 113 | C | D | D | D | Comp. Example |
| 114 | B | C | C | C | Present Invention |
| 115 | B | C | C | C | Present Invention |
| 116 | B | C | C | C | Present Invention |
| 117 | B | C | C | B | Comp. Example |

### Example 2

The same inks produced in Example 1 were filled into a cartridge of an ink jet printer, BJ-F850 (manufactured by CANON), images were printed on ink jet paper, photo gloss paper EX, manufactured by Fuji Photo Film Co., Ltd., using the same machine, and the same evaluations as in Example 1 were conducted. Results the same as those in Example 1 were obtained.

As is clear from the evaluation results of Examples 1 and 2, the ink sets using the ink for ink jet recording of the present invention had excellent printing ability, drying ability and water resistance, and performance when outputting narrow lines was also excellent in that there was no blotting. Further, improved effects of image fastness were also remarkable. Namely, when the ink for ink jet of the present invention is spit out onto image-receiving material, there is a difference in retainability at the image-receiving material between the oil droplets and the polymer latex. It is thought that, because the polymer latex has the effect of cutting contact between the oil-soluble dyes and the outside, resistance to color fading of the oil-soluble dyes is improved and image sturdiness is raised.

### Example 3

Fabrication of Ink Set 201

The same method of fabrication as that used for the ink set 101 in Example 1 was used, except that infrared absorbants UV1-UV5 were not used, to produce a magenta ink, a light cyan ink, a cyan ink, a yellow ink, and a black ink shown in comparative ink set 101 in Table 18.

TABLE 18
Ink Set 201

| | Light | | | | | |
|---|---|---|---|---|---|---|
| | Magenta Ink | Magenta Ink | Light Cyan Ink | Cyan Ink | Yellow Ink | Black Ink |
| Dye (g/l) | M-6 5.00 | M-6 20.0 | C-1 9.3 | C-1 37.2 | Y-1 27.2 | M-6 10.0 |
| | | | | | | C-1 18.6 |
| | | | | | | Y-1 13.6 |
| High-boiling | S-1 3.8 | S-1 15.0 | S-1 7.0 | S-1 27.9 | S-1 20.4 | S-1 31.7 |
| Point | | | | | | |
| Organic | S-2 6.3 | S-2 25.0 | S-2 11.8 | S-2 47.0 | S-2 34.0 | S-2 53.3 |
| Solvent (g/l) | | | | | | |
| Dioctyl | 3.13 | 12.5 | 5.8 | 23.3 | 17.0 | 26.4 |
| Sodium | | | | | | |
| Sulfosucci- | | | | | | |
| nate (g/l) | | | | | | |
| Diethylene | 100.0 | 100.0 | 100.0 | 100.0 | 100.0 | 100.0 |
| Glycol(g/l) | | | | | | |
| Urea (g/l) | 46.0 | 46.0 | 46.0 | 46.0 | 46.0 | 46.0 |
| Glycerin | 40.0 | 40.0 | 40.0 | 40.0 | 40.0 | 40.0 |
| (g/l) | | | | | | |
| SURFYNOL | 5.5 | 5.5 | 5.5 | 5.5 | 5.5 | 5.5 |
| 465 (g/l) | | | | | | |
| Triethanol- | 7.5 | 7.5 | 7.5 | 7.5 | 7.5 | 7.5 |
| amine (g/l) | | | | | | |
| Benzo- | 0.075 | 0.075 | 0.075 | 0.075 | 0.075 | 0.075 |
| triazole (g/l) | | | | | | |
| Proxel XL2 | 2.5 | 2.5 | 2.5 | 2.5 | 2.5 | 2.5 |
| (g/l) | | | | | | |
| Deionized water | | | | | | |
| added to make | | | | | | |
| one liter. | | | | | | |
| Volume | 42 | 48 | 51 | 50 | 43 | 58 |
| Average | | | | | | |
| Particulate | | | | | | |
| Size (nm) | | | | | | |

Production of Ink Set 202

Dye types to be used in ink set 201 were changed as indicated in Table 19 to produce comparative ink set 202.

Production of Ink Sets 203-205

The same method of producing ink set 202 was used, except that after deionized water was added, the polymer latex of the present invention was added as indicated in Table 19 to produce ink sets 203-205 of the present invention. (It should be noted that the total liquid amount of the deionized water added and the polymer latex was kept constant. Also, the mass of the polymer latex indicated in Table 19 represents polymer solid components in 1 liter of ink.

Production of Ink Sets 206-209

Next, comparative ink set 206 was produced in the same manner as ink set 202, except that the types of dyes and high-boiling point organic solvent and amounts for ink set 202 were changed.

Further, ink sets 207-209 of the present invention corresponding to comparative ink set 206 were produced by the same method as used for ink sets 203-205, and the polymer latex of the present invention indicated in Table 19 was used.

It should be noted that ink set 117 of Table 15 was used as it is as the comparative ink set using the oil-soluble dye.

TABLE 19
Ink Sets 201-209

| | | Light | | | | | | |
|---|---|---|---|---|---|---|---|---|
| | | magenta | Magenta | Light Cyan | | | | |
| Ink Set | | Ink | Ink | Ink | Cyan Ink | Yellow Ink | Black Ink | Remarks |
| 201 | Dye (g/l) | M-6 5.0 | M-6 20.0 | C-1 9.3 | C-1 37.2 | Y-1 27.2 | M-6 10.0 | Comp. |
| | | | | | | | C-1 18.6 | Example |
| | | | | | | | Y-1 13.6 | |
| | HBPOS | 3.8/ | 15.0/ | 7.0/ | 27.9/ | 20.4/ | 31.7/ | |
| | (g/l) | 6.3 | 25.0 | 11.8 | 47.0 | 34.0 | 533 | |
| | S-2/S-11 | | | | | | | |
| | VAPS(nm) | 42 | 48 | 51 | 50 | 43 | 58 | |
| 202 | Dye (g/l) | a-17 5.0 | a-17 20.0 | C-114 10.5 | C-114 42.0 | Y-1 27.2 | a-17 10.0 | Comp. |
| | | | | | | | C-114 21.0 | Example |
| | | | | | | | Y-1 13.6 | |
| | HBPOS | 3 8/ | 15.0/ | 7.0/ | 27.9/ | 20.4/ | 31.7/ | |
| | (g/l) | 6.3 | 25.0 | 11.8 | 47.0 | 34.0 | 53.3 | |
| | S-2/S-11 | | | | | | | |
| | VAPS(nm) | 40 | 49 | 45 | 53 | 43 | 58 | |
| 203 | Dye (g/l) | a-17 5.0 | a-17 20.0 | C-114 10.5 | C-114 42.0 | Y-1 27.2 | a-17 10.0 | Present |
| | | | | | | | C-114 21.0 | Invention |
| | | | | | | | Y-1 13.6 | |
| | HBPOS | 3.8/ | 15.0/ | 7.0/ | 27.9/ | 20.4/ | 31.7/ | |
| | (g/l) | 6.3 | 25.0 | 11.8 | 47.0 | 34.0 | 53.3 | |
| | S-2/S-11 | | | | | | | |
| | VAPS(nm) | 40 | 49 | 45 | 53 | 43 | 58 | |
| | Polymer | P-3 50 | P-3 25 | P-3 50 | P-3 25 | P-3 25 | P-3 25 | |
| | Latex (g/l) | | | | | | | |
| 204 | Dye (g/l) | a-17 5.0 | a-17 20.0 | C-114 10.5 | C-114 42.0 | Y-1 27.2 | a-17 10.0 | Present |
| | | | | | | | C-114 21.0 | Invention |
| | | | | | | | Y-1 13.6 | |
| | HBPOS | 3.8/ | 15.0/ | 7.0/ | 27.9/ | 20.4/ | 31.7/ | |
| | S-2/S-11 | 6.3 | 25.0 | 11.8 | 47.0 | 34.0 | 53.3 | |
| | VAPS(nm) | 40 | 49 | 45 | 53 | 43 | 58 | |
| | Polymer | P-13 50 | P-13 25 | P-13 50 | P-13 25 | P-13 25 | P-13 25 | |
| | Latex (g/l) | | | | | | | |
| 205 | Dye (g/l) | a-17 5.0 | a-17 20.0 | C-114 10.5 | C-114 42.0 | Y-1 27.2 | a-17 10.0 | Present |
| | | | | | | | C-114 21.0 | Invention |
| | | | | | | | Y-1 13.6 | |
| | HBPOS | 3.8/ | 15.0/ | 7.0/ | 27.9/ | 20.4/ | 31.7/ | |
| | (g/l) | 6.3 | 25.0 | 11.8 | 47.0 | 34.0 | 53.3 | |
| | S-2/S-11 | | | | | | | |
| | VAPS(nm) | 40 | 49 | 45 | 53 | 43 | 58 | |
| | Polymer | P-20 50 | P-20 25 | P-20 50 | P-20 25 | P-20 25 | P-20 25 | |
| | Latex (g/l) | | | | | | | |
| 206 | Dye (g/l) | a-3 5.0 | a-3 20.0 | C-105 9.8 | C-105 37.2 | Y-1 27.2 | a-3 10.0 | Comp. |
| | | | | | | | C-105 18.6 | Example |
| | | | | | | | Y-1 13.6 | |
| | HBPOS | 7.5/ | 30.0/ | 4.7/ | 18.8/ | 13.6/ | 21.8/ | |
| | (g/l) | 2.5 | 10.0 | 14.1 | 56.4 | 40.8 | 63.8 | |
| | S-10/S-15 | | | | | | | |
| | VAPS(nm) | 42 | 46 | 44 | 51 | 42 | 59 | |
| 207 | Dye (g/l) | a-3 5.0 | a-3 20.0 | C-105 9.3 | C-105 37.2 | Y-1 27.2 | a-3 10.0 | Present |
| | | | | | | | C-105 18.6 | Invention |
| | | | | | | | Y-1 13.6 | |
| | HBPOS | 7.5/ | 30.0/ | 4.7/ | 18.8/ | 13.6/ | 21.8/ | |
| | (g/l) | 2.5 | 10.0 | 14.1 | 56.4 | 40.8 | 63.8 | |
| | S-10/S-15 | | | | | | | |
| | VAPS(nm) | 42 | 46 | 44 | 51 | 42 | S9 | |
| | Polymer | P-2 20 | P-2 10 | P-2 20 | P-2 10 | P-2 10 | P-2 10 | |
| | Latex (g/l) | P-4 30 | P-4 15 | P-4 30 | P-4 15 | P-4 15 | P-4 15 | |
| 208 | Dye (g/l) | a-3 5.0 | a-3 20.0 | C-105 9.3 | C-105 37.2 | Y-1 27.2 | a-3 10.0 | Present |
| | | | | | | | C-105 18.6 | Invention |
| | | | | | | | Y-1 13.6 | |
| | HBPOS | 7.5/ | 30.0/ | 4.7/ | 18.8/ | 13.6/ | 21.8/ | |
| | (g/l) | 2.5 | 10.0 | 14.1 | 56.4 | 40.8 | 63.8 | |
| | S-10/S-15 | | | | | | | |
| | VAPS(nm) | 42 | 46 | 44 | 51 | 42 | 59 | |
| | Polymer | P-19 70 | P-19 30 | P-19 70 | P-19 35 | P-19 35 | P-19 35 | |
| | Latex (g/l) | | | | | | | |
| 209 | Dye (g/l) | a-3 5.0 | a-3 20.0 | C-105 9.3 | C-105 37.2 | Y-1 27.2 | a-3 10.0 | Present |
| | | | | | | | C-105 18.6 | Invention |
| | | | | | | | Y-1 13.6 | |
| | HBPOS | 7.5/ | 30.0/ | 4.7/ | 18.8/ | 13.6/ | 21.8/ | |
| | (g/l) | 2.5 | 10.0 | 14.1 | 56.4 | 40.8 | 63.8 | |
| | S-10/S-15 | | | | | | | |
| | VAPS(nm) | 42 | 46 | 44 | 51 | 42 | 59 | |
| | Polymer | P-28 50 | P-28 25 | P-28 50 | P-28 25 | P-28 25 | P-28 25 | |
| | Latex (g/l) | | | | | | | |

Image Recording and Evaluation

Next, the produced ink sets 201 -209 and 117 were, as in Example 1, filled into a cartridge of an ink jet printer, PM670C (manufactured by EPSON), images were printed on ink jet paper, photo gloss paper EX manufactured by Fuji Photo Film Co., Ltd., using the same machine, and the following evaluations were conducted. Printing ability, drying property and blotting of narrow lines were evaluated under the same conditions and evaluation criteria as in Example 1.

Image fastness

Print samples of Yellow (Y), Magenta (M), Cyan (C) and Black (BK) were produced, and image fastness was evaluated as below.

(1) Dark heat storability was determined by measuring image concentration Ci directly after printing, thereafter storing the samples for 14 days under conditions of 15% RH and 80° C., and again measuring image concentration Cf to determine color residual ratio.

(2) Ozone resistance was determined by storing the sample for 14 days under conditions of ozone concentration 0.5 ppm, and measuring concentration ratio prior to storage in the same manner as that for the preceding dark heat storability to determine color residual ratio.

The results of each measurement of ozone resistance were evaluated in the following five grades according to the numerical value of the color residual ratio: 80%-100% was A, 60%-80% was B, 40%-60% was C, and below 40% was D.

The results of the evaluations are shown in Tables 20 and 21.

TABLE 20

| | | | | Blotting | Blotting | | |
|---|---|---|---|---|---|---|---|
| | Printing | Printing | | of | of | | |
| | Ability | Ability | Drying | Narrow | Narrow | Water | |
| Ink Set | (1) | (2) | Property | Lines (1) | Lines (2) | Resistance | Remarks |
| 201 | A | B | ◯ | ◯ | ◯ | ◯ | Comp. Example |
| 202 | A | B | ◯ | ◯ | ◯ | ◯ | Comp. Example |
| 203 | A | A | ◯ | ◯ | ◯ | ◯ | Present Invention |
| 204 | A | A | ◯ | ◯ | ◯ | ◯ | Present Invention |
| 205 | A | A | ◯ | ◯ | ◯ | ◯ | Present Invention |
| 206 | A | B | ◯ | ◯ | ◯ | ◯ | Comp. Example |
| 207 | A | A | ◯ | ◯ | ◯ | ◯ | Present Invention |
| 208 | A | A | ◯ | ◯ | ◯ | ◯ | Present Invention |
| 209 | A | A | ◯ | ◯ | ◯ | ◯ | Present Invention |
| 117 | A | A | X | X | X | X | Comp. Example |

TABLE 21

| | Color Residual Ratio (%) | | | | | | | | |
|---|---|---|---|---|---|---|---|---|---|
| | Yellow | | Magenta | | Cyan | | Black | | |
| Ink | Dark | | Dark | | Dark | | Dark | | |
| Set | Heat | Ozone | Heat | Ozone | Heat | Ozone | Heat | Ozone | Remarks |
| 201 | D | C | D | D | D | C | D | C | Comp. Example |
| 202 | D | C | B | B | B | B | D | C | Comp. Example |
| 203 | B | B | A | A | A | A | B | B | Present Invention |
| 204 | B | B | A | A | A | A | B | B | Present Invention |
| 205 | B | B | A | A | A | A | B | B | Present Invention |
| 206 | C | C | B | B | B | B | C | C | Comp. Example |
| 207 | A | A | A | A | A | A | A | A | Present Invention |
| 208 | A | A | A | A | A | A | A | A | Present Invention |
| 209 | A | A | A | A | A | A | A | A | Present Invention |
| 117 | C | C | D | D | D | D | C | C | Comp. Example |

When the ink of the present invention is used, excellent printing ability and water resistance is obtained, and improved effects of image fastness are remarkable. Further, in the ink composition of the present invention, performance at the time of output of narrow lines is also excellent with no blotting thereof.

### Example 4

The same inks produced in Example 3 were filled into a cartridge of an ink jet printer, BJ-F850 (manufactured by CANON), images were printed on ink jet paper, photo gloss paper EX, manufactured by Fuji Photo Film Co., Ltd., using the same machine, and the same evaluations as in Example 3 were conducted. Results the same as those in Example 3 were obtained.

According to the present invention, there can be provided: a coloring composition having no paper-dependency, having excellent color developability and hue when printed on optionally selected paper, having excellent ink permeability with respect to paper for photographic image quality, leaving no stains directly after printing, having excellent water resistance and image fastness, enabling high recording concentration and high image quality, and which is suitable for water-based ink for writing, water-based printing ink, information recording ink and the like; ink jet ink including the coloring composition, the ink for ink jet recording being suitable for thermal, piezoelectric or electric field or acoustic ink jet methods, having no paper dependency, having excellent color developability and hue when printed on optionally selected paper, having excellent ink permeability with respect to paper for photographic image quality, leaving no stains directly after printing, and having excellent water resistance and image fastness; and an ink jet recording method that uses the ink for ink jet recording and with which recording of high image quality is possible.

What is claimed is:

1. An ink for ink jet recording, the ink comprising:
coloring particulate dispersion, the dispersion including particulate composed of at least an oil-soluble dye and a hydrophobic organic solvent, with the hydrophobic organic solvent having a high-boiling point of at least 150° C.; and
polymer latex.

2. The ink for ink jet recording of claim 1, wherein the polymer latex includes on a main chain or side chain thereof an ethylenically unsaturated group.

3. The ink for ink jet recording of claim 1, wherein the polymer latex comprises a monomer chosen from: olefins; α, β-unsaturated carboxylic acids and salts thereof; esters of α, β-unsaturated carboxylic acids; amides of α, β-unsaturated carboxylic acids; styrenes and derivatives thereof; vinyl ethers; and vinyl esters.

4. The ink for ink jet recording of claim 1, wherein the oil-soluble dye is represented by following general formula (I): 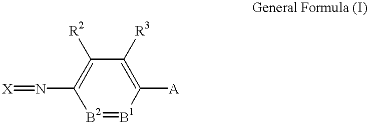
wherein, X represents the residue of a color coupler;
A represents one of —NR⁴R⁵ and a hydroxyl group;
R⁴ and R⁵ each independently represents one of a hydrogen atom, an aliphatic group, an aromatic group, and a heterocyclic group;
B¹ represents one of ═C(R⁶)— and ═N—;
B² represents one of —C(R⁷)═ and —N═;
R², R³, R⁶, and R⁷ each independently represents one of a hydrogen atom, a halogen atom, an aliphatic group, an aromatic group, a heterocyclic group, a cyano group, —OR⁵¹, —SR⁵², —CO₂R⁵³, —OCOR⁵⁴, —NR⁵⁵R⁵⁶, —CONR⁵⁷R⁵⁸, —SO₂R⁵⁹, —SO₂NR⁶⁰R⁶¹, —NR⁶²CONR⁶³R⁶⁴, —NR⁶⁵CO₂R⁶⁶, —COR⁶⁷, —NR⁶⁸COR⁶⁹, and —NR⁷⁰SO₂R⁷¹;
R⁵¹, R⁵², R⁵³, R⁵⁴, R⁵⁵, R⁵⁶, R⁵⁷, R⁵⁸, R⁵⁹, R⁶⁰, R⁶¹, R⁶², R⁶³, R⁶⁴, R⁶⁵, R⁶⁶, R⁶⁷, R⁶⁸, R⁶⁹, R⁷⁰, and R⁷¹ each independently represents one of a hydrogen atom, an aliphatic group, and an aromatic group; and
Any of R² and R³, R³ and R⁴, R⁴ and R⁵, R⁵ and R⁶, and R⁶ and R⁷ may be combined with each other to form rings.

5. The ink for ink jet recording of claim 4, wherein the oil-soluble dye represented by said general formula (I) is a compound represented by following general formula (II): 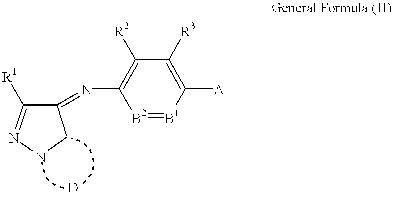
wherein, R², R³, A, B¹, and B² are synonymous with R², R³, A, B¹, and B² in said general formula (I);
R¹ represents one of a hydrogen atom, an aliphatic group, an aromatic group, a heterocyclic group, a cyano group, —OR¹¹, —SR¹², —CO₂R¹³, —OCOR¹⁴, —NR¹⁵R¹⁶, —CONR¹⁷R¹⁸, —SO₂R¹⁹, —SO₂NR²⁰R²¹, —NR²²CONR²³R²⁴, —NR²⁵CO₂R²⁶, —COR²⁷, —NR²⁸COR²⁹, and —NR³⁰SO₂R³¹;
R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸, R²⁹, R³⁰, and R³¹ each independently represents one of a hydrogen atom, an aliphatic group, and an aromatic group;
D represents an atom group that forms one of a five-membered nitrogen-containing heterocyclic ring and a six-membered nitrogen-containing heterocyclic ring which may be substituted for at least one of an aliphatic group, an aromatic group, a heterocyclic group, a cyano group, —OR⁸¹, —SR⁸², —CO₂R⁸³, —OCOR⁸⁴, —NR⁸⁵R⁸⁶, —CONR⁸⁷R⁸⁸, —SO₂R⁸⁹, SO₂NR⁹⁰R⁹¹, —NR⁹²CONR⁹³R⁹⁴, —NR⁹⁵CO₂R⁹⁶, —COR⁹⁷, —NR⁹⁸COR⁹⁹, and —NR¹⁰⁰SO₂R¹⁰¹;
the heterocyclic ring may further form a fused ring with another ring; and
R⁸¹, R⁸², R⁸³, R⁸⁴, R⁸⁵, R⁸⁶, R⁸⁷, R⁸⁸, R⁸⁹, R⁹⁰, R⁹¹, R⁹², R⁹³, R⁹⁴, R⁹⁵, R⁹⁶, R⁹⁷, R⁹⁸, R⁹⁹, R¹⁰⁰, and R¹⁰¹ each independently represents one of a hydrogen atom, an aliphatic group, and an aromatic group.

6. The ink for ink jet recording of claim 5, wherein the compound represented by said general formula (II) is a compound represented by following general formula (III): 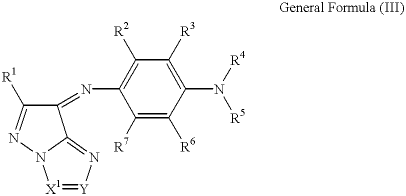
wherein, R¹, R², R³, R⁴, R⁵, R⁶, and R⁷ are synonymous with R¹, R², R³, R⁴, R⁵, R⁶, and R⁷ in said general formula (II);
X¹ and Y each independently represents one of —C(R⁸)═ and —N═;
R⁸ represents one of a hydrogen atom, an aliphatic group, and an aromatic group; and
one of X¹ and Y is always —N═, and X¹ and Y do not simultaneously represent —N═.

7. The ink for ink jet recording of claim 4, wherein the oil-soluble dye represented by said general formula (I) is at least one of compounds represented by following general formulae (IV-1) to (IV-4): 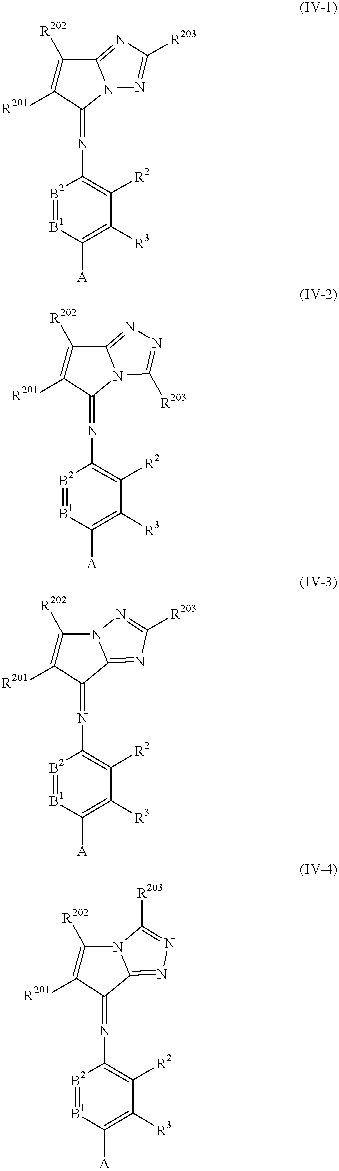
wherein, A, R², R³, B¹, and B² are synonymous with A, R², R³, B¹, and B² in said general formula (I);
R²⁰¹, R²⁰², and R²⁰³ each independently represents one of a hydrogen atom, an aliphatic group, an aromatic group, a heterocyclic group, a cyano group, —OR¹¹, —SR¹², —CO₂R¹³, —OCOR¹⁴, —NR¹⁵R¹⁶, —CONR¹⁷R¹⁸, —SO₂R¹⁹, —SO₂NR²⁰R²¹, —NR²²CONR²³R²⁴, —NR²⁵CO₂R²⁶, —COR²⁷, —NR²⁸COR²⁹, and —NR³⁰SO₂R³¹;
R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸, R²⁹, R³⁰, and R³¹ each independently represents one of a hydrogen atom, an aliphatic group, and an aromatic group; and
R²⁰¹ and R²⁰² may be combined with each other to form a ring structure.

8. The ink for ink jet recording of claim 1, wherein the oil-soluble dye is represented by following general formula (M-I): 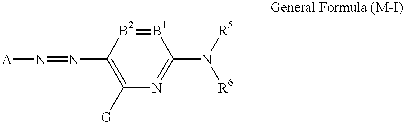
wherein, A represents the residue of a five-membered heterocyclic ring diazo component A—NH₂;
As for B¹ and B², B¹ represents ═CR¹— and B² represents —CR²═, or one represents a nitrogen atom and while the other represents ═CR¹— or —CR²═.
R⁵ and R⁶ each independently represents one of a hydrogen atom, an aliphatic group, an aromatic group, a heterocyclic group, an acyl group, an alkoxycarbonyl group, an aryloxycarbonyl group, a carbamoyl group, an alkyl sulfonyl group, an aryl sulfonyl group, and a sulfamoyl group, wherein each group may be further substituted;
G, R¹ and R² each independently represents one of a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic group, an alkoxycarbonyloxy group, an aryloxycarbonyloxy group, an amino group (including an anilino group), an acylamino group, an ureide group, a sulfamoyl group, an alkoxycarbonylamino group, an aryloxycarbonylamino group, an alkyl sulfonylamino group, an aryl sulfonylamino group, an aryloxycarbonylamino group, a nitro group, an alkyl thio group, an aryl thio group, an alkyl sulfonyl group, an aryl sulfonyl group, an alkyl sulfinyl group an aryl sulfinyl group, a sulfamoyl group, a sulfo group, or a heterocyclic thio group, wherein each group may be further substituted; and
R¹ and R⁵, or R⁵ and R⁶, may be bonded to form a five- or six-membered ring.

9. The ink for ink jet recording of claim 8, wherein A in the general formula (M-I) is represented by following general formulae (M-a) to (M-f):

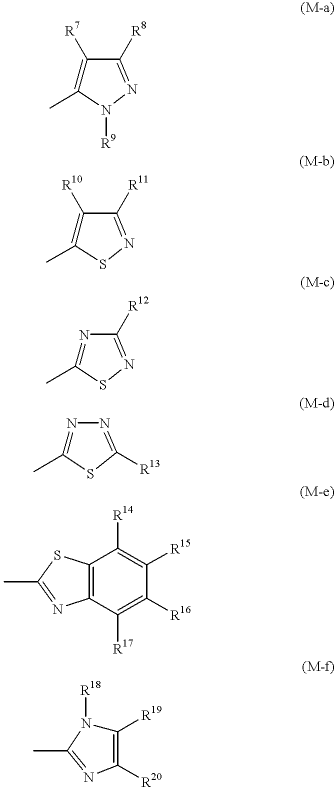

10. The ink for ink jet recording of claim 1, wherein the oil-soluble dye is represented by following general formula (C-I):
General formula (C-I)
wherein, X¹, X², X³ and X⁴ each independently represents —SO—Z¹, —SO₂—Z¹, or —SO₂NR²¹R²²;
Z¹ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group;
R²¹ and R²² each independently represents a hydrogen atom, a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group, wherein R²¹ and R²² do not simultaneously represent a hydrogen atom;
Y¹, Y², Y³ and Y⁴ each represents a monovalent substituent; and
a¹-a⁴ and b¹-b⁴ each represents substituents of X¹-X⁴ and Y¹-Y⁴, with a¹-a⁴ each independently representing an integer of 0-4 and b^{1 -b}⁴ each independently representing an integer of 0-4, wherein the summation of a¹-a⁴is no less than 2.

11. The ink for ink jet recording of claim 1, wherein the dielectric constant at a temperature of 25° C. of the hydrophobic high-boiling point organic solvent is 3-12.

12. The ink for ink jet recording of claim 1, wherein the mean particle diameter of dispersed particulates in the coloring particulate dispersion is no greater than 100 nm.

13. The ink for ink jet recording of claim 1, wherein an amount of the coloring particulate dispersion is 1 mass % to 45 mass % with respect to a total mass of the ink.

14. The ink for ink jet recording of claim 1, wherein the hydrophobic high-boiling point organic solvent is at least one hydrophobic high-boiling point organic solvent selected from hydrophobic high-boiling point organic solvents represented by following formulae [S-1] to [S-9]: 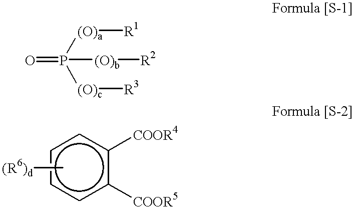 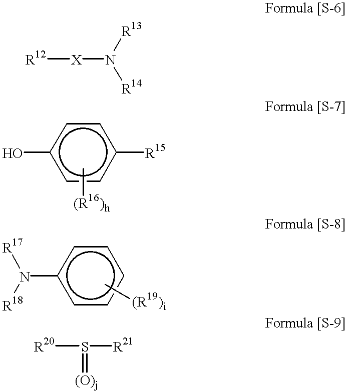
wherein, in the formula [S-1], R₁, R₂ and R₃ each independently represents one of an aliphatic group and an aryl group, and a, b and c each independently represents 0 or 1;
in the formula [S-2], R₄ and R₅ each independently represents one of an aliphatic group and an aryl group, R₆ represents one of a fluorine atom, chlorine atom, bromine atom, iodine atom, alkyl atom, alkoxy group, aryloxy group, alkoxycarbonyl group and aryloxycarbonyl group, d represents an integer from 0 to 3, and, in a case where d is more than 1, one R₆ may be different from another R₆;
in the formula [S-3], Ar represents an aryl group, e represents an integer from 1 to 6, and R₇ represents one of an e-valent hydrocarbon group and a hydrocarbon group that is mutually bonded by an ether bond;
in the formula [S-4], R₈ represents an aliphatic group, f represents an integer from 1 to 6, and R₉ represents one of an f-valent hydrocarbon group and a hydrocarbon group that is mutually bonded by an ether bond;
in the formula [S-5], g represents an integer from 2 to 6, R₁₀ represents a g-valent hydrocarbon group other than an aryl group, and R₁₁ represents one of an aliphatic group and an aryl group;
in the formula [S-6], R₁₂, R₁₃ and R₁₄ each independently represents one of a hydrogen atom, aliphatic group and aryl group, X represents one of —CO— and —SO₂—, and one of a pair R₁₂ and R₁₃ and a pair R₁₃ and R₁₄ may bond together mutually to form a ring;
in the formula [S-7], R₁₅ represents one of an aliphatic group, alkoxycarbonyl group, aryloxycarbonyl group, alkylsulfonyl group, arylsulfonyl group, aryl group and cyano group, R₁₆ represents one of a fluorine atom, chlorine atom, bromine atom, iodine atom, aliphatic group, aryl group, alkoxy group and aryloxy group, h represents an integer from 0 to 3, and in a case where h is more than 1, one R₁₆ may be different from another R₁₆;
in the formula [S-8], R₁₇ and R₁₈ each independently represents one of an aliphatic group and an aryl group, R₁₉ represents one of a fluorine atom, chlorine atom, bromine atom, iodine atom, aliphatic group, aryl group, alkoxy group and aryloxy group, i represents an integer from 0 to 4, and, in a case where i is more than 1, one R₁₉ may be different from another R₁₉; and
in the formula [S-9], R₂₀ and R₂₁ each independently represents an aliphatic group or aryl group, and j represents 1 or 2.

15. The ink for ink jet recording of claim 1, wherein the oil-soluble dye is contained from 0.1 mass % to 20 mass % with respct to a total mass of the ink.

16. The ink for ink jet recording of claim 1, wherein use amount of the hydrophobic high-boiling point organic solvent is 50 mass % to 150 mass % with respect to the oil-soluble dye.

17. The ink for ink jet recording of claim 1, wherein use amount of the polymer latex is 0.1 mass % to 30 mass % with respct to a total mass of the ink.

18. An ink jet recording method, the method comprising recording by using ink for ink jet recording, the ink comprising:
coloring particulate dispersion, the dispersion including particulate composed of at least an oil-soluble dye and a hydrophobic organic solvent, with the hydrophobic organic solvent having a high-boiling point of at least 150° C.; and polymer latex.

19. The ink jet recording method of claim 18, wherein the recording is conducted upon an image-receiving material, the image-receiving material comprising an ink receiving layer disposed on a support, with the ink receiving layer including a porous inorganic pigment.

20. The ink jet recording method of claim 18, wherein the ink includes an oil-soluble dye, the oil-soluble dye being represented by following general formula (I): 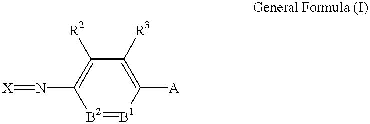
wherein, X represents the residue of a color coupler;
A represents one of —NR⁴R⁵ and a hydroxyl group;
R⁴ and R⁵ each independently represents one of a hydrogen atom, an aliphatic group, an aromatic group, and a heterocyclic group;
B¹ represents one of ═C(R⁶)— and ═N—;
B² represents one of —C(R⁷)═ and —N═;
R², R³, R⁶, and R⁷ each independently represents one of a hydrogen atom, a halogen atom, an aliphatic group, an aromatic group, a heterocyclic group, a cyano group, —OR⁵¹, —SR⁵², —CO₂R⁵³, —OCOR⁵⁴, —NR⁵⁵R⁵⁶, —CONR⁵⁷R⁵⁸, —SO₂R⁵⁹, —SO₂NR⁶⁰R⁶¹, —NR⁶²CONR⁶³R⁶⁴, —NR⁶⁵CO₂R⁶⁶, —COR⁶⁷, —NR⁶⁸COR⁶⁹, and —NR⁷⁰SO₂R⁷¹;
R⁵¹, R⁵², R⁵³, R⁵⁴, R⁵⁵, R⁵⁶, R⁵⁷, R⁵⁸, R⁵⁹, R⁶⁰, R⁶¹, R⁶², R⁶³, R⁶⁴, R⁶⁵, R⁶⁶, R⁶⁷, R⁶⁸, R⁶⁹, R⁷⁰, and R⁷¹ each independently represents one of a hydrogen atom, an aliphatic group, and an aromatic group; and
R² and R³, R³ and R⁴, R⁴ and R⁵, R⁵ and R⁶, and R⁶ and R⁷ may be combined with each other to form rings.

21. The ink jet recording method of claim 18, wherein the ink includes an oil-soluble dye, the dye being represented by following general formula (M-I): 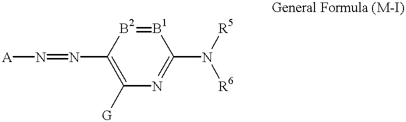
wherein, A represents the residue of a five-membered heterocyclic ring diazo component A—NH₂;
As for B¹ and B², B¹ represents ═CR¹— and B² represents —CR²═, or one represents a nitrogen atom and while the other represents ═CR¹— or —CR²═.
R⁵ and R⁶ each independently represents one of a hydrogen atom, an aliphatic group, an aromatic group, a heterocyclic group, an acyl group, an alkoxycarbonyl group, an aryloxycarbonyl group, a carbamoyl group, an alkyl sulfonyl group, an aryl sulfonyl group, and a sulfamoyl group, wherein each group may be further substituted;
G, R¹ and R² each independently represents one of a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic group, an alkoxycarbonyloxy group, an aryloxycarbonyloxy group, an amino group (including an anilino group), an acylamino group, an ureide group, a sulfamoyl group, an alkoxycarbonylamino group, an aryloxycarbonylamino group, an alkyl sulfonylamino group, an aryl sulfonylamino group, an aryloxycarbonylamino group, a nitro group, an alkyl thio group, an aryl thio group, an alkyl sulfonyl group, an aryl sulfonyl group, an alkyl sulfinyl group an aryl sulfinyl group, a sulfamoyl group, a sulfo group, or a heterocyclic thio group, wherein each group may be further substituted; and
R¹ and R⁵, or R⁵ and R⁶, may be bonded to form a five- or six-membered ring.

22. The ink jet recording method of claim 18, wherein the ink includes an oil-soluble dye, the dye being represented by following general formula (C-I):
General formula (C-I) 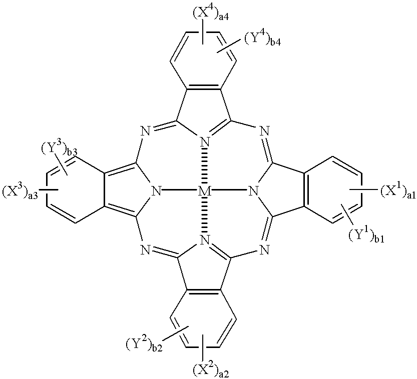
wherein, X¹, X², X³ and X⁴ each independently represents —SO—Z¹, —SO₂—Z¹, or —SO₂NR²¹R²²;
Z¹ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group;
R²¹ and R²² each independently represents a hydrogen atom, a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group, wherein R²¹ and R²² do not simultaneously represent a hydrogen atom;
Y¹, Y², Y³ and Y⁴ each represents a monovalent substituent; and
a¹-a⁴ and b¹-b⁴ each represents substituents of X¹-X⁴ and Y¹-Y⁴, with a¹-a⁴ each independently representing an integer of 0-4 and b¹-b⁴ each independently representing an integer of 0-4, wherein the summation of a¹-a⁴ is no less than 2.

23. A coloring composition, the composition comprising a coloring particulate dispersion and polymer latex, the coloring particulate dispersion comprising at least an oil-soluble dye and a hydrophobic organic solvent, with the hydrophobic organic solvent having a boiling point of at least 150° C.

24. The coloring composition of claim 23, wherein the polymer latex includes on a main chain or a side chain thereof an ethylenically unsaturated group.

25. The coloring composition of claim 24, wherein the oil-soluble dye is one represented by following formulae (I), (M-I) or (C-I): 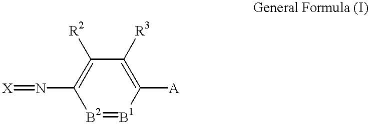
wherein, X represents the residue of a color coupler;
A represents one of —NR⁴R⁵ and a hydroxyl group;
R⁴ and R⁵ each independently represents one of a hydrogen atom, an aliphatic group, an aromatic group, and a heterocyclic group;
B¹ represents one of ═C(R⁶)— and ═N—;
B² represents one of —C(R⁷)═ and —N═;
R², R³, R⁶, and R⁷ each independently represents one of a hydrogen atom, a halogen atom, an aliphatic group, an aromatic group, a heterocyclic group, a cyano group, —OR⁵¹, —SR⁵², —CO₂R⁵³, —OCOR⁵⁴, —NR⁵⁵R⁵⁶, —CONR⁵⁷R⁵⁸, —SO₂R⁵⁹, —SO₂NR⁶⁰R⁶¹, —NR⁶²CONR⁶³R⁶⁴, —NR⁶⁵CO₂R⁶⁶, —COR⁶⁷, —NR⁶⁸COR⁶⁹, and —NR⁷⁰SO₂R⁷¹;
R⁵¹, R⁵², R⁵³, R⁵⁴, R⁵⁵, R⁵⁶, R⁵⁷, R⁵⁸, R⁵⁹, R⁶⁰, R⁶¹, R⁶², R⁶³, R⁶⁴, R⁶⁵, R⁶⁶, R⁶⁷, R⁶⁸, R⁶⁹, R⁷⁰, and R⁷¹ each independently represents one of a hydrogen atom, an aliphatic group, and an aromatic group; and
R² and R³, R³ and R⁴, R⁴ and R⁵, R⁵ and R⁶, and R⁶ and R⁷ may be combined with each other to form rings. 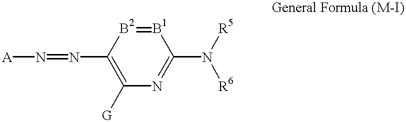
wherein, A represents the residue of a five-membered heterocyclic ring diazo component A—NH₂;
B¹ and B² each represents ═CR¹— and —CR²═, or one represents a nitrogen atom and the other represents either ═CR¹— or —CR²═;
R⁵ and R⁶ each independently represents one of a hydrogen atom, an aliphatic group, an aromatic group, a heterocyclic group, an acyl group, an alkoxycarbonyl group, an aryloxycarbonyl group, a carbamoyl group, an alkyl sulfonyl group, an aryl sulfonyl group, and a sulfamoyl group, wherein each group may be further substituted;
G, R¹ and R² each independently represents one of a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic group, an alkoxycarbonyloxy group, an aryloxycarbonyloxy group, an amino group (including an anilino group), an acylamino group, an ureide group, a sulfamoyl group, an alkoxycarbonylamino group, an aryloxycarbonylamino group, an alkyl sulfonylamino group, an aryl sulfonylamino group, an aryloxycarbonylamino group, a nitro group, an alkyl thio group, an aryl thio group, an alkyl sulfonyl group, an aryl sulfonyl group, an alkyl sulfinyl group an aryl sulfinyl group, a sulfamoyl group, a sulfo group, or a heterocyclic thio group, wherein each group may be further substituted; and
R¹ and R⁵, or R⁵ and R⁶, may be bonded to form a five- or six-membered ring.
General formula (C-I) 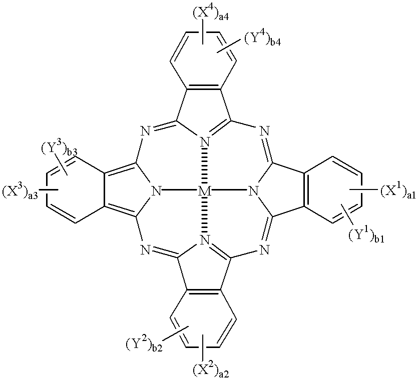
wherein, X¹, X², X³ and X⁴ each independently represents —SO—Z¹, —SO₂—Z¹, or —SO₂NR²¹R²²;
Z¹ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group;
R²¹ and R²² each independently represents a hydrogen atom, a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group, wherein R²¹ and R²² do not simultaneously represent a hydrogen atom;
Y¹, Y², Y³ and Y⁴ each represents a monovalent substituent; and
a¹-a⁴ and b¹-b⁴ each represents substituents of X¹-X⁴ and Y¹-Y⁴, with a¹-a⁴ each independently representing an integer of 0-4 and b¹-b⁴ each independently representing an integer of 0-4, wherein the summation of a¹-a⁴ is no less than 2.
